(19) United States
(12) Patent Application Publication
(10) Pub. No.: US 2025/0284484 A1
(43) Pub. Date: Sep. 11, 2025

(54) SYSTEM AND METHOD FOR ENHANCING NETWORK RELIABILITY AND COUNTERACTING CYBERSECURITY BREACH VIA SOFTWARE UPDATE

(71) Applicant: Clarity Consulting Corporation, Spring, TX (US)

(72) Inventors: Paul Williams, Spring, TX (US); Brandon Rains, Niceville, FL (US)

(21) Appl. No.: 19/213,742

(22) Filed: May 20, 2025

Related U.S. Application Data
(63) Continuation-in-part of application No. 18/243,165, filed on Sep. 7, 2023.
Application No. 18/243,165 is a continuation-in-part of application No. 18/206,003, filed on Jun. 5, 2023.
Application No. 18/206,003 is a continuation-in-part of application No. 18/206,008, filed on Jun. 5, 2023.
Application No. 18/206,003 is a continuation-in-part of application No. 17/106,060, filed on Nov. 27, 2020, now Pat. No. 11,711,382.
Application No. 18/206,008 is a continuation-in-part of application No. 17/106,060, filed on Nov. 27, 2020, now Pat. No. 11,711,382.
(60) Provisional application No. 62/941,576, filed on Nov. 27, 2019.
(60) Provisional application No. 63/445,654, filed on Feb. 14, 2023.
(60) Provisional application No. 63/445,663, filed on Feb. 14, 2023.
(60) Provisional application No. 63/445,654, filed on Feb. 14, 2023.
(60) Provisional application No. 63/445,663, filed on Feb. 14, 2023.
(60) Provisional application No. 63/700,302, filed on Sep. 27, 2024.

(51) Int. Cl. G06F 8/65; G06N 20/00

(52) U.S. Cl. CPC G06F 8/65; G06N 20/00

(57) ABSTRACT

A monitoring system including a processor to: place the monitoring system into an operating mode to use a model of a software update process to analyze observed transmissions of operational commands or information associated with the process; receive, from one or more interchange devices, indications of observed transmissions of operational commands or information among multiple monitored devices of a monitored system, wherein at least one of the monitored devices is configured to provide an updated routine in the process; and compare the received indications of observed transmissions of operational commands or information associated with the process to indications in the model of expected transmissions of operational commands or information associated with the process to determine whether a particular transmitted operational command is a proper operational command associated with the process or to determine whether particular transmitted operational information is proper operational information associated with the process.

### RELATED APPLICATIONS

This application is a continuation-in-part of U.S. patent application Ser. No. 18/243,165 entitled “EMULATION OF NETWORK TRAFFIC TO PREPARE A MONITORING SYSTEM FOR COUNTERACTING EFFECTS OF IMPROPER NETWORK TRAFFIC” filed Sep. 7, 2023 by Brandon Rains and Paul Williams; the disclosure of which is incorporated herein by reference for all purposes. In turn, U.S. patent application Ser. No. 18/243,165 is a continuation-in-part of U.S. patent application Ser. No. 18/206,003 entitled “SYSTEM AND METHOD FOR COUNTERACTING EFFECTS OF IMPROPER NETWORK TRAFFIC” filed Jun. 5, 2023 by Paul Williams; and is also a continuation-in-part of U.S. patent application Ser. No. 18/206,008 entitled “SYSTEM AND METHOD FOR ENHANCING COMPUTER NETWORK RELIABILITY BY COUNTERING DISRUPTIONS IN NETWORK COMMUNICATIONS” also filed Jun. 5, 2023 by Paul Williams; the disclosures of each of which are incorporated herein by reference for all purposes. In turn, each of U.S. patent application Ser. Nos. 18/206,003 and 18/206,008 is a continuation-in-part of U.S. patent application Ser. No. 17/106,060 entitled “METHOD AND SYSTEM OF DEDUCING STATE LOGIC DATA WITHIN A DISTRIBUTED NETWORK” filed Nov. 27, 2020 by Paul Williams (since issued as U.S. Pat. No. 11,711,382 on Jul. 25, 2023); the disclosure of which is incorporated herein by reference for all purposes.

This application also claims the benefit of the priority date of U.S. Provisional Application 63/700,302 entitled “SYSTEM AND METHOD FOR ENHANCING NETWORK RELIABILITY AND COUNTERACTING CYBERSECURITY BREACH VIA SOFTWARE UPDATE” filed Sep. 27, 2024 by Paul Williams and Brandon Rains; the disclosure of which is incorporated herein by reference for all purposes.

Each of U.S. patent application Ser. Nos. 18/206,003 and 18/206,008 also claims the benefit of the priority date of each of U.S. Provisional Application 63/445,654 entitled “SYSTEM AND METHOD FOR COUNTERACTING EFFECTS OF CYBER SECURITY BREACH OR OTHER DISRUPTION IN NETWORK COMMUNICATIONS” filed Feb. 14, 2023 by Paul Williams; and also claims the benefit of the priority date of U.S. Provisional Application 63/445,663 entitled “SYSTEM AND METHOD FOR ENHANCING COMPUTER NETWORK RELIABILITY AND COUNTERACTING EFFECTS OF A CYBER SECURITY BREACH” filed Feb. 14, 2023 by Paul Williams; the disclosures of each of which are also incorporated herein by reference for all purposes.

U.S. patent application Ser. No. 17/106,060 also claims the benefit of the priority date of U.S. Provisional Application 62/941,576 entitled “METHOD AND SYSTEM OF DEDUCING STATE LOGIC DATA WITHIN A DISTRIBUTED NETWORK” filed Nov. 27, 2019 by Paul Williams; the disclosure of which is incorporated herein by reference for all purposes.

### BACKGROUND

### 1. Technical Field

The present disclosure relates to the field of cybersecurity, specifically counteracting cybersecurity beaches through fake updates to software.

### 2. Description of the Related Art

It has become commonplace to employ computing devices and computer-based networking technologies to control industrial processes, including and not limited to, chemical processes, automated assembly lines, and the provision of various utilities, including electric power. Unfortunately, this has opened the door to a wide variety of communications failures arising from the complexities of such technologies that may affect the control of industrial processes, thereby creating a plethora of information technology and industrial process failure scenarios. This has also opened the door to cyber attacks affecting the control of industrial processes, thereby creating the relatively new concern that cybersecurity breaches of computing devices may additionally result in the compromising of industrial processes. Accordingly, a new form of malicious activity has been created in which cybersecurity breaches are committed for the very purpose of disrupting and/or otherwise compromising industrial processes. Thus, in numerous possible ways, there may be failures in the timing of communications, failures in the correctness of the contents of communications, incorrect actions of industrial processes, and/or failure for industrial processes to operate at all.

Regarding communications failures, and by way of example, a computer server in an information technology network may cease performing its normal functions with little or no warning due to a malfunctioning or an erroneously configured hardware or software component. Alternatively, and by way of another example, a cyber attack technique such as a distributed denial of service (DDOS) attack may be directed against networked computing devices that are involved in the control of industrial processes. Such attacks may so thoroughly inundate such computing devices with network traffic as to entirely prevent them from engaging in communications related to industrial processes such that necessary transmissions of operational commands are at least significantly delayed, or simply never occur.

As will be familiar to those skilled in the art, the timing of the transmission of a particular operational command from one device to another may be as important to the correct performance of an industrial process as whether such a transmission ever occurs, at all. The failure to transmit information and/or commands when expected, or the failure to transmit information and/or commands at all, may result in portions of an information technology network or industrial process being performed for too long a period of time, being commenced at too late a time, or not being performed at all. A whole host of failures may result, including and not limited to, expensive failures cascading throughout an information technology network in an organization or failures in the successful production of products or successful provision of services, damage to equipment used to produce products or provide services, creation of hazardous conditions where industrial processes are performed, injuries and/or fatalities among personnel involved in performing industrial processes, and/or reputational and/or financial damage to corporate entities and/or other entities associated with information technology network or industrial processes. Still further, where an industrial process is part of a chain of related industrial processes, such compromising of the performance of one industrial process may adversely affect the ability to perform one or more preceding industrial processes, and/or one or more subsequent industrial processes.

Regarding incorrect communications content, and by way of an example, a cybersecurity breach may occur in which a computing device involved in the control of an industrial process may be successfully compromised by malicious software such that it becomes remotely controllable for the purpose of disrupting that industrial process. It may be that such a compromised computing device is caused to cease issuing proper operational commands in a proper order with proper timings and/or parameters, and instead, it may be caused to issue improper operational commands that cause improper operation of robotic arms/actuators, conveyor motors, power relays, welding devices, valves, heating and/or cooling units, etc. Such devices may be caused to operate outside of equipment design limitations, and/or with incorrect timings that violate operational and/or safety requirements. Beyond simply impairing the correct performance of an industrial process, the results could include wasting raw materials, releasing and/or spilling hazardous materials, destroying sub-assemblies, damaging equipment and/or facilities, and/or placing personnel in physical danger.

The malicious operational commands that are so issued may be altered versions of proper operational commands such that the operational commands may actually be issued when they are expected to be issued, but may include incorrect parameters that specify one or more incorrect values, such as an incorrect device identifier, temperature, pressure, direction of movement, extent of movement, countdown time, upper or lower limit, etc. Alternatively or additionally, the malicious operational commands actually may be proper operational commands for the industrial processing being performed, but they may be issued at improper times and/or out of proper sequence. As still another alternative, it may simply be that entirely new malicious operational commands are issued without any connection to the content and/or timing of proper operational commands.

Among the increasingly frequent varieties of cybersecurity attack is the provision of fake updates to software relied upon for the basic functionality of processing systems, including firmware and/or device drivers that may be associated with lower level functionality of hardware components and/or operating systems, operating system and/or security software components, application routines and/or support libraries, etc. As will be familiar to those skilled in the art, the increasing complexity of the software used within processing systems (e.g., processing systems involved in controlling industrial processes) often necessitates the repeated updating of various software components to address mistakes found therein, to increase the efficiency and/or performance thereof, to add support for new hardware components, and/or to add new functionality.

Unfortunately, and as will also be familiar to those skilled in the art, it has become commonplace practice for such software updates to be obtained through the Internet from servers operated by a wide variety of software suppliers at many different locations around the world. With so many different software suppliers, an extremely wide variety of software download and security measures of widely varying degrees of effectiveness have become employed such that there is no such thing as a single standard procedure (or just a relatively small quantity of standard procedures) for identifying and/or obtaining software updates. Additionally, as software suppliers change over time, merge over time, are acquired over time, change management over time, etc., such procedures are likely to change, as well as the physical locations and/or network address locations of those servers.

A similarly dizzying and ever-changing variety of software-based tools are often provided by the manufacturers of computing devices for use in enabling manually-controlled or automated accessing and downloading of software updates from such servers. And such software tools are likely to also need to be updated over time, themselves, as the aforedescribed changes to such servers occur over time. As a result, each provider of software updates and/or each software tool that is so provided may employ its own unique set of procedures for reaching out to a server, checking for whether there is a software update for a particular software routine, downloading a software update, checking its integrity, etc. In turn, this leads to similarly unique sets and/or sequences of operational commands and/or data being transmitted among devices through an internal network and/or through the Internet.

This chaotic situation has proven to be an irresistible invitation for those seeking to compromise processing devices (including those involved in controlling industrial processes) by creating fake servers, and/or using other measures, to cause fake versions of software updates to be downloaded and used. In this way, various malicious measures such as “back doors” are introduced into processing devices, thereby providing malicious persons with the ability to access those processing systems. As will be familiar to those skilled in the art, such access may enable such malicious persons to access and steal confidential information, and/or to take control of an industrial process and/or other important process to cause damage, inflict downtime and/or to commit a wide variety of types of theft.

As those skilled in the art will readily recognize, it is often inevitable that some degree of software updating from external sources for those updates is necessary for the ongoing proper operation of processing devices as they perform their various functions. Thus, it is often not practical and/or not possible to avoid all risk of downloading and using fake software updates that introduce malicious code by simply preventing all software updates. It is also often not practical and/or not possible to directly manually control the accessing and downloading of each software update, as there may be far too many software updates occurring on far too frequent a basis within a particular organization and/or within a particular facility of an organization.

A similar concern exists regarding software updates that may be provided by an internal source. It is not uncommon for personnel associated with the maintenance of processing devices within an organization to create an internal repository of software updates that may be deemed to be trusted. It may be that such software updates have been, in some way, verified and/or tested to confirm their legitimacy such that they are deemed to not pose a threat when downloaded and used within other processing devices within that organization. However, such internal methods of verification, even if effective in avoiding the introduction of malicious software, often cannot prevent the introduction of coding errors and/or other non-malicious issues.

The use of cyber attack techniques in such attacks on industrial processes often begets the temptation to focus on using longstanding cybersecurity measures to counter them. Such longstanding cybersecurity measures include, and are not limited to, the use of various malicious code digital signatures to detect 1) the transmission, receipt and/or storage of particular sequences of executable instructions of malicious pieces of software, 2) the transmission of particular malicious combinations of operational commands across a network by a computing device, and/or 3) the performance of particular malicious combinations of actions by a computing device. Such approaches have been useful in attempting to prevent the infiltration and/or execution of malicious software, and/or halting further execution of malicious software. However, as will be familiar to those skilled in the art, such approaches often set up a form of “arms race” between developers of malicious software and developers of the signatures used in such detection.

Unavoidably, there is a delay between the deployment of new malicious software and/or other varieties of attacks, and the development of corresponding defensive measures (e.g., signatures) such that it is inevitable that at least some of such software and/or attacks will be successful in causing harm before being detected. As a result, such approaches usually do little to address the harm done to industrial processes in situations where malicious software or other unexpected and/or nefarious activity is not yet detected until after some amount of damage has been underway for at least some amount of time.

An additional issue is the disruption to the normal functioning of computing devices that is often caused by the introduction of various longstanding cybersecurity measures, including to the function of controlling an industrial or other process. Such measures usually entail the installation of new cyber security software on existing computing devices, thereby consuming resources of those devices. It is not unheard of for a computing device to require enhancements to processing and/or storage resources, or to require being replaced with another computing device having such enhancements in plate, to accommodate the consumption of resources by cyber security software. Indeed, as a result of such issues, it is not uncommon for the installation of cybersecurity software on computing devices to be regarded as a case where the proverbial cure is worse than the proverbial disease. Additionally, it is also not unheard of for the installation of cyber security software and/or the replacement of computing devices to cause changes in behavior in controlling a process. More specifically, there may be slight alterations to the timing and/or ordering of the transmission of operational commands and/or data that may seem innocuous, but which beget unforeseen deleterious results as a result of triggering an unforeseen and/or unknown quirk of the logic employed in controlling a process.

Further, such installations often require some degree of adjustment in distinguishing between undesired events arising from failures and/or cyber security attacks, and events that normally occur during normal functioning associated with controlling a process. Such adjustments to address missed conditions and/or false alarms can further compound disruptions, and may still further become another avenue by which unforeseen deleterious results are triggered.

The present invention addresses these and other drawbacks of the prior art by providing a unique approach to detecting and optionally mitigating the effects of such events on computing devices and/or communications among computing devices involved in the performance of industrial processes and other repetitive loop processes. The present invention also addresses these and other drawbacks of the prior art by providing a unique approach to thoroughly preparing a monitoring system to perform such detection and mitigation prior to deployment.

### BRIEF SUMMARY

Techniques are described for providing a system of one or more devices that implements a method for counteracting the effects of ongoing attempts to introduce fake firmware or software into a controlled environment.

A monitoring system includes: a processor configured to perform operations including: place the monitoring system into a training mode to generate a model of a software update process; receive indications of observed transmissions of operational commands or operational information among multiple monitored devices of a monitored system, wherein at least one of the multiple monitored devices is configured to initiate the software update process; and from the received indications of observed transmissions of operational commands or operational information associated with the software update process, generate the model of the software update process, wherein the model includes indications of an expected order of transmissions of operational commands or operational information associated with the software update process.

A monitoring system includes a processor configured to perform operations including: place the monitoring system into an operating mode to use a model of a software update process to analyze observed transmissions of operational commands or operational information associated with the software update process; receive, from one or more interchange devices, indications of observed transmissions of operational commands or operational information among multiple monitored devices of a monitored system, wherein at least one of the monitored devices is configured to provide an updated routine in the software update process; and compare the received indications of observed transmissions of operational commands or operational information associated with the software update process to indications in the model of expected transmissions of operational commands or operational information associated with the software update process to determine whether a particular transmitted operational command is a proper operational command associated with the software update process or to determine whether particular transmitted operational information is proper operational information associated with the software update process.

A method of generating a model of a software update process includes: receiving, by a processor of a monitoring system, and from an interchange device of a monitored system, indications of observed transmissions, through the interchange device, of operational commands or operational information among multiple monitored devices of the monitored system; and from the received indications of observed transmissions of operational commands or operational information associated with the software update process, generating, by the processor, the model of the software update process, wherein the model includes indications of an expected order of transmissions of operational commands or operational information associated with the software update process.

A method of using a model of a software update process to analyze observed transmissions of operational commands or operational information associated with the software update process includes: receiving, by a processor of a monitoring system, and from at least one interchange device of a monitored system, indications of observed transmissions of operational commands or operational information among multiple monitored devices of a monitored system; and comparing, by the processor, the received indications of observed transmissions of operational commands or operational information associated with the software update process to indications in the model of expected transmissions of operational commands or operational information associated with the software update process to determine whether a particular transmitted operational command is a proper and expected operational command associated with the software update process, or to determine whether the particular transmitted operational information is proper and expected operational information associated with the software update process.

### BRIEF DESCRIPTION OF THE DRAWINGS

The disclosure will be better understood and when consideration is given to the drawings and the detailed description which follows. Such description makes reference to the annexed drawings wherein:

FIGS. 1A, 1B, 1C, 1D, 1E and 1F, together, provide block diagrams of an example embodiment of a combination of a monitored system, a monitoring system to monitor network activity of the monitored system, and an emulation system to prepare the monitoring system for use.

FIGS. 2A, 2B and 2C present details of example embodiments of the monitoring system monitoring network activity within the monitored system.

FIGS. 3A, 3B, 3C, 3D and 3E, together, present details of an example embodiment of interactions among components of the monitored system and an external system in controlling a process performed within the external system.

FIGS. 4A, 4B and 4C present details of example embodiments of interactions of components of the monitored system and of an external system with external servers in update download processes.

FIGS. 5A, 5B and 5C, together, provide a more detailed presentation of aspects of a gathering phase of preparing the monitoring system for use—data is gathered to serve as part of the basis for generating emulations of behaviors of components of the monitored system, of an external system and/or of a process.

FIGS. 6A, 6B, 6C, 6D, 6E and 6F, together, provide a more detailed presentation of aspects of a pre-training phase of preparing the monitoring system for use—the gathered data is used to define behaviors and/or timings of the emulations.

FIGS. 7A and 7B, together, provide a more detailed presentation of aspects of an emulation training phase of preparing the monitoring system for use—the emulations are used to train, test and/or demonstrate abilities of the monitoring system.

FIGS. 8A, 8B, 8C and 8D, together, provide an example alternate embodiment of preparing the monitoring system for use that may be employed for supplemental training of the monitoring system, and/or that may be employed where information concerning process control logic is unavailable.

FIGS. 9A and 9B, together, present details of an example embodiment of counteracting the effects of a lack of transmission of an expected operational command.

FIGS. 10A, 10B, 10C and 10D, together, present details of an example embodiment of counteracting the effects of a transmission of an improper operational command.

FIGS. 11A and 11B, together, present details of another example embodiment of counteracting the effects of a transmission of an improper operational command.

FIGS. 12A and 12B, together, present details of an embodiment of using the monitoring system to counteract improper network activity in an update download process.

FIGS. 13A and 13B, together, present details of an embodiment of using the monitoring system to control the performance of an update download process.

### DETAILED DESCRIPTION

In the following detailed description, reference is made to the accompanying drawings that form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Broadly speaking, in a form of machine learning, observations of actual network traffic associated with the performance of an industrial process and/or an update download process are used as at least one basis to generate a model of that process and its associated network activity. That model is then used to identify when that process is being performed, and to identify instances of improper network activity that does not conform to what has been learned to be expected network activity. Each such identified instance of improper network activity may then be corrected to better conform to that expected network activity and/or may then be responded to in other ways to prevent the process from going awry.

A monitoring system includes: a processor configured to perform operations including: place the monitoring system into a training mode to generate a model of a software update process; receive indications of observed transmissions of operational commands or operational information among multiple monitored devices of a monitored system, wherein at least one of the multiple monitored devices is configured to initiate the software update process; and from the received indications of observed transmissions of operational commands or operational information associated with the software update process, generate the model of the software update process, wherein the model includes indications of an expected order of transmissions of operational commands or operational information associated with the software update process.

A monitoring system includes a processor configured to perform operations including: place the monitoring system into an operating mode to use a model of a software update process to analyze observed transmissions of operational commands or operational information associated with the software update process; receive, from one or more interchange devices, indications of observed transmissions of operational commands or operational information among multiple monitored devices of a monitored system, wherein at least one of the monitored devices is configured to provide an updated routine in the software update process; and compare the received indications of observed transmissions of operational commands or operational information associated with the software update process to indications in the model of expected transmissions of operational commands or operational information associated with the software update process to determine whether a particular transmitted operational command is a proper operational command associated with the software update process or to determine whether particular transmitted operational information is proper operational information associated with the software update process.

A method of generating a model of a software update process includes: receiving, by a processor of a monitoring system, and from an interchange device of a monitored system, indications of observed transmissions, through the interchange device, of operational commands or operational information among multiple monitored devices of the monitored system; and from the received indications of observed transmissions of operational commands or operational information associated with the software update process, generating, by the processor, the model of the software update process, wherein the model includes indications of an expected order of transmissions of operational commands or operational information associated with the software update process.

A method of using a model of a software update process to analyze observed transmissions of operational commands or operational information associated with the software update process includes: receiving, by a processor of a monitoring system, and from at least one interchange device of a monitored system, indications of observed transmissions of operational commands or operational information among multiple monitored devices of a monitored system; and comparing, by the processor, the received indications of observed transmissions of operational commands or operational information associated with the software update process to indications in the model of expected transmissions of operational commands or operational information associated with the software update process to determine whether a particular transmitted operational command is a proper and expected operational command associated with the software update process, or to determine whether the particular transmitted operational information is proper and expected operational information associated with the software update process.

### High Level Overview of Systems and Interplay Among Systems

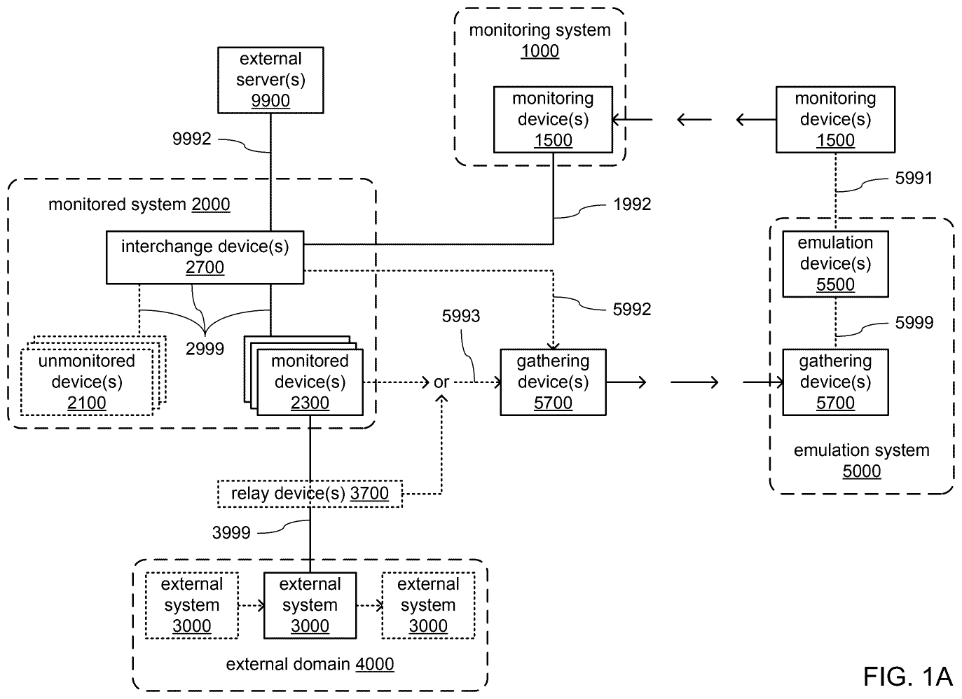

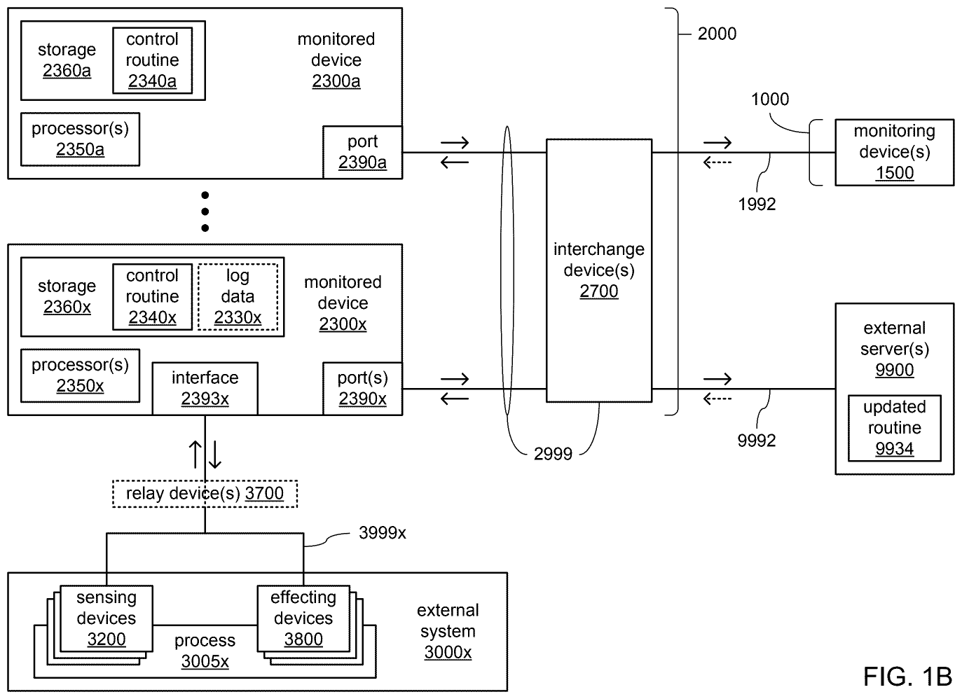

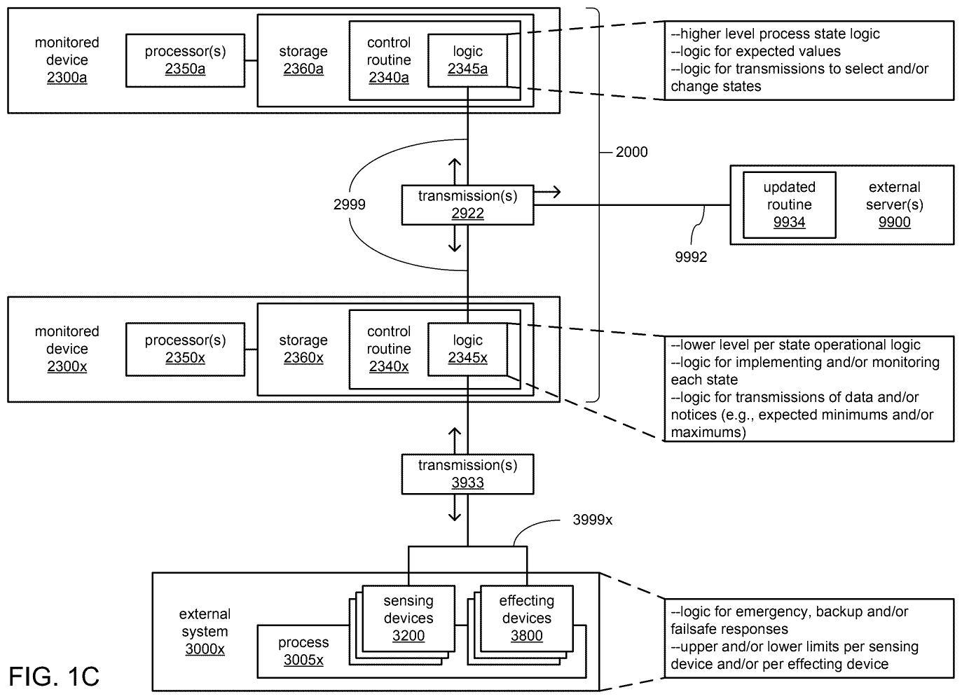

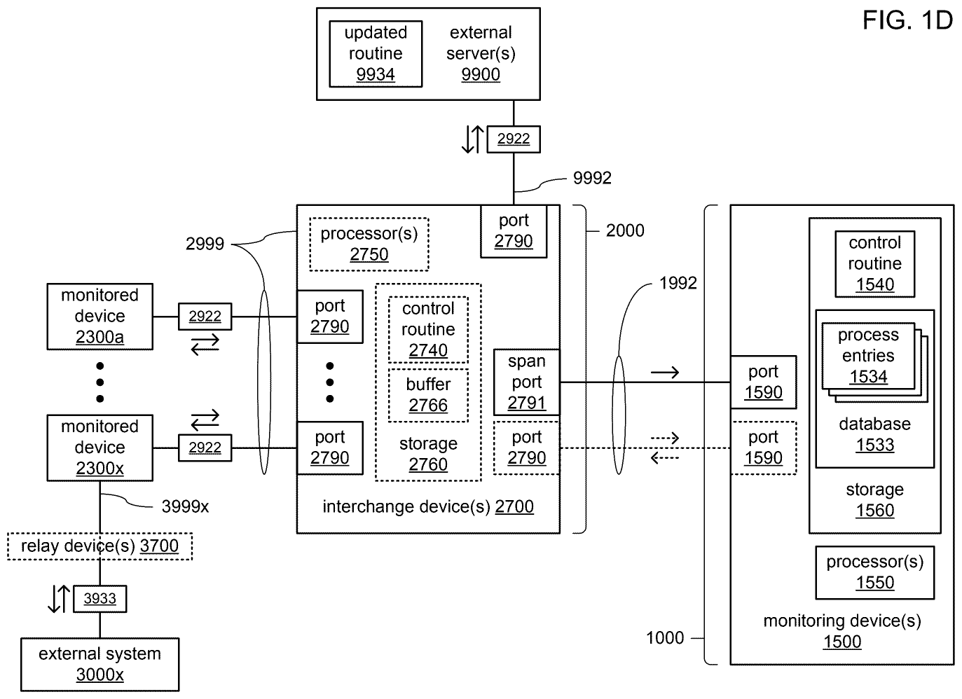

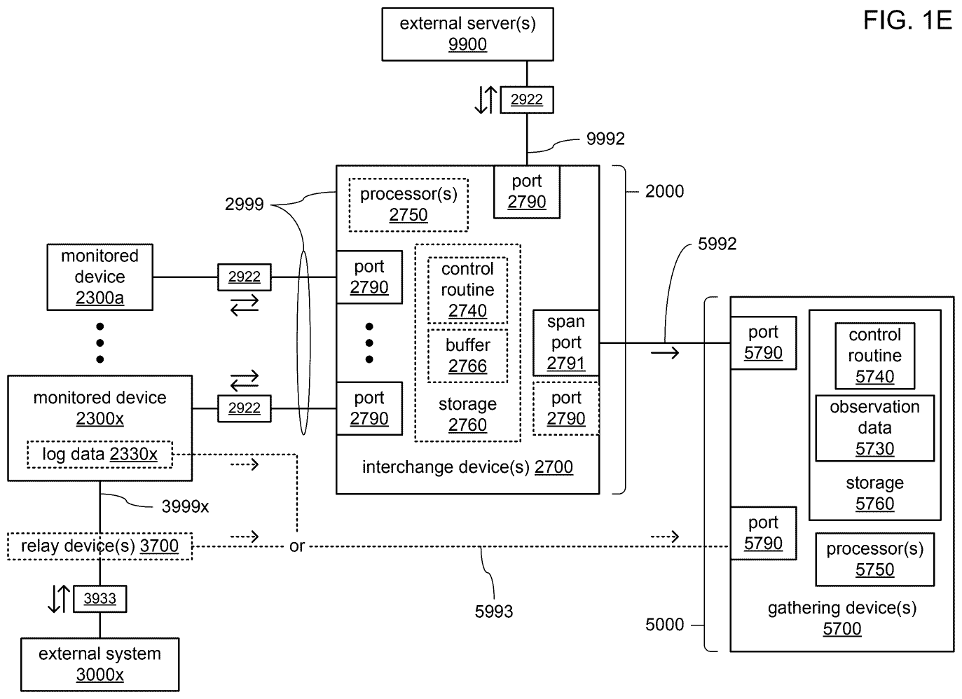

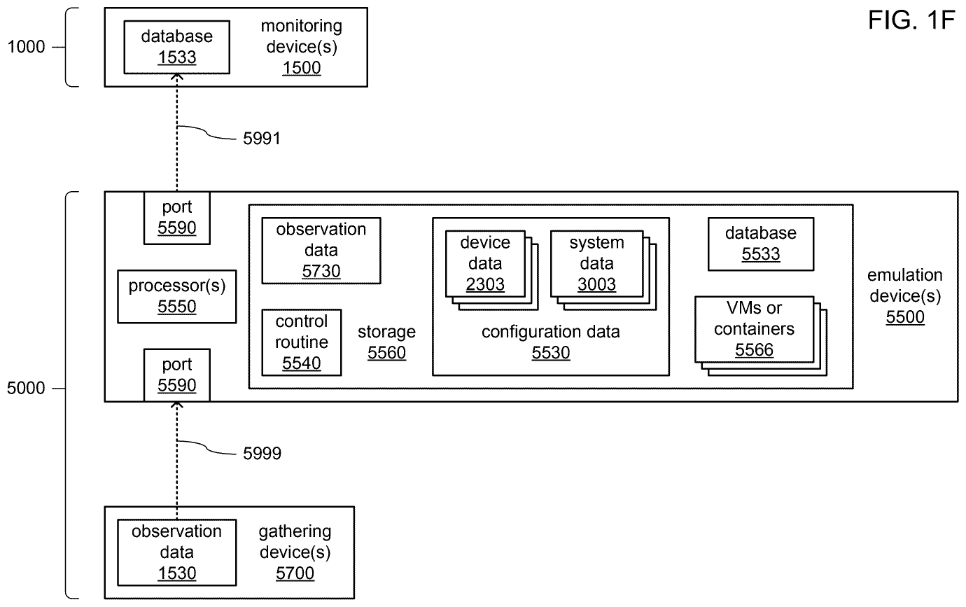

FIGS. 1A, 1B, 1C, 1D, 1E and 1F, taken together, provide a high level presentation of an example of a monitoring system 1000 being prepared, and then being deployed, to monitor transmissions of operational commands and/or operational information within a monitored system 2000 for purposes of a controlling aspects of an industrial or other type of process performed within an external system 3000. The particular external system 3000 that is so controlled may be one of multiple external systems 3000 that define an external domain 4000 by which products may be produced; utility services may be monitored, controlled and/or provided; etc. An emulation system 5000 that emulates behaviors of the monitored system 2000 and/or of the particular external system 3000 may be employed in training and/or testing the monitoring system 1000 as part of the monitoring system 1000 for its deployment. Additionally, one or more external servers 9000 may, from time to time, provide updated versions of various routines that are executed by devices of the monitored system 2000 and/or the particular external system 3000. Such updated versions of such routines may, on occasion, change the behaviors of the monitored system 2000 and/or of the particular external system 3000 such that occasional retraining of the monitoring system 1000 may be needed.

FIG. 1A introduces components of each of the systems 1000, 2000, 3000, 4000 and 5000; FIGS. 1B-D, together, depict aspects of using the monitoring system 1000 to monitor and/or correct communications traffic of the monitored system 2000 after being prepared for such use; and FIGS. 1E-F, together, depict aspects of preparing the monitoring system 1000 for such use.

Turning to FIG. 1A, in some embodiments, the monitored system 2000 may include a variety of computing devices interconnected by an internal network 2999. Among such computing devices may be multiple monitored devices 2300 that are involved in controlling the industrial process or other type of process that occurs within the one of the external systems 3000 that is depicted as being coupled to one of the monitored devices 2300. As part of being used together in a cooperative manner to control that process, various operational commands or information may be transmitted through the internal network 2999 among at least a subset of those monitored devices 2300.

For purposes of this patent application, it is important to note that the use of such terms as “monitoring” and “monitored” refer to the monitoring, by the monitoring system 1000, of communications through the internal network 2999 and among the monitored devices 2300 of the monitored system 2000 as part of providing reliability and/or cyber security services for the monitored system 2000. Such terms also refer to the monitoring of communications through the internal network 2999 and between the monitored devices 2300 and one or more external servers 9900 reachable through an external network 9992 (e.g., the Internet). Thus, these terms do not refer to the use of the monitored system 2000 to control of any industrial process or other type of process performed within an external system 3000.

Also among the computing devices connected to the internal network 2999 may be one or more unmonitored devices 2100 where none of the communications therewith through the internal network 2999 are monitored by the monitoring system 1000. It may be that at least a subset of the unmonitored device(s) 2100 does engage in communications with at least a subset of the multiple monitored devices 2300 through the internal network 2999. However, it may also be that none of those communications are associated with controlling an industrial process or other type of process performed within one of the external systems 3000, and therefore, it may be deemed unnecessary to monitor those communications.

As depicted, the internal network 2999 may include one or more interchange devices 2700. Each such interchange device 2700 may be any of a variety of types of network device, including and not limited to, a router, network switch, wireless network access point, network bridge, etc. In the internal network 2999, it may be that each transmission of operational command(s) and/or operational information among devices coupled to the internal network 2999 is transmitted through at least one interchange device 2700.

Also as part of controlling an external system 3000, and as depicted, at least one of the monitored devices 2300 may be coupled to that external system 3000 by one or more communications links 3999 to both monitor and control various aspects of a process that is performed with that external system 3000. Thus, in controlling such a process, there may be transmissions between such a monitored device 2300 and such an external system 3000 through the one or more links 3999, in addition to there being transmissions among multiple monitored devices 2300 through the internal network 2999. Depending on the particular technologies employed by the link(s) 3999, one or more relay devices 3700 may be incorporated into the one or more links 3999.

In view of their central role in conveying transmissions through the internal network 2999, it may be that monitoring transmissions of operational commands and/or operational information among the monitored devices 2300 entails monitoring network traffic passing through each of the one or more interchange devices 2700. To do so, at least one of the one or more interchange devices 2700 may be coupled to the monitoring system 1000 via a link 1992. Similarly, such monitoring through each of the one or more interchange devices 2700 may also be applied to the monitoring of transmissions of operational commands and/or operational information between the monitored devices 2300 and one or more external servers 9900 reachable via the external network 9992.

As depicted, the monitoring system 1000 may include one or more monitoring devices 1500, and each of the one or more monitoring devices 1500 may be still another computing device. It may be that the monitoring system 1000 is remotely located from the monitored system 2000 such that it may be deemed to be entirely separate therefrom. Alternatively, it may be that the monitoring system 1000 is co-located with at least a portion of the monitored system 2000, and/or is otherwise integrated with the monitored system 2000, such that it may be deemed to be included therein.

The preparation of the one or more monitoring devices 1500 for use in monitoring the monitored system 2000 may include three distinct phases. In a gathering phase, one or more gathering devices 5700 of the emulation system 5000 may be temporarily coupled to the interchange device(s) 2700 by one or more links 5992 to observe and capture communications activity occurring on the internal network 2999. This may include activity among the monitored devices 2300, and/or activity between the monitored devices 2300 and one or more external servers 9900. Also, at least one gathering device 5700 may be additionally temporarily coupled to the relay device(s) 3700 and/or to at least one monitoring device 2300 by one or more links 5993 to observe and capture communications activity occurring on the link(s) 3999. This may include activity between one or more of the external systems 3000 and one or more external servers 9900, which may be routed through one or more of the monitored devices 2300, as well as through both the internal network 2999 and at the link(s) 3999. In so doing, the gathering device(s) 5700 may generate observation data descriptive of the activity captured from at least the internal network 2999, if not also from the link(s) 3999.

The communications activity that is captured may include network activity associated with an industrial process (or other type of process) that occurs within an external system 3000, and is under the control of monitored devices 2300. Thus, such network activity may include operational commands and operational information exchanged with an external system 3000 to the performance of a process occurring therein at a relatively finely detailed and step-by-step level, as well as operational commands and operational information exchanged between monitored devices 2300 to coordinate the control of that process at a somewhat higher level. However, the communications activity that is captured may also include network activity associated with a single monitored device 2300 or a single external system 3000 retrieving an updated version of a software routine from an external server 9900. Thus, such network activity may include operational commands and operational information exchanged with an external server 9900 for authentication, to query whether there is an updated version of a particular software routine currently available, to coordinate a download of such an updated routine as multiple blocks of data conveyed through a series of transmission, and/or to check the integrity of such an updated routine following its download.

Following the gathering phase, in a pre-training phase, the gathering device(s) 5700 may be uncoupled from the interchange device(s) 2700, the relay device(s) 3700 and/or the at least one monitored device 2300, and the observation data generated by the gathering device(s) 5700 may be provided to the one or more emulation devices 5500. In so providing the observation data to the emulation device(s) 5500, the gathering device(s) 5700 may be temporarily coupled thereto through one or more links of a training network 5999. The emulation device(s) 5500 may be used to combine the observation data with other data concerning various aspects of the monitored device(s) 2300, various aspects of the external system(s) 3000, and/or various aspects of the process(es) being performed within the monitored device(s) 2300 and/or the external system(s) 3000. Such a combining of information may be used to generate and/or tune aspects of emulations of the monitored device(s) 2300, the external system(s) 3000, and/or the process(es).

Following the pre-training phase, in an emulation training phase, the emulation device(s) 5500 may be temporarily coupled to the monitoring device(s) 1500 through one or more links 5991 in a manner that is meant to mimic the manner in which the monitoring device(s) 1500 are to be coupled to the monitored system 2000 after the monitoring device(s) 1500 have been prepared for use. The emulation device(s) 5500 may then generate an emulation of behaviors of a combination of the monitored system 2000, the external system(s) 3000, and/or a process as part of providing the monitoring device(s) 1500 with an emulation of corresponding communications activity on the internal network 2999 for use in training and/or testing the monitoring device(s) 1500.

Thus, through such use of emulation, the monitoring device(s) 1500 are able to be trained for use in a manner that minimizes down time and/or other interruptions in controlling the process. Further, following such use of the emulations to train the monitoring device(s) 1500 for use, the emulations may be employed to test the effectiveness of the monitoring device(s) 1500 in various simulated scenarios to demonstrate their capabilities, provide confidence in the range of their capabilities, and/or ensure that various particular needs of operators of the monitored system 2000 are met.

Still further, such emulations may be used to simulate various conditions that may additionally provide new insights into other aspects of the monitored system 2000, of an external system 3000, and/or of a process. In this way, flaws in the logic employed in controlling a process and/or in the state machine of a process may be revealed that may create a susceptibility to one or more forms of attack and/or failure. Thus, it may be that such emulations go beyond providing proof of the suitability of the monitoring devices 1500 for use, and additionally identify ways in which the monitored system 2000, an external system 3000, and/or a process may be improved.

Following the preparation of the monitoring device(s) 1500 through the aforementioned three phases, the monitoring device(s) 1500 may be uncoupled from the emulation device(s) 5500, and then coupled to the one or more interchange device(s) 2700 of the monitored system 2000 via the one or more links 1992. The monitoring device(s) 1500 may then commence monitoring the communications activity through the internal network 2999 for instances of improper network traffic and/or instances of a lack of proper network traffic, and may respond to selected ones of such instances in various ways that will be described in greater detail.

Thus, through such use of the monitoring device(s) 1500 (which are separate and distinct from the monitored device(s) 2300) to detect anomalous network traffic on the internal network 2999, the effects of a cyber attack or a malfunction on the control of an industrial or other process is able to be mitigated. Also, this is able to be accomplished without consuming processing, storage and/or other resources of the monitored devices 2300, which might impair the control of the process.

### Systems and Interplay Among Systems During Normal Use

FIGS. 1B-D, taken together, present aspects of the use of the monitored system 2000 to control an example process 3005x being performed within an example external system 3000x, and present aspects of the use of monitoring device(s) 1500 of the monitoring system 1000 to monitor and/or actively correct the corresponding network activity on the internal network 2999. More specifically, an example monitored device 2300x of the multiple monitored devices 2300 of the monitored system 2000 may be coupled to the external system 3000x via one or more links 3999x, while at least one other example monitored device 2300a may cooperate with the monitored device 2300x through the internal network 2999 to control the process 3005x within the external system 3000x. Also, at least one monitoring device 1500 of the monitoring system 1000 may be coupled to at least one interchange device 2700 of the internal network 2999 to monitor the corresponding network traffic between at least the monitored devices 2300a and 2300x for instances of improper network activity that may adversely affect such controlling of the process 3005x, and to take various actions to correct such improper network activity.

These same figures, taken together, also present aspects of the operation of the monitored system 2000 to update software employed by one or more of the monitored devices 2300, and present aspects of the use of monitoring device(s) 1500 of the monitoring system 1000 to monitor and/or actively correct the corresponding network activity on the internal network 2999. More specifically, one of the monitored devices 2300a or 2300x, and/or the external system 3000x, may attempt to identify and/or download an updated routine 9934 from an external server 9900 as an update to at least a portion of a control routine 2340 and/or another routine. As will be explained in greater detail, there may be a distinct update download process that controls at least some aspects of the corresponding network activity that results on at least the internal network 2999. At least one monitoring device 1500 of the monitoring system 1000 may be coupled to at least one interchange device 2700 of the internal network 2999 to also monitor the network traffic between one of the monitored devices 2300a or 2300x and that server 9900 for instances of improper network activity that may be associated with accessing a fake version of that server 9900 and/or downloading a fake version of the updated routine 9934.

To be clear, it should be understood that what is depicted in FIGS. 1B-D includes using the monitoring device(s) 1500 of the monitoring system 1000 to monitor and/or correct network traffic through the internal network 2999 at a time after the monitoring device(s) 1500 have been prepared for use by performing the earlier described three phases (i.e., the gathering phase, the pre-training phase, and the emulation training phase). As previously mentioned, FIGS. 1E-F, taken together, depict aspects of such preparation of the monitoring device(s) 1500 of the monitoring system 1000 for use. Also, a more detailed discussion of such preparation is provided still later in this present application.

Turning to FIG. 1B, as depicted, the external system 3000x in which an example process 3005x is performed, may include multiple sensing devices 3200 to detect various conditions, and/or multiple effecting devices 3800 able to be commanded to perform various functions. Depending on the nature of the depicted process 3005x that is performed within the external system 3000x, each of the sensing devices 3200 may be any of a variety of type of sensing device based on any of a variety of technologies to sense any of a variety of conditions, including and not limited to, a temperature sensor, pressure sensor, light sensor, vibration sensor, accelerometer, gyroscope, spectrometer, chemical release sensor, particle emission detector, manually-operable control, manual data input device, air speed sensor, RADAR, LIDAR, SONAR, RPM sensor, etc. Correspondingly, depending on the nature of the process 3005x that is performed within the external system 3000x, each of the effecting devices 3800 may be any of a variety of type of effecting device based on any of a variety of technologies to effect any of a variety of actions, including and not limited to, a robotic arm, gantry crane, remotely controllable mobile platform, welding device, metal press, valve, heater, cooler, power supply, magnet or set of magnets, data storage device, display system, aerofoil or hydrofoil control surface, rudder, magnetron, radiation source, electric motor, internal combustion engine, turbine engine, etc.

Thus, in being coupled to the external system 3000x via the link(s) 3999x, the monitored device 2300x may be coupled to the sensing devices 3200 and/or to the effecting devices 3800 of the external system 3000x via the link(s) 3999x. As depicted, and depending on the technologies employed by the link(s) 3999x, it may be that the link(s) 3999x incorporate one or more relay devices 3700x. By way of example, it may be that the relay device(s) 3700x serve to boost signal strength over relatively long electrical and/or optical conductors of the link(s) 3999x; serve as transceiver(s) for one or more wireless connections on which the link(s) 3999x may be based; serve as converter(s) between portions of the link(s) 3999x that may employ different signaling, protocols, transmission media, etc.; and/or serve as isolators (e.g., optoisolators) to prevent harmful current and/or voltage spikes from being conveyed through the link(s0 3999x.

The process 3005x that may be performed within the external system 3000x may be any of a variety of types of industrial process (e.g., a chemical process, the automated assembly of a product on an assembly line, the provision of electric power, etc.), or may be any of a variety of types of non-industrial process (e.g., data archival and storage, data mining, etc.). Regardless of what the process 3005x may be, the process 3005x may have multiple states where particular action(s) are to be performed and/or where particular event(s) are to occur within each state. Thus, the performance of the process 3005x may progress through a tree of such states with particular transitions occurring between particular states at particular times, in a particular order, and/or in response to particular conditions.

As depicted, the monitored device 2300x may include one or more processors 2350x, a storage 2360x, a port 2390x to couple the monitored device 2300x to the internal network 2999, and/or an interface 2393x to couple the monitored device 2300x to the link(s) 3999x. The storage 2360x, the port 2390x and/or the interface 2393x may each be communicatively coupled to the processor(s) 2350x to exchange executable instructions and/or data therewith through the exchange of electrical, optical, magnetic and/or other signals through one or more buses and/or other form of interconnect within the monitored device 2300x. Further, the storage 2360x may store a control routine 2340x that may include instructions executable by the processor(s) 2350x to cause the processor(s) 2350x to perform various functions. In some embodiments, the storage 2360x may also store log data 2330x that may include indications of transmissions to and/or from the external system 3000x via the link(s) 3999x, and/or may include other information associated with those transmissions.

As depicted, the monitored device 2300a may include one or more processors 2350a, a storage 2360a, and/or a port 2390a to couple the monitored device 2300a to the internal network 2999. The storage 2360a and/or the port 2390a may each be communicatively coupled to the processor(s) 2350a to exchange executable instructions and/or data therewith through the exchange of electrical, optical, magnetic and/or other signals through one or more buses and/or other form of interconnect within the monitored device 2300a. Further, the storage 2360a may store a control routine 2340a that may include instructions executable by the processor(s) 2350a to cause the processor(s) 2350a to perform various functions.

Turning to FIG. 1C, as depicted, transmissions 2922 of operational commands and/or operational information may be exchanged through the internal network 2999 among such monitored devices 2300 as the depicted monitored devices 2300a and 2300x, and transmissions 2922 may be exchanged through the internal network 2999 between such monitored devices 2300 and the one or more external servers 9900. Additionally, transmissions 3933 of operational commands and/or operational information may be exchanged through such links 3999 as the depicted link(s) 3999x between such monitored devices 2300 and external systems 3000 as the depicted monitored device 2300x and external system 3000x.

In various embodiments, the control routine 2340x may implement logic 2345x for controlling at least some lower level aspects of performances of the process 3005x within the external system 3000x. It may be that the control routine 2340x is operative on the processor(s) 2350x of the monitored device 2300x to cause the processor(s) 2350x to monitor the sensing devices 3200 of the external system 3000x to monitor aspects of the process 3005x performed within the external system 3000x, and/or to command the effecting devices 3800 of the external system 3000x in a manner that causes the processor(s) 2350x to put the external system 3000x into at least a subset of the multiple states of the process 3005x. In so doing, the effecting devices 3800 of the external system 3000x may be operated in a concerted manner by the monitored device 2300x to perform various steps of the process 3005x, while being guided by data received by the monitored device 2300x from the sensing devices 3200 of the external system 3000x. Stated differently, the control routine 2340x may be capable of causing the processor(s) 2350x to monitor for and/or to implement at least a subset of those multiple states of the process 3005x. Additionally, it may be that the control routine 2340x is operative on the processor(s) 2350x to monitor for conditions within the process 3005x that are outside of at least a subset of expected minimums and/or maximums, and to respond by transmitting operational information indicative of such conditions to the monitored device 2300a.

In various embodiments, the control routine 2340a may implement logic 2345a for also controlling at least some higher level aspects of performances of the process 3005x within the external system 3000x. It may be that the control routine 2340a is operative on the processor(s) 2350a of the monitored device 2300a to cause the processor(s) 2350a to transmit operational commands to the monitored device 2300x to control the performance of the process of the external system 3000x based, at least in part, on operational information received from the monitored device 2300x. Stated differently, the control routine 2340a may be capable of causing the processor(s) 2350a to command the occurrence of transitions among at least a subset of the states of the process of the external system 3000x, thereby causing the process to be performed. Additionally, it may be that the control routine 2340a is operative on the processor(s) 2350a to provide a user interface to an operator tasked with overseeing the performance of a process 3005x within an external system 3000x.

Thus, within the monitored devices 2300a and 2300x, the control routines 2340a and 2340x, together, may implement logic 2345a and 2345x that causes the processors 2350a and 2350x, respectively, to cooperate to control the process 3005x. While the monitored device 2300x may be coupled to the external system 3000x so as to be capable of such lower level functionality as directly monitoring for and/or implementing states of the process 3005x performed therein, it may be that such higher level functionality as the overall actual performance of the process 3005x is controlled by the monitored device 2300a. In this way, the monitored devices 2300a and 2300x may cooperate to implement the logic of the finite state machine for the process performed within the external system 3000x.

More precisely, it may be that the monitored device 2300a outputs transmissions 2922 onto the internal network 2999 that convey operational commands and/or operational information to the monitored device 2300x to cause the monitored device 2300x to implement at least a subset of the transitions between states within the external system 3000x. In turn, the monitored device 2300x may output corresponding transmissions 3933 onto the link(s) 3999x to various ones of the effecting devices 3800 that convey commands to act in a manner that causes such transitions. It may also be that the monitored device 2300x receives, via the link(s) 3999x, transmissions 3933 from the effecting devices 3800 confirming receipt and/or performance of such instructions to act, and/or transmissions 3933 from the sensing devices 3200 providing data concerning detected conditions. In turn, the monitored device 2300x may output corresponding transmissions 2922 onto the internal network 2999 that convey operational information to the monitored device 2300a indicative of data received from the sensing device(s) 3200 to enable the monitored device 2300a to determine when particular ones of such transitions between states of the process 3005x have occurred and/or should occur.

Further, it may be that components of an external system 3000x, such as sensing devices 3200 and/or effecting devices 3800 of the external system 3000x, may incorporate or otherwise implement various forms of relatively simple logic for locally handling various specific events. Such events may include loss of communication with the monitored device 2300x that would otherwise monitor and control the external system 3000x, such that the locally implemented logic serves as a backup form of monitoring and/or control for a limited period of time until such communication is reestablished. Alternatively or additionally, such events may include an emergency situation, such as the outbreak of a fire or other condition that triggers the locally implemented logic to independently act to quickly implement a transition to a known failsafe state, while also transmitting operational information indicative of such conditions to the monitored device 2300x.

Alternatively or additionally, within the monitored devices 2300a and/or 2300x, the control routines 2340a and/or 2340x may implement logic 2345a and/or 2345x that causes the processors 2350a and/or 2350x, respectively, to access one or more external servers 9900 to retrieve one or more updated routines 9934 by which portions of the control routines 2340a and/or 2340x (and/or still other software routines) may be updated. Such logic may require manual triggering by an operator of one or both of these devices interacting therewith via a user interface (UI), such as a combination of keyboard and display (not specifically shown). Alternatively or additionally, such logic may be automatically triggered at timed intervals and/or in response to other factors. Regardless of the exact manner in which such logic is triggered, the processor(s) 2350a and/or 2350x may be caused by such logic within the control routine(s) 2340a and/or 2340x, respectively, to at least attempt to engage in communications with one or more external servers 9900. Such communications may include transmissions 2922 of operational commands and/or operational information pertinent to determining whether there are updated routine(s) 9934 for the control routine(s) 2340a and/or 2340x (and/or for other software routines), and/or to effect the downloading of updated routine(s) 9934 from the one or more external servers 9900.

Not unlike the example process 3005x occurring within the example external system 3000x, it may be that the process of identifying and/or downloading updated routine(s) 9934 from external server(s) 9900 also progresses through multiple states of a state machine. For example, there may be distinct states of searching for and/or identifying pertinent updated routine(s) 9934 based on what version of a control routine 2340 (and/or what version(s) of other software routines) is currently stored and/or executed within a corresponding monitored device 2300. There may also be a distinct state of downloading one of such identified updated routines 9934, and/or a distinct state of checking the integrity of such a download to confirm that such updated routine 9934 has not been corrupted during the download process through the networks 2999 and/or 9992.

Accordingly, the control and/or monitoring of such states may be based on transmissions 2922 of operational commands and/or operational information through the networks 2999 and/or 9992. For example, triggering the commencement of such a state of searching for and/or identifying pertinent update routine(s) 9934 may entail the transmission of various operational commands that may convey identifiers and/or version levels of various routines as parameters. The act of downloading an updated routine 9934 may entail the transmission of that updated routine 9934 as multiple blocks of operational information. The protocol used in coordinating such transmissions 2922 of blocks of operational information may entail the transmission of multiple instances of operational command(s) confirming the successful reception of each such block. The state of checking integrity may entail the transmission of operational commands confirming that all block have been transmitted and/or received, the transmission of operational commands conveying a checksum or other value by which such a confirmation may be performed, etc.

Further, within the external system 3000x, similar logic may be implemented to also determine whether updated routine(s) 9934 for routine(s) that may be executed within the external system 3000x are available, to also download such updated routine(s) 9934 that are found to be available, and/or to perform integrity checks of such downloaded ones of such routines 9934. Thus, the external system 3000x may implement another process (separate and distinct from the process 3005x) that may implement another state machine for identifying and/or downloading such updated routine(s) 9934. In so doing, the fact of the indirect connection of the external system 3000x to the internal network 2999 through the monitored device 2300x may result in transmissions of operational commands and/or operational information as transmissions 3933 through the link(s) 3999x, in addition to corresponding transmissions of operational commands and/or operational information as transmissions 2922 through the networks 2999 and/or 9992.

Turning to FIG. 1D, as depicted, each interchange device 2700 of the internal network 2999 may include one or more processors 2750, a storage 2760, multiple bi-directional ports 2790, and/or a span port 2791. The storage 2760, the ports 2790 and/or the span port 2791 may each be communicatively coupled to the processor(s) 2750 to exchange executable instructions and/or data therewith through the exchange of electrical, optical, magnetic and/or other signals through one or more buses and/or other form of interconnect within each interchange device 2700. Further, the storage 2760 may store a control routine 2740 that may include instructions executable by the processor(s) 2750 to cause the processor(s) 2750 to perform various functions. Alternatively or additionally, a portion of the storage 2760 may be allocated to serve as a buffer 2766.

As previously discussed, each interchange device 2700 may be any of a variety of types of network device. Thus, in some embodiments, the depicted interchange device 2700 may be a relatively simple hub device in which execution of the control routine 2740 by the processor(s) 2750 may cause the processor(s) 2750 to, in response to receiving a transmission 2922 at one of the ports 2790, output the very same transmission 2922 in a broadcasting manner at all other ports 2790. Alternatively, in other embodiments, the depicted interchange device 2700 may be a relatively more sophisticated device (e.g., a network switch device) in which execution of the control routine 2740 by the processor(s) 2750 may cause the processor(s) 2790 to use internally stored address information associated with each port 2790 to more selectively relay a transmission 2922 received at one port 2750 to just one other port 2750 or to just a subset of the other ports 2750.

Regardless of the level of sophistication of the depicted interchange device 2700, it may be that received transmissions 2922 are temporarily stored within the buffer 2766 for a predetermined period of time and/or until there is an indication of success in being relayed onward through the internal network 2999. This may be done to enable one or more attempts at retransmission to be performed in response to an indication of failure in an initial attempt at relaying onward through the internal network 2999.

Further, the span port 2791 may be implemented as an output-only port that relays a copy and/or an indication of each transmission 2922 that is received at any port 2790 of the interchange device 2700. Thus, as depicted, the span port 2791 may be coupled to a monitoring device 1500 of the monitoring system 1000 to enable copies and/or indications of some or all network traffic that passes through the interchange device 2700 to be provided to that monitoring device 1500. As will shortly be explained in greater detail, this enables that monitoring device 1500 to detect an instance in which a transmission 2922 of a particular operational command and/or operational information among the monitored devices 2300, or between a monitored device 2300 and an external server 9900, was expected to occur within a particular span of time, but failed to occur. This also enables that monitoring device 1500 to detect an instance in which an improper transmission 2922 of an operational command and/or operational information among the monitored devices 2300, or between a monitored device 2300 and an external server 9000, occurs. As additionally depicted, the same depicted monitoring device 1500 may also be coupled to the depicted interchange device 2700 via another of the ports 2790. As will be explained in greater detail, such an additional coupling therebetween may enable the monitoring device 1500 to respond to such an occurrence of a lack of an expected transmission 2922, and/or such an occurrence of an improper transmission 2922, by outputting a replacement transmission 2922, itself.

In embodiments in which the interchange device 2700 is of a more sophisticated variety, it may be that execution of the control routine 2740 causes the processor(s) 2750 thereof to respond to commands received from such a monitoring device 1500 to limit the copies and/or indications of network traffic that are provided through the span port 2791 to transmissions 2922 of particular types and/or to transmissions 2922 associated with particular devices. In this way, it may be that the depicted interchange device 2700 is caused to cooperate with the depicted monitoring device 1500 to limit the copies and/or indications of network traffic that are output to the monitoring device 1500 to operational commands and/or operational information transmitted among monitored devices 2300, and/or between monitored devices 2300 and specific external server(s) 9900.

Alternatively or additionally, in embodiments in which the interchange device 2700 is of a more sophisticated variety, it may be that the execution of the control routine 2740 causes the processor(s) 2750 thereof to respond to commands received from such a monitoring device 1500 to at least temporarily retain transmissions 2922 meeting one or more specified criteria within the buffer 2766. In this way, it may be that the depicted interchange device 2700 is caused to cooperate with the depicted monitoring device 1500 to at least temporarily delay allowing a transmission 2922 to proceed through the interchange device 2700 between monitored devices 2300, and/or between a monitored device 2700 and an external server 9900, thereby at least providing the monitoring device 1500 with an amount of time needed to analyze aspects of the transmission 2922 to determine whether it is a proper transmission 2922 so as to be able to determine whether to command the interchange device 2700 to allow it to continue onward to its intended destination device.

As also depicted, each such monitoring device 1500 may include one or more processors 1550, a storage 1560, and/or one or more ports 1590 for coupling to one or more interchange devices 2700 of the internal network 2999. The storage 1560 and/or the port(s) 1590 may each be communicatively coupled to the processor(s) 1550 to exchange executable instructions and/or data therewith through the exchange of electrical, optical, magnetic and/or other signals through one or more buses and/or other form of interconnect within each monitoring device 1500. Further, the storage 1560 may store a control routine 1540 that may include instructions executable by the processor(s) 1550 to cause the processor(s) 1550 to perform various functions. Alternatively or additionally, the storage 1560 may store a database 1533 of information concerning states, operational commands and/or operational information associated with one or more processes that may be performed within an external system 3000 (e.g., the process 3005x performed within the external system 3000x, or associated with one or more processes for downloading an update routine 9934 from an external server 9900), as well as information concerning actions to be taken in response to situations observed on the internal network 2999 that at least appear to fall outside what is expected to occur during the performance of each of those one or more processes.

More precisely, and as will be explained in greater detail, the database 1533 may include multiple process entries 1534, with each process entry 1534 corresponding to a single process that may be performed within an external system 3000 under the control of monitored device(s) 2300, or to a single process for downloading an updated version of a software routine from an external server 9900. Still more precisely, each process entry 1534 may store a model of one of such processes. Such a model may define the processing states of a process, along with aspects of network activity associated with each processing state. As will also be explained in greater detail, these models may be generated from at least observations of network activity as part of preparing the monitoring devices 1500 for use, and during such use of the monitoring devices 1500, these models may be repeatedly referred to identify network activity associated with a particular process and/or to identify improper network activity that may be associated with an issue developing during the performance of a process.

With the monitoring device(s) 1500 so coupled to the interchange device(s) 2700, the monitoring for improper network traffic through the internal network 2999 may include, and not be limited to: 1) monitoring for instances of a lack of transmission of a particular operational command or particular operational information when expected within a particular span of time; and/or 2) monitoring for instances of a transmission of an improper or invalid operational command, or of improper or invalid operational information or data.

Regarding the lack of a transmission 2922 of a particular operational command or particular operational information occurring when expected within a particular span of time, such an instance of failure of transmission may arise for any of a variety of reasons. Among those reasons may be any of a variety of hardware and/or software malfunctions that may have occurred within a particular monitored device 2300 or external server 9900 such that it is no longer functioning sufficiently to transmit the operational command or information when expected. Alternatively or additionally, among those reasons may be a cyber attack in which a particular monitored device 2300 or external server 9900 that was to transmit the operational command or information through the internal network 2999 has succumbed to malicious software or other form of internal cyber attack that prevents it from doing so, and/or has been inundated with network activity through the internal network 2999 such that it is prevented from transmitting the expected operational command or operational information.

Again, there may be particular transmissions 2922 of operational commands and/or operational information through the internal network 2999 that are associated with various transitions between states of such a process within an external system 3000. By way of example, it may be that a particular operational command or operational information is meant to be transmitted through the internal network 2999 within a particular span of time in response to the occurrence of particular conditions, such as a transition into a particular state. Or, by way of another example, it may be that a particular operational command or operational information is meant to be transmitted through the internal network 2999 within a particular span of time, and/or as part of a particular sequence of operational commands and/or operation information, to cause a transition into a particular state. Thus, a failure of one of those transmissions 2922 to occur when expected within a particular span of time may result in a failure of occurrence of a transition between states that would otherwise normally take place, and/or may result in an errant transition to an incorrect state.

The monitoring device(s) 1500 of the monitoring system 1000 may be configured to respond to such a failure of occurrence of the transmission of a particular operational command or information through the internal network 2999 by taking any of a variety of actions. By way of example, in some embodiments, the monitoring device(s) 1500 may simply provide an alert to designated personnel of such a failure (e.g., providing an audible and/or visual alert, and/or transmitting an electronic alert message, such as a text message or phone call). Alternatively or additionally, in other embodiments, the monitoring device(s) 1500 may store, in a log or other similar data structure maintained within the storage 2760, an indication of such a failure. Also alternatively or additionally, in still other embodiments, the monitoring device(s) 1500 may, through the interchange device(s) 2700, transmit that particular operational command or operational information through the internal network 2999, itself, such that the particular operational command or operational information is still provided to whichever monitored device 2300 or external server 9900 is supposed to receive it, thereby enabling the associated industrial process, download process, or other type of process to continue without interruption.

Regarding the transmission of an improper or invalid operational command, such an instance of an improper transmission 2922 may also arise for any of a variety of reasons. Among those reasons may be an honest operator mistake, or any of a variety of hardware and/or software malfunctions that may have occurred within the a particular monitored device 2300 or external server 9900 such that it is no longer functioning sufficiently to select correct operational commands and/or operational information to be transmitted. Alternatively or additionally, among those reasons may be that the monitored device 2300 or external server 9900 that transmits the improper operational command or operational information has succumbed to malicious software or other form of cyber attack that either, itself, causes the particular monitored device 2300 or external server 9900 to transmit the improper operational command or operational information, or that enables the monitored device 2300 or external server 9900 to be remotely commanded to do so. It should also be noted that such an instance of an improper transmission 2922 may arise elsewhere within and/or proximate to the internal network 2999, such as interfering electrical activity caused by a lightning strike, etc. such that the contents of a proper transmission 2922 may have been corrupted, thereby creating the improper transmission 2922.

Again, there may be particular transmissions 2922 of operational commands and/or operational information through the internal network 2999 that are associated with various transitions between states of such a process within an external system 3000, or that are associated with various transitions between states of a process of downloading an updated routine 9934. Thus, a transmission 2922 of an improper operational command to take an improper action, or to take an action with improper parameter(s), may result in a transition to another state that occurs out of proper sequence, or may result in a transition to an improper state that is entirely outside of such a tree of proper states.

The monitoring device(s) 1500 of the monitoring system 1000 may be configured to respond to the transmission of such an improper operational command through the internal network 2999 by taking any of a variety of actions. By way of example, in some embodiments, the monitoring device(s) 1500 may simply provide an alert to designated personnel of such a transmission (e.g., providing an audible and/or visual alert, and/or transmitting an electronic alert message, such as a text message or phone call). Alternatively or additionally, in other embodiments, the monitoring device(s) 1500 may store, in a log or other similar data structure maintained within the storage 2760, an indication of such a transmission 2922. Also alternatively or additionally, in still other embodiments, the monitoring device(s) 1500 may, through the interchange device(s) 2700, block the transmission 2922 of such an improper operational command such that it is not received at whichever monitored device 2300 or external server 9900 is the intended destination device, and/or cause the transmission 2922 of a proper operational command that replaces and/or countermands the improper operational command.

More precisely, in some embodiments, it may be that the monitoring device(s) 1500 operate the interchange device(s) 2700 to cause the interchange device(s) 2700 to intercept each operational command that is transmitted by a monitored device 2300 or an external server 9900 that meets various pre-selected parameters (e.g., type of operational command, protocol used, destination, etc.). Each such operational command may initially be relayed to the monitoring device(s) 1500 for analysis, instead of being relayed onward to its intended destination device. The analysis that is performed may be based on machine learning where correct transmissions 2922 of operational commands associated with controlling industrial processes (e.g., the process 3005x) and/or associated with downloading updated routines 9934 through the internal network 2999 have been observed over time to build up a knowledge base of what transmissions 2922 of operational commands are expected to occur and when for each process. Where the analysis results in a determination that the operational command is proper, then the interchange device(s) 2700 may be directed to proceed with relaying the operational command onward towards its intended destination. However, where the analysis results in a determination that the operational command is improper or invalid, then, at a minimum, the interchange device(s) 2700 may be directed to refrain from relaying the operational command onward towards its intended destination device.

Still further action may be taken by the monitoring device(s) 1500 in response to an improper operational command based on various factors. By way of example, where a transmitted improper operational command is the type of operational command that is expected, is transmitted at the expected time, and to the expected destination device, but includes invalid parameter(s), then the monitoring device(s) 1500 may transmit a corrected version of that improper operational command, through interchange device(s) 2700, and onward to the same destination device, so as to cause the proper operational command to be received at that destination device at the expected time.

Alternatively, in other embodiments, it may be that the interchange device(s) 2700 do not, in any way, intercept the operational commands that are transmitted therethrough. Instead, for each operational command that is transmitted by a monitored device 2300 or an external server 9900 that meets various pre-selected parameters (e.g., type of operational command, protocol used, destination, etc.), a copy is relayed to the monitoring device(s) 1500 for analysis as it is also relayed onward to its intended destination. Again, the analysis that is performed may be based on machine learning and/or a comparison against the database 1533 with its models providing indications of expected operational commands. Where the analysis results in a determination that the operational command or information transmission is proper, then no further action may be taken. However, where the analysis results in a determination that the operational command or information transmission is improper, then further action may be taken by the monitoring device(s) 1500, such as sending an alert or transmitting additional operational command(s), through interchange device(s) 2700, and onward to the same destination device. The additional operational command(s) may be generated based on an analysis of the improper operational command to countermand the action specified in the improper operational command.

### Systems and Interplay Among Systems During Preparation for Normal Use

FIGS. 1E-F, taken together, present aspects of the preparation of the monitoring system 1000 for use in monitoring and/or correcting network traffic occurring on the internal network 2999 of the monitored system 2000 that are associated with controlling the process 3005x being performed within the external system 3000x, and/or associated with downloading updated routines 9934 from one or more external servers 9900. More specifically, information gathered about the monitored system 2000, the external system 3000x, and/or the one or more external servers 9900 is provided to one or more emulation devices 5500 of the emulation system 5000 to enable the provision of a set of emulations of different portions of the system 2000, the system 3000x, and/or the one or more external servers 9900. In so doing, an emulation of network activity through at least the internal network 2999 may also be provided, and may be used to train and/or test the one or more monitoring devices 1500 as part of preparing those monitoring device(s) 1500 for such use.

Turning to FIG. 1E, during the gathering phase, one or more gathering devices 5700 may be temporarily coupled, via at least one link 5992, to span port(s) 2791 and/or to tap(s) of interchange device(s) 2700 of the internal network 2999 of the monitored system 2000. Through the link(s) 5992, and in a manner similar to what was described in reference to FIG. 1D for the monitoring device(s) 1500, the gathering device(s) 5700 may receive indications of transmissions 2922 occurring on the internal network 2999. Also in a manner similar to what was described in reference to FIG. 1D for the monitoring device(s) 1500, the indications of transmissions 2922 received by the gathering device(s) 5700 through the link(s) 5992 may be limited to transmissions 2922 that are associated with controlling processes performed within one or more external systems 3000 (e.g., the process 3005x that is performed within the external system 3000x). Alternatively or additionally, the transmissions 2922 may be limited to those that are associated with downloading updated routines 9934 for the control routines 2340 executed within the monitored devices(s) 2300 (e.g., the monitored devices 2300a and/or 2300x), and for routines that may be executed within the one or more external systems 3000 (e.g., the external system 3000x).

Additionally, in some embodiments, it may be that the gathering device(s) 5700 are also temporarily coupled, via at least one link 5993, to either the relay device(s) 3700x (if present) or to the monitored device 2300x. As previously discussed, based on the type(s) of communications technology employed by the link(s) 3999x, it may be that the link(s) 3999x incorporate the relay device(s) 3700x to boost signals by which the transmissions 3933 are conveyed, to convert between differing protocols and/or differing transmission media used by the link(s) 3999x, and/or to provide protective isolation. Further, it may be that the relay device(s) 3700x also incorporate span port(s) and/or a wire tap(s) to which the gathering device(s) 5700 may be temporarily coupled via the at least one link 5993 in a manner similar to the span port(s) 2791 and/or wire tap(s) of the interchange device(s) 2700.

Alternatively, in other embodiments in which the link(s) 3999x do not incorporate the relay device(s) 3700x, it may be deemed desirable to avoid attempting to couple the gathering device(s) 5700 to the link(s) 3999x, at all. As those skilled in the art will readily recognize, it may be deemed desirable to not risk causing disruptions to the ability of the link(s) 3999x to convey transmissions 3933 therethrough, and to employ an alternate approach to obtaining information concerning those transmissions 3933, if an alternate approach is available. Such an alternate approach may be to couple the gathering device(s) 5700 to the monitored device 2300x to obtain a copy of the log data 2330x that may be generated therein, which may include various details of transmissions 3933 to and from the external system 3000x.

As those skilled in the art will readily recognize, each of the monitored devices 2300, including the monitored devices 2300a and 2300x, may be any of a wide variety of types of computing device based on any of a variety of implementations of any of a variety of computing architectures. Among such a wide assortment of options for implementing the monitored device 2300x, a subset of those options may be configured and/or configurable to generate the log data 2330x to include any of a variety of types of information concerning any of variety of types of event that may occur while controlling the process 3005x within the external system 3000x, and/or while cooperating with the external system 3000x to retrieve updated routines 9934 for the use within the external system 3000x. In embodiments in which the log data 2330x is generated to include indications of each transmission 3933 through the link(s) 3999x, it may be possible to use the log data 2330x in lieu of direct observations of those transmissions 3933 by connecting to the link(s) 3999x.

By way of example regarding controlling the process 3005x, in some of such embodiments, it may be that the log data 2330x is limited to recording instances of anomalies and/or improper conditions that might occur during individual performances of the process 3005x, such as instances of exceeding ranges of temperature, pressure, speed, capacity, timing, etc. Alternatively, it may be that the log data 2330x is far more verbose such that indications of each transmission 3933 that is sent or received by the monitored device 2300x in connection with the process 3005x may be recorded therein, along with timestamps thereof.

By way of another example regarding downloading updated routines 9934, in some embodiments for use within the external system 3000x, it may be that the log data 2330x is limited to recording instances of anomalies and/or improper conditions that might occur during an instance of downloading an updated routine 9934, such as instances of anomalies in communicating with an external server 9900, instances of interruption and/or corruption of the download, etc. Alternatively, it may be that the log data 2330x is far more verbose such that indications of each transmission 3933 that is sent or received by the monitored device 2300x in connection with downloading an updated routine 9934 may be recorded therein, along with timestamps thereof.

Regardless of the exact manner in which information concerning transmissions 3933 through the link(s) 3999x is captured or otherwise obtained (if that is possible) in addition to information concerning transmissions 2922 through the internal network 2999, the captured information concerning transmissions 2922 and/or 3933 may be stored within at least one gathering device 5700 as the observation data 5730. As will shortly be explained, following this gathering phase in which the observation data 5730 is so generated to include information for such transmissions 2922 and/or 3933 occurring over a pre-determined period of time, the observation data 5730 may then be provided to the one or more emulating devices 5500 of the emulation system 5000 as an input to the pre-training phase.

As depicted, each gathering device 5700 may include one or more processors 5750, a storage 5760, and/or one or more ports 5790 for being temporarily coupled to at least interchange device(s) 2700 of the internal network 2999. The storage 5760 and/or the port(s) 5790 may each be communicatively coupled to the processor(s) 5750 to exchange executable instructions and/or data therewith through the exchange of electrical, optical, magnetic and/or other signals through one or more buses and/or other form of interconnect within each monitoring device 1500. Further, the storage 5760 may store the observation data 5730 and/or a control routine 5740 that may include instructions executable by the processor(s) 5750 to cause the processor(s) 5750 to perform various functions.

More specifically, in executing the control routine 5740, the processor(s) 5750 of the gathering device(s) 5700 may be caused to monitor the port(s) 5790 for the receipt of indications of transmissions 2922 occurring on the internal network 2999. Additionally, in some embodiments, the processor(s) 5750 may be caused to monitor the port(s) 5790 for the receipt of either indications of transmissions 3933 occurring through the link(s) 3999x, or the log data 2330x. In response, the processor(s) 5750 may be caused to combine such received information concerning transmissions 2922 and/or 3933 (e.g., the contents of each transmission 2922 and/or 3933, and/or when each transmission occurred) to generate the observation data 5730.

Referring to FIG. 1A, in addition to FIG. 1E, it should be noted that, in an alternate embodiment, the emulation system 5000 may not include the gathering device(s) 5700, and it may be that the monitoring device(s) 1500 are employed to perform the functions of the gathering device(s) 5700. More precisely, in such an alternate embodiment, and at a time prior to the monitoring device(s) 1500 being prepared for use in monitoring and/or correcting network traffic on the internal network 2999, it may be that the monitoring device(s) 1500 are able to be operated in a gathering mode during the gathering phase to receive indications of transmissions 2922 occurring on the internal network 2999, and/or transmissions 3933 occurring through the link(s) 3999, and to generate the observation data 5730 therefrom in a manner similar to what has been described in reference to the gathering device(s) 5700. In such an alternate embodiment, the monitoring device(s) 1500 may then be temporarily coupled to the emulation device(s) 5500 to both provide the observation data 5730 thereto as part of completing the gathering phase, and to be trained and/or tested as part of the emulation training phase, as has been described.

In another alternate embodiment, it may be that one or more of the monitored devices 2300 (e.g., one or both of the monitored devices 2300a and 2300x) are employed to perform the functions of the gathering device(s) 5700. More precisely, processor(s) 2350 within each such monitored device 2300 may caused, by execution of a portion of the control routine 2340, to generate and store at least a portion of the observation data 5730 to include indications of network traffic through the internal network 2999 that it has output and/or that it has received. Such portions of the observation data 5730 may then be subsequently combined to form the completed observation data 5730, which may then be provided to the emulation device(s) 5500.

In still another embodiment, it may be that the interchange device(s) 2700 of the internal network 2999 are employed to perform the functions of the gathering device(s) 5700. More precisely, processor(s) 2750 within each such interchange device 2700 may caused, by execution of a portion of the control routine 2740, to generate and store at least a portion of the observation data 5730 to include indications of network traffic that passes therethrough. Again, such portions of the observation data 5730 may then be subsequently combined to form the completed observation data 5730, which may then be provided to the emulation device(s) 5500.

Turning to FIG. 1F, following the gathering phase, and during the pre-training phase, the gathering device(s) 5700 that had been temporarily coupled to at least the monitored system 2000 and/or to the link(s) 3999x to gather information and/or to generate the observation data 5730, may be uncoupled therefrom, and may then be temporarily coupled, to one or more emulation device(s) 5500 via the training network 5999. In this way, the emulation device(s) 5500 may be provided with at least the observation data 5730 generated by the gathering device(s) 5700.

Also, the emulation device(s) 5550 may be provided with configuration data 5530 that includes one or more instances of device data 2303 concerning characteristics of one or more monitored devices 2300 (e.g., the monitored devices 2300a and 2300x), the instance of the control routine 2340 executed within each, the logic 2345 implemented within each such instance of the control routine 2340 to perform one or more processes (e.g., a process for downloading an updated routine 9934), and/or the state machine(s) implemented thereby for each such process. Alternatively or additionally, the configuration data 5530 may include one or more instances of system data 3003 concerning characteristics of one or more external systems 3000 (e.g., the external system 3000x), the logic implemented within each such external system 3000 to perform one or more processes (e.g., the process 3005x, and/or a process for downloading an updated routine 9934), and/or the state machine(s) implemented thereby for each such process. It should be noted that in various different embodiments, information concerning the characteristics of one or more of such items may not be available, and as a result, some of such information may need to be derived from the observation data 5730 to enable the provision of at least some emulations, as will be explained in greater detail.

As depicted, each such emulation device 5500 may include one or more processors 5550, a storage 5560, and/or one or more ports 5590 for coupling to the training network 5999 and/or to links 5991. The storage 5560 and/or the port(s) 5590 may each be communicatively coupled to the processor(s) 5550 to exchange executable instructions and/or data therewith through the exchange of electrical, optical, magnetic and/or other signals through one or more buses and/or other form of interconnect within each emulation device 5500. Further, the storage 5560 may store a control routine 5540 that may include instructions executable by the processor(s) 5550 to cause the processor(s) 5550 to perform various functions. Alternatively or additionally, the storage 5560 may store the observation data 5730, the configuration data 5530 and/or a database 5533. Also alternatively or additionally, portions of the storage 5560 may be allocated to serve as virtual machines (VMs) or containers 5566 to support the provision of emulations.

As will be explained in greater detail, during the pre-training phase, execution of the instructions of the control routine 5540 may cause processor(s) 5550 of the emulation device(s) 5500 to use the information in the observation data 5730 concerning observed transmissions 2922 and/or 3933, together with information in the configuration data 5530 to generate, within each VM or container 5566, an emulation of a separate device or other component that is present within the monitored system 2000, the external system 3000x, and/or one or more external servers 9900. These may include separate emulations for each of the monitored devices 2300a and 2300x, emulation(s) of the process 3005x and/or the external system 3000x in which the process 3005x is performed, and/or separate emulations for each of one or more external servers 9900. These VMs or containers 5566 may be linked to enable the separate emulations within each VM or container 5566 to interact in a cooperative manner to provide an emulation of the monitored system 2000, the external system 3000x, and/or one or more external servers 9900 interacting with each other. In so doing, an emulation may also be provided of at least the communications activity occurring through the internal network 2999, if not also through the link(s) 3999x.

As will also be explained in greater detail, following the pre-training phase, and during the emulation training phase, these emulations may be used in training the monitoring device(s) 1500 to distinguish between proper network activity on the internal network 2999 that is associated with one or more processes being performed, and improper network activity on the internal network 2999 that is at least suggestive of a malfunction and/or cyber attack where the monitoring device(s) 1500 should take some form of action. As will be explained in greater detail, it may be that the monitoring device(s) 1500 are also prepared to distinguish network activity on the internal network 2999 that is indicative of an error condition where the monitoring device(s) 1500 should not take action, and instead, allow other devices or external systems (e.g., one or more monitored devices 2300 and/or external systems 3000) to take action.

In commencing the emulation training phase, the monitoring device(s) 1500 may be temporarily coupled, via at least one link 5991, to port(s) 5590 of the emulation device(s) 5500. The processor(s) 5550 of the emulation device(s) 5500 may be caused by execution of the control routine 5540 to provide, at such port(s) 5590, access to the emulation of at least the communication activity through the internal network 2999. In this way, the monitoring device(s) 1500 may be subjected to conditions that are at least relatively similar to the conditions that will be encountered when coupled to at least the actual interchange device(s) 2700 of the internal network 2999.

Referring to FIG. 1A, in addition to FIG. 1F, following the emulation training phase, the monitoring device(s) 1500 may be uncoupled from the emulation device(s) 5500, and may then be coupled, via the link(s) 1992, to the interchange device(s) 2700 of the internal network 2999 of the monitored system 2000 for use. As will be explained in greater detail, the emulation training phase is meant to at least minimize (if not eliminate) the need for further training of the monitoring device(s) 1500 upon being so coupled to the actual monitored system 2000 for use. In this way, at least the potential for disruptions of the normal operation of the monitored system 2000 to control the process 3005x, and/or to download update routine(s) 9934, may be at least minimized, if not eliminated.

However, as will also be explained, it may be that, over time, changes in network traffic through the internal network 2999 may be caused by changes to various other devices coupled thereto and/or to routines that are executed therein, which may result in changes to the logic and/or state machines of various processes. As will be familiar to those skilled in the art, hardware upgrades to devices that may have been intended to simply improve their speed and/or reliability of operation can still have the unintended consequence of changing their behavior, including on the networks to which they are connected. Further, and as will also be familiar to those skilled in the art, software updates that may have been intended to simply address seemingly insignificant “software bugs” can also have such unintended consequences. Thus, over time, such “drift” in the behavior of various devices, software and/or external systems may cause some degree of re-training of the monitoring device(s) 1500 to be deemed at least desirable, if not necessary.

Returning to FIG. 1A, although the monitored system 2000 has been discussed as being made up of multiple networked computing devices 2100, 2300 and/or 2700, in alternate embodiments, it may be that the monitored system 2000 is, itself, a single computing device. In such alternate embodiments, the device(s) 2100, 2300 and/or 2700 may be components of that single computing device that are interconnected by an internal network of buses 2999. In such alternate embodiments, it may be that each of the one or more interchange devices 2700 is an integrated circuit providing a form of crosspoint switch function for the network of buses 2999 by which commands and/or data are transmitted among the other devices 2100 and/or 2300.

Further, in such alternate embodiments, it may additionally be that the monitoring system 1000 is implemented using one or more microcontrollers that may be physically incorporated into that single computing device of the monitored system 2000. However, it may also be that the monitoring system 1000 is otherwise isolated from the central processing units (CPUs) thereof of that single computing device.

Still further, and regardless of whether the monitored system 2000 is made up of multiple networked computing devices, or is, itself, a computing device, it may be that the monitoring system 1000 is implemented via public or private cloud-based network computing resources.

### Further Detail of Network Communications and Interchange Devices

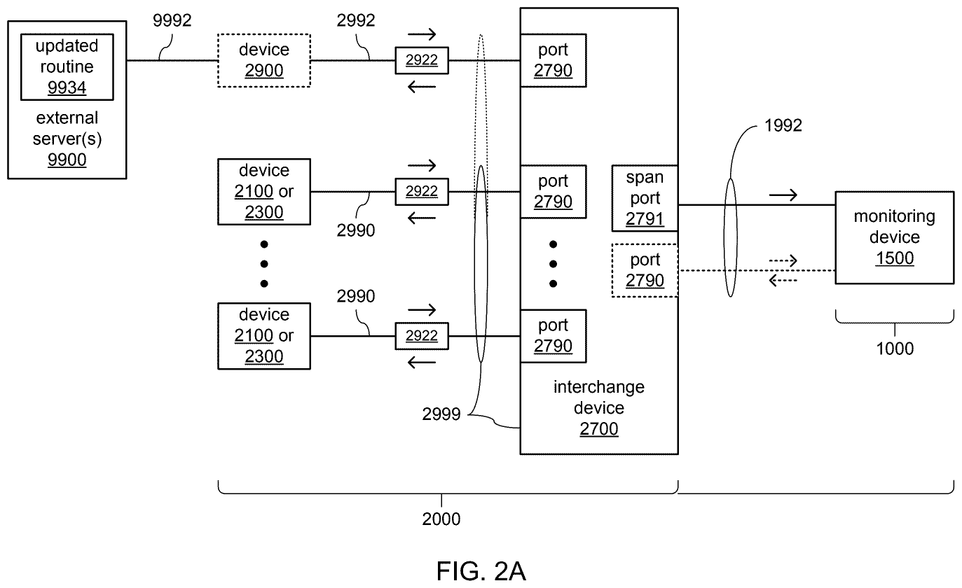

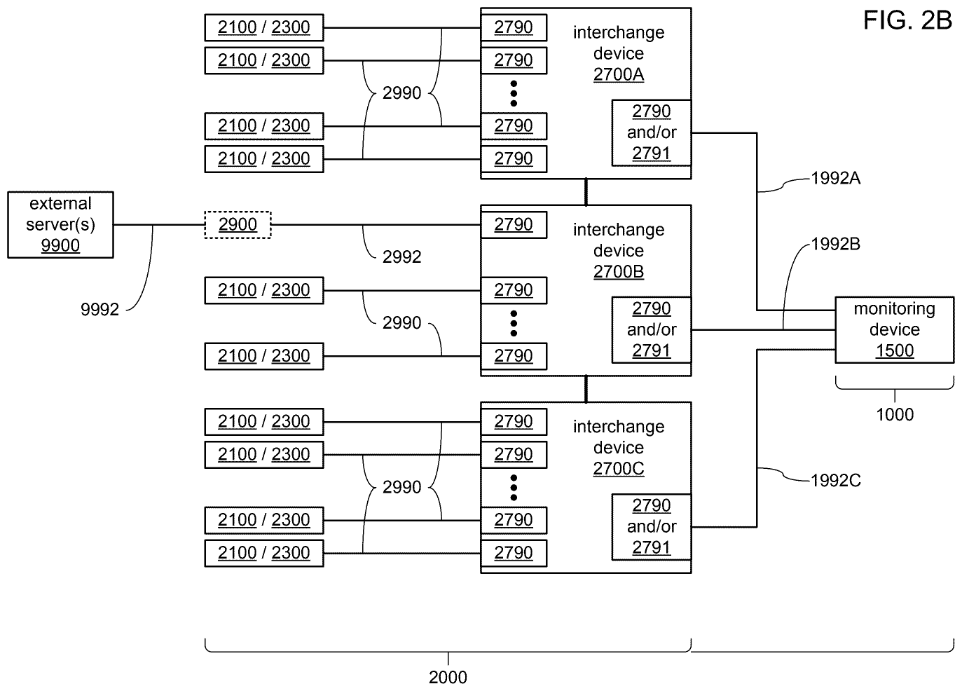

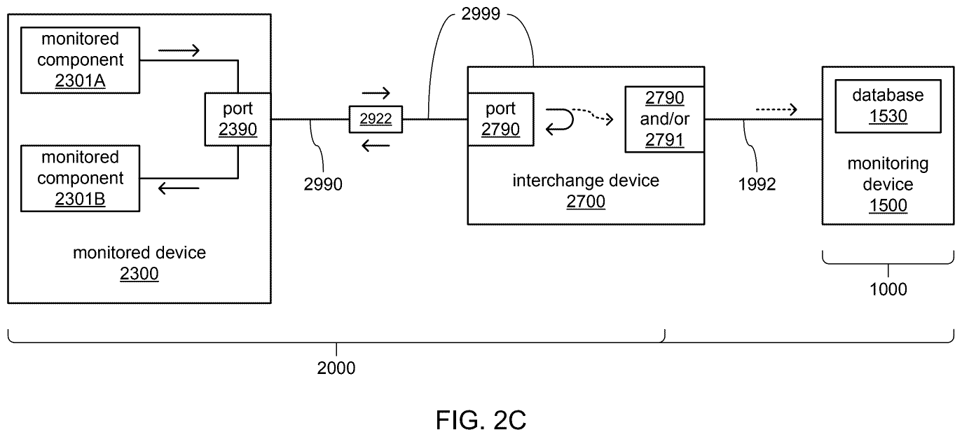

FIGS. 2A, 2B and 2C, taken together, present various aspects of example implementations of the internal network 2999, including example implementations of the interchange device(s) 2700.

Turning to FIG. 2A, and regarding the internal network 2999, each of at least a subset of the ports 2790 of an interchange device 2700 of the one or more interchange devices 2700 may be coupled by a separate link 2990 to a separate unmonitored device 2100 or monitored device 2300. As those skilled in the art will readily recognize, this may create a form of hub-and-spoke topology, or other electrically similar topology, in which an interchange device 2700 may be at the center of a set of point-to-point connections to a corresponding set of multiple devices 2100/2300. Regarding the external network 9992 (e.g., the Internet), at least one of the ports 2790 may be coupled, via a separate link 2992 and a relay device 2900 (e.g., a modem, a media converter, etc.), to the external network 9992, which in turn, may provide access to the one or more external servers 9900 from which various updated routines 9934 may be downloaded.

Turning briefly to FIG. 2B, along with FIG. 2A, in larger embodiments of the monitored system 2000, it may be that multiple interchange devices 2700 are coupled together to form a larger version of such a hub-and-spoke topology.

Returning to FIG. 2A, for each monitored system 2000, the span port 2791 and/or wire tap(s) of at least a single interchange device 2700 may be coupled, via a separate link 1992, to at least a single monitoring device 1500 of the monitoring system 1000. As the devices 2100 and/or 2300 of the monitored system 2000 engage in communications thereamong, and/or as the devices 2300 and external server(s) 9900 engage in communications therebetween, through the internal network 2999, copies and/or indications of at least operational commands and/or operational information that are transmitted in those communications may be relayed to the one or more monitoring devices 1500 via the span port(s) 2791 and/or wire tap(s), and via the links 1992. In some embodiments, it may be that such a single monitoring device 1500 is additionally or alternatively coupled, by another link 1992, to a bi-directional port 2790 of such a single interchange device 2700 to enable the single monitoring device 1500 to control one or more the interchange devices 2700, and/or to transmit an operational command or operational information to a monitored device 2300 or external server 9900 therethrough.

Turning again to FIG. 2B, along with FIG. 2A, where there are multiple interchange devices 2700 incorporated into an embodiment of the monitored system 2000, it may be that each one of the multiple interchange devices 2700 incorporates a separate network switch span port 2791. The span port 2791 of each of those multiple interchange devices 2700 may then be separately coupled, by a separate link 1992, to one or more monitoring devices 1500 of the monitoring system 1000 of that embodiment, thereby enabling each one of those multiple interchange devices 2700 to directly relay copies and/or indications of at least operational commands and/or operational information that are transmitted among the monitored devices 2300, and/or between the monitored devices 2300 and the external server(s) 9900. Alternatively, it may be that just a single one of those multiple interchange devices 2700 is so coupled to a single monitoring device 1500, and that single interchange device 2700 may relay copies and/or indications of such operational commands and/or operational information conveyed through any of the multiple interchange devices 2700 through that single span port 2791 and single link 1992.

Regardless of the quantity of interchange devices 2700 and/or the exact manner in which those interchange device(s) 2700 are coupled to one or more monitoring devices 1500, as previously discussed, the interchange device(s) 2700 may include the ability to be programmed to specify a particular subset of transmissions 2922 through the internal network 2999 for which copies and/or indications thereof are relayed to the monitoring device(s) 1500. Such a subset may be specified by identifiers of devices involved, types of transmission, types of protocol used, size of what is transmitted, time of day or day of week of transmissions, etc. Indeed, in some embodiments, it may be the use of identifiers of devices in defining such a subset that effectively defines which devices within the monitored system 2000 are the monitored devices 2300, versus which are the unmonitored devices 2100.

In embodiments in which the monitored system 2000 is made up of a set of networked computing devices, each link 1992, 2990 and/or 2992 may be implemented using any of a variety of wireless and/or cabling-based network technologies, including and not limited to, Bluetooth, Wi-Fi, cellular signaling, twisted-pair electrical cabling, coaxial electrical cabling, and fiber optic cabling. Such wireless and/or cabling-based technologies may adhere to any of a wide variety of specifications, including and not limited to, Ethernet and/or TCP/IP. In embodiments in which the monitored system 2000 is made up of a single computing device, each link 2990 and/or 1992 may be implemented using any of a variety of widely used and accepted internal bus specifications, including and not limited to, PCI-Express bus, and I²C bus.

As previously discussed, the interchange device(s) 2700 incorporated into a monitored system 2000 may vary in their sophistication. Again, each interchange device 2700 may be relatively simple, such as a network hub that essentially broadcasts each transmission 2922 that it receives at one port 2790 to all of its other ports 2790. Alternatively, each interchange device 2700 may be relatively sophisticated such that it may employ various levels of protocol analysis to implement a switching algorithm by which each transmission 2922 that it receives at one port 2790 is directed to one other specific port 2790 (unless the transmission 2922 that is received is specifically intended to be broadcast). As those skilled in the art will readily recognize, still more sophisticated implementations of an interchange device 2700 are possible that may incorporate even more complex functions that may entail the storage and/or logging of transmissions, content-based analysis of transmissions 2922, etc.

Thus, embodiments of the monitored system 2000 are possible in which an interchange device 2700 may be too rudimentary in its capabilities to be able to provide a span port 2791 as was depicted in the interchange devices 2700 shown in FIGS. 2A-B. Alternatively or additionally, it may be that there are insufficient ports. In such situations, one or more taps may be added.

Turning to FIG. 2C, in some embodiments, it may be that a monitored device 2300 includes multiple components 2301 where transmissions 2922 of operational commands or operational information thereto and/or therefrom are at least able to be observed through the link 2990 by which that monitored device 2300 is coupled to an interchange device 2700. More specifically, it may be that a single monitored device 2300 incorporates multiple components 2301 that are each able to be separately addressed and communicated with through that link 2990 in a manner almost akin to being entirely separate devices. Alternatively or additionally, it may be that transmissions 2922 of operational commands or operational information among multiple components 2301 within a single monitored device 2300 are also reflected on that link 2990.

Thus, and by way of example, where the depicted monitored component 2301A of the depicted monitored device 2300 transmits an operational command or operational information to another depicted monitored component 2301B within the same monitored device 2300, a copy of that transmission 2922 may also be transmitted onto the depicted link 2990, thereby enabling the depicted interchange device 2700 to relay a copy and/or indication of that transmission 2922 onward to the depicted monitoring device 1500. As still another alternative, it may be that such a transmission 2922 between the depicted monitored components 2301A and 2301B is performed by the monitored component 2301A transmitting the operational command or operational information out to the depicted interchange device 2700, followed by the interchange device 2700 relaying that operational command or operational information back along the same link 2990 to the monitored component 2301B.

Regardless of the exact manner in which transmissions 2922 of operational commands or operational information are relayed to the monitoring device(s) 1500 of the monitoring system 1000, as will shortly be explained in greater detail, the copies and/or indications of operational commands or operational information that are so relayed may be compared to information stored within the database 1533 concerning what transmissions 2922 of operational commands and/or operational information are expected to occur (and when) as part of identifying instances in which observed transmissions 2922 of operational commands or operational information deviate from what is expected.

### Correlations Among Transmissions and Process States—External Process Control

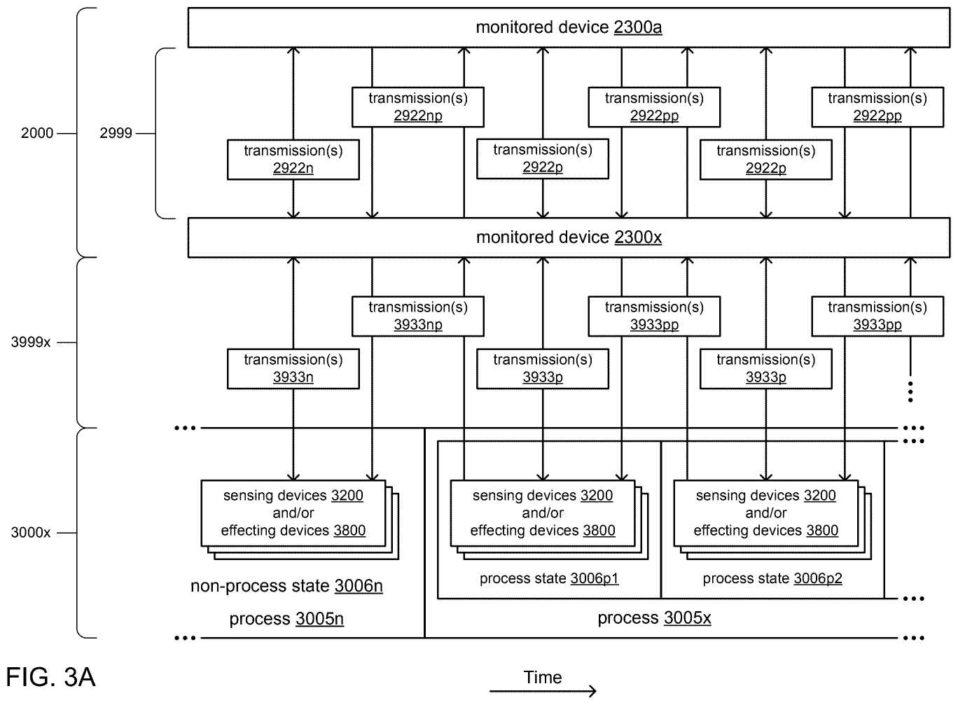

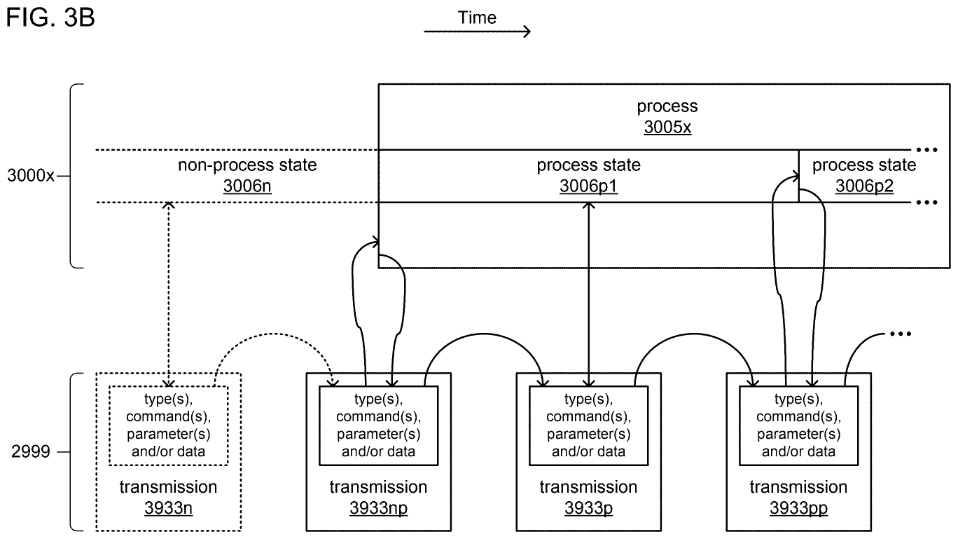

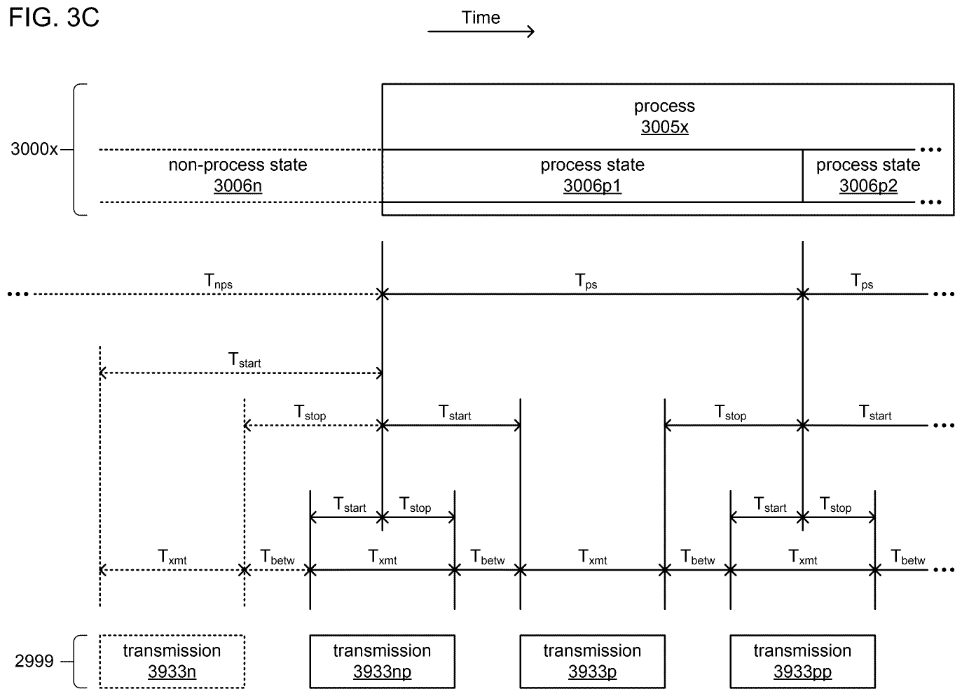

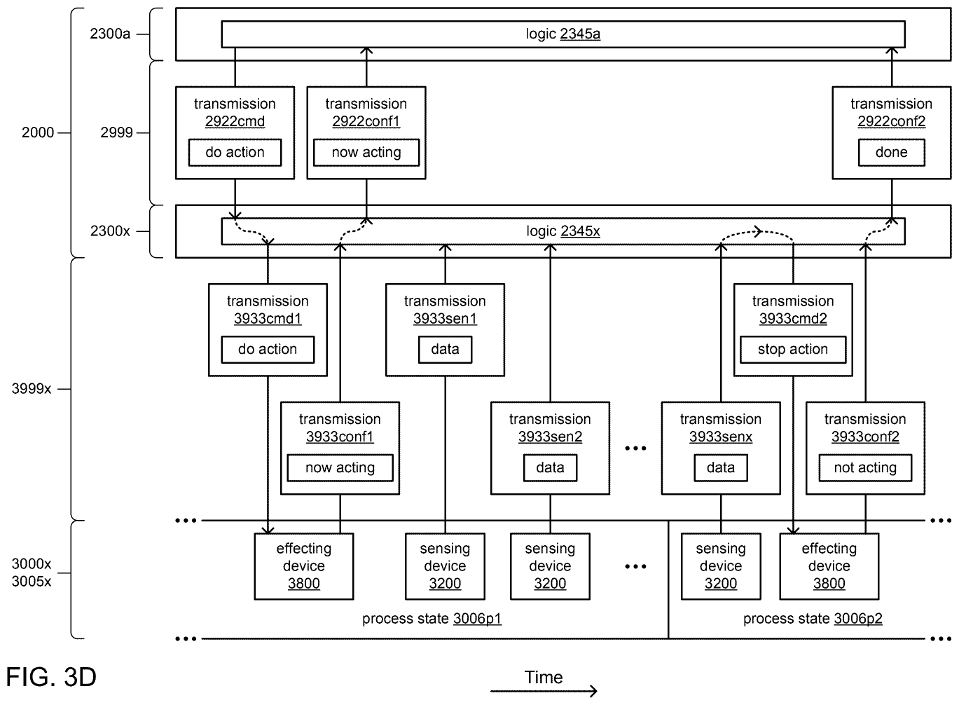

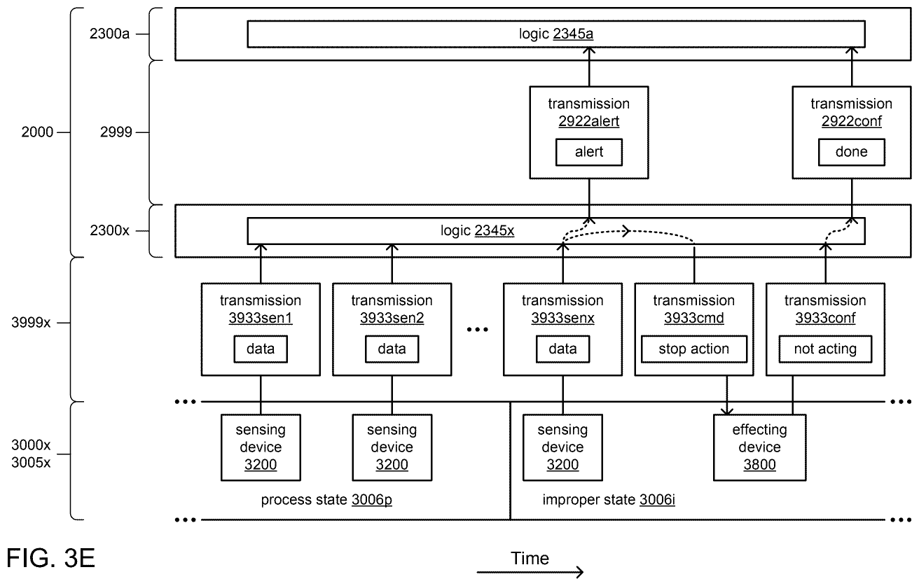

FIGS. 3A, 3B, 3C, 3D and 3E, taken together, present various aspects of the manner in which transmissions 2922 and 3933, a process state machine (i.e., the example process 3005x), and logic employed within monitored devices (i.e., the logic 2345a and 2345x of the monitored devices 2300a and 2300x, respectively) correlate and interact to control a performance of a process (i.e., the example process 3005x).

Turning to FIG. 3A, as previously discussed, and as depicted, a process performed within one of the external systems 3000 may be defined as having a tree of multiple states that is traversed during its performance, such as the depicted process states 3006p1, 3006p2, etc., of the depicted process 3005x performed within the depicted external system 3000x. Also, such an external system as the depicted external system 3000x may include one or more sensing devices 3200 to monitor various aspects of the process 3005x performed therein, and/or one or more effecting devices 3800 to effect various aspects of a performance of the process 3005x therein.

As also previously discussed, one or more transmissions 2922 through the internal network 2999, and/or one or more corresponding transmissions 3933 through the link(s) 3999x, may be associated with the beginning of a performance of the process 3005x. More specifically, in various embodiments, there may be one or more transmissions 2922np and/or 3933np that trigger the commencement of the process 3005x. By way of example, there may be transmission(s) 2922np that convey operational command(s) between monitored devices 2300 (e.g., the depicted monitored devices 2300a and 2300x) through the internal network 2999 to prepare for beginning the process 3005x, and/or to actually begin the process 3005x. Such operational command(s) to the monitored device 2300x may, in turn, cause one or more effecting devices 3800 to be commanded with corresponding transmission(s) 3933np through the link(s) 3999x to perform operations that implement such preparations, and/or that actually begin the process 3005x, thereby causing a transition from a non-process state 3006n to the depicted first process state 3006p1 of the process 3005x.

Alternatively, it may be that the process 3005x is responsive to external inputs such that the beginning of a performance of the process 3005x may be triggered in a manner that is not based on the occurrence of transmissions. Thus, from the perspective of the internal network 2999 and the link(s) 3999x, it may be that the first transmission associated with a performance of the process 3005x is a transmission indicating that the process 3005x has already begun. By way of example, there may first be transmission(s) 3933np through the link(s) 3999x that convey operational information that preparations for beginning the process 3005x have been completed, and/or that the process 3005x has begun such that the transition from the depicted non-process state 3006n to the first process state 3006p1 has already occurred. Such operational information to the monitored device 2300x may, in turn, cause corresponding transmission(s) 2922np between the monitored devices 2300a and 2300x to relay such operational information onward to the monitored device 2300a. Such operational information may include data collected by one or more sensing devices 3200 at a time immediately preceding, during and/or immediately after the transition to the process state 3006p1.

It should be noted that, during the depicted non-process state 3006n prior to the process 3005x being triggered to begin, there may be one or more transmissions that are not associated within performing the process 3005x, at all, such as the depicted one or more transmissions 2922n and/or 3933n. Such transmissions 2292n and/or 3933n may be associated with maintaining the external system 3000x in the depicted non-process state 3006n, such as a distinct “off” state, a “sleep” state, or a “standby” state. As will be familiar to those skilled in the art, such a non-process state 3006n may be configured to minimize the consumption of energy, to maintain device(s) in a known inactive state, and/or to maintain substance(s) in a known safe storage state. Such a minimal consumption of energy may be directed toward maintaining a cache of pre-loaded data in readiness for a future performance of the process 3005x, and/or such a safe storage state may preserve substances in a condition for use in a future performance of the process 3005x.

By way of example, there may be transmission(s) 2922n that convey operational command(s) between monitored devices 2300a and 2300x through the internal network 2999 to effect and/or maintain the non-process state 3006n. Such operational command(s) may, in turn, cause one or more effecting devices 3800 to be commanded via transmission(s) 3933n through the link(s) 3999x to perform operations that implement and/or maintain various aspects of the non-process state 3006n. Alternatively or additionally, there may be transmission(s) 3933n through the link(s) 3999x, and corresponding transmissions 2922n through the internal network 2999 that convey operational information to the monitored device 2300a concerning aspects of maintaining the non-process state 3006n. Such operational information may include data collected by one or more sensing devices 3200 about the ongoing preservation of data, and/or about the ongoing preservation of substance(s) in storage.

For purposes of monitoring transmissions that pass through the internal network 2999 as an approach to monitoring the performance of a process occurring within an external system 3000, such as the example process 3005x occurring within the external system 3000x, it may be that a particular transmission 2922n associated with the non-process state 3006n, a particular transmission 2922np associated with the transition from the non-process state 3006n to the process state 3006p1, or a combination of multiple transmissions 2922n and/or 2922np, is selected to serve as an indication, that is observable on the internal network 2999, that the process 3005x has begun. Thus, by monitoring transmissions 2922 occurring on the internal network 2999 (through one or more interchange devices 2700), a monitoring device 1500 may identify instances in which such particular transmissions 2922n and/or 2922np (or such a combination thereof) have occurred on the internal network 2999, and use such instances as an indication of when to begin monitoring the internal network 2999 for transmissions 2922 associated with the process 3005x.

Just as some transmissions 2922 and/or 3933 may be associated with the commencement of a performance of a process, others may be associated with the performance progressing between process states. Returning to the example process 3005x, there may be various transmissions 3933pp through the link(s) 3999x, and/or transmissions 2922pp through the internal network 2999, that may be associated with transitioning between the process states 3006p1 and 3006p2. More precisely, there may be transmission(s) 2922pp and/or 3933pp that are associated with the process state 3006p1 ending (with a presumption of the next process state beginning), and/or there may be transmission(s) 2922pp and/or 3933pp that are associated with the process state 3006p2 beginning (with a presumption of the preceding process state having ended). Somewhat similar to the aforedescribed commencement of the process 3005x, this may arise from the fact that some transmission(s) 2922pp and/or 3933pp may trigger the ending of the process state 3006p1, some may be caused to occur by the ending of the process state 3006p1, some may trigger the beginning of the process state 3006p2, and/or some may be caused to occur by the beginning of the process state 3006p2. Also in a manner somewhat similar to the commencement of the process 3005x, the transmission(s) 2922pp and/or 3933pp that trigger the beginning or the ending of a process state may do so by conveying operational command(s) that cause effecting device(s) 3800 to be commanded to perform operations that effectuate such a beginning or ending. Correspondingly, transmissions that are caused to occur by the beginning of a process state, or are caused to occur by the ending of a process state, may convey operational information that includes data collected by one or more sensing devices 3200 associated with such a beginning or ending.

Additionally, during a process state (e.g., during one of the depicted process states 3006p1 or 3006p2), there may be transmissions 2922p that convey operational commands and/or operational information between the monitored devices 2300a and 2300x, and/or corresponding transmissions 3933p between the monitored device 2300x and either or both of the sensing device(s) 3200 and/or the effecting device(s) 3800. Again, such transmissions may convey operational information that may include data collected by sensing devices 3200 that is indicative of various measurements associated with a portion of the process 3005x that occurs during a process state. Alternatively or additionally, such transmissions may convey operational commands that cause effecting device(s) 3800 to perform various operations during a process state.

As previously discussed, for the example process 3005x performed within the external system 3000x, the monitored devices 2300a and 2300x, together, may implement the logic for controlling the progression of those performances through the various process states thereof. As part of exerting such control, the logic implemented within each of the monitored devices 2300a and 2300x functions in a manner that is at least partially responsive to received inputs. While such inputs may include transmissions 2922 and/or 3933 originating from within the monitored system 2000 and/or the external system 3000x, others of such inputs may be external inputs that originate entirely outside of both systems 2000 and 3000x. By way of example, the monitored device 2300a may provide a user interface (not specifically shown) that may be operable to enable manual control of when a performance of the process 3005x commences and/or other aspects thereof. By way of another example, components and/or devices within the external system 3000x may be subject to external influences (e.g., availability of various external resources, weather conditions, etc.) that may constrain, enable and/or disable various aspects of the process 3005x. Further, regardless of what each such external input may be, the timing of each such external input may at least partially determine what effect it has on a performance of the process 3005x.

FIG. 3B depicts aspects of various causal relationships among various aspects of a performance of a process, such as the depicted process 3005x. More specifically, there may be causal relationships between transmissions 3933 and at least a subset of the process states 3006p. As those skilled in the art will readily recognize, such causal relationships may dictate what transmissions 3933 are to occur on the network 2999, the type of transmission (e.g., a transmission conveying operational command(s), or a transmission conveying operational information), aspects of the content of each transmission (e.g., which operational command is conveyed, what parameters accompany each command, and/or what data values are included in operational information that is conveyed), and/or the timing of each transmission (e.g., when each transmission is expected to occur on the network 2999).

As previously discussed, there may be one or more transmissions 3933np that may trigger the beginning of a performance of the process 3005x, and various aspects of such transmission(s) 3933np may be dictated by various requirements associated with the process 3005x. By way of example, it may be that the protocol used to control the process 3005x dictates that at least one particular operational command be transmitted to triggering the commencement of the process 3005x. This may dictate that a transmission 3933np of a type that conveys an operational command is required, and that the particular operational command specified by the protocol is the one that is to be conveyed. The same protocol may also dictate one or more of the parameters that are to be included with the particular operational command in that transmission 3933np.

Again, the transmissions 3933n that occur during the depicted non-process state 3006n may be associated with monitoring and/or maintaining aspects of the non-process state 3006n, and may not be associated with the process 3005x. However, it may also be that there is a causality between the occurrence of such a transmission 3933n during the non-process state 3006n, and a later transmission 3933np that triggers the commencement of the process 3005x. By way of example, it may be that operational information that is conveyed in one or more of the transmissions 3933n includes data indicative of measurements taken during the non-process state 3006n that in some way influences a parameter of an operational command that is later conveyed in a transmission 3933np that triggers the commencement of the process 3005x. As those skilled in the art will readily recognize, such a situation may arise where a measurement of an aspect of a device and/or of a substance that is taken during the non-process state 3006n may influence an aspects of how the process 3005x is to begin, such as a temperature reading taken during the non-process state 3006n that affects of a parameter for controlling heating or cooling within an operational command for triggering the commencement of the process 3005x. As will be discussed further, there may be logic employed in the control of the process 3005x that is used to derive a value for such a parameter based on such input as an earlier-collected measurement.

As also previously discussed, there may be one or more transmissions 3933np that are caused to occur by the commencement of the process 3005x. By way of example, it may be that the protocol used to control the process 3005x dictates that operational information be conveyed that includes an indication of success or failure in commencing performance of the process 3005x, along an indication of the type of failure in situations where failure occurs. This may dictate that a transmission 3933np of a type that conveys operational information is required, as well as dictating what operational information is to be included. The same protocol may also dictate one or more aspects of the formatting of the data values that are used to represent that operational information in that transmission 3933np. As will be discussed further, there may be logic employed in the control of the process 3005x that is used to identify such a failure, and thereby determine the particular indication of type of failure that may be included in such operational information.

In a manner similar to the transmission(s) 3933np associated with the commencement of a process 3003, there may be one or more transmissions 3933pp that may trigger a transition between process states 3006, such as the depicted transition from the process state 3006p1 to the process state 3006p2 of the depicted process 3005x. This may include transmission(s) 3933pp that separately trigger the ending of one process state 3006p, and/or transmission(s) 3933pp that separately trigger the beginning of the next process state 3006p, as well as transmission(s) 3933pp that may serve both purposes. Also in a similar manner, various aspects of such transmission(s) 3933pp may be dictated by various requirements associated with the process 3005x, and/or dictated by various requirements of the particular process states 3006 between which the transition occurs. Again, such aspects may include requirements for the transmission(s) 3933pp based on protocols uses. Also, and as will be discussed further, there may be logic employed in the control of the process 3005x that is used to determine what operational commands and/or what operational information is to be transmitted, used to derive values for parameters of operational commands that may be transmitted, and/or used to derive data values included in operational information that may be transmitted.

Again, the transmissions 3933p that occur during each of process state 3006p may be associated with monitoring and/or controlling operations that are performed during each of the process states 3006p as part of performing the process 3005x. As depicted, there may be causality between such transmissions 3933p and preceding transmissions 3933np for the commencement of the process 3005x and/or preceding transmissions 3933pp for a preceding transition between process states 3006p. Alternatively or additionally, there may be causality between such transmissions 3933p and subsequent transmissions 3933pp for a subsequent transition between process states 3006p. Also alternatively or additionally, there may be causality among such transmissions 3933p associated with a single process state 3006p, or among multiple process states 3006p. Each of such causalities may include influences that previously transmitted operational commands, parameters of previously transmitted operational commands, and/or data values in previously transmitted operational information, may exert on subsequently transmitted operational commands, parameters of subsequently transmitted operational commands, and/or data values in subsequently transmitted operational information. Again, there may be logic employed in the control of the process 3005x that is used to determine what operational commands and/or what operational information is to be transmitted, used to derive values for parameters of operational commands that may be transmitted, and/or used to derive data values included in operational information that may be transmitted.

FIG. 3C depicts aspects of various timing relationships among various aspects of a performance of a process, such as the depicted process 3005x. More specifically, there may be timing relationships between transmissions 3933 and at least a subset of the process states 3006p. The earlier discussed causal relationships may at least partially dictate aspects of the timing of at least a subset of the transmissions 3933n, 3933np, 3933p and/or 3933pp.

More specifically, the start times (Tstart), the stop times (Tstop) and/or the transmission duration times (Txmt) for at least a subset of these transmissions may be at least partially determined by whether each of such transmissions is causes or is caused by the commencement of the process 3005x, and/or causes or is caused by a transition between process states 3006p. Thus, although FIG. 3C depicts an example transmission 3933np as occurring at least partially simultaneously with the transition from the non-process state 3006n and to the process state 3006p1, the entirety of this same example transmission 3933np could occur entirely before that transition or entirely afterward. Similarly, although an example transmission 3933pp is depicted as occurring at least partially simultaneously with the transition from the process state 3006p1 and to another process state 3006p, the entirety of this same example transmission 3933pp could occur entirely before that transition or entirely afterward.

Also depicted is an example transmission 3933n that occurs entirely within the non-process state time period (Tnps) of the non-process state 3006n, and an example transmission 3933p that occurs entirely within the process state time period (Tps) of the process state 3006p1.

However, despite the role that causality in connection with such transitions may play in at least partially dictating timing of various ones of these transmissions 3933n, 3933np, 3933p and/or 3933pp, other factors unrelated to such transitions may also play a role. By way of example, during the portion of the performance of the process 3005x that occurs during the depicted process state 3006p1, a circumstance may arise that triggers the occurrence of a transmission 3933p during that process state that conveys operational information indicative of a milestone in the process 3005x having been reached, or of an anomalous event having been detected by one of the sensing devices 3200 (e.g., a high temperature reading, or of a lack of imminent lack of available data storage space). While such a transmission 3933p may occur entirely within the Tps of the process state 3006p1, its occurrence may be entirely based on logic used to trigger such notification transmissions, and may not actually be dictated by any direct constraint relative to either the start or end of that time period beyond the fact that such logic may only be used during the process state 3006p1.

FIGS. 3D and 3E present differing examples of responses by the logic 2345a and 2345x implemented within the monitored devices 2300a and 2300x, respectively, to various combinations of internal and external inputs. As each of these two figures makes clear, and as will be explained in greater detail, there are time delays inherent in implementing such logic to also be taken into account in providing emulations of computing devices that implement such logic, such as the monitored devices 2300a and 2300x.

Turning to FIG. 3D, the monitored device 2300a may implement a UI (not specifically shown) by which an operator of the monitored device 2300a may manually input a command to cause the process 3005x being performed within the external system 3000x to progress from process state 3006p1 to process state 3006p2. By way of example, such an operator may enter a command to perform an action such as heat a tank filled with water in the external system 3000x.

It is important to note that the timing of such manual input by the operator may be extremely difficult, if not impossible, to predict. This, in turn, may make the timing of when the first transmission in the depicted series of transmissions similarly difficult to predict. However, the timings of at least some of the following transmissions relative to each other may be far more easily predicted, as will be explained in greater detail.

In response to receiving such manually entered input from the operator, the logic 2345a implemented within the monitoring device 2300a may cause the monitored device 2300a to output a transmission 2922cmd onto the internal network 2999 that conveys an operational command to the monitored device 2300x to do the commanded action (e.g., heat a tank). As will be explained in greater detail, such a response to such manual input may be an example of a causal relationship implemented as part of the logic 2345a within the monitored device 2300a for controlling the process 3005x.

In response to receiving the transmission 2922cmd, the monitored device 2300x may relay the operational command to do the commanded action onward in a transmission 3933cmd1 to the effecting device 3800 of the external system 3000x via the one or more communication links 3999x. As depicted, there is a time delay within the monitored device 2300x between the time of receipt of the transmission 2922cmd and the time of output of the transmission 3933cmd1.

As will be explained in greater detail, this relaying of the operational command, through the monitored device 2300x, and from the transmission 2922cmd to the transmission 3933cmd1, is an example of a causal relationship implemented as part of the logic 2345x within the monitored device 2300x for controlling the process 3005x. Stated differently, the logic 2345x implemented within the monitored device 2300x may include logic to cause such relaying of an operational command of this type through the monitored device 2300x, and onward to the external system 3005x.

In response to receiving the transmission 3933cmd1, the effecting device 3800 may act on the operational command therein to do the commanded action (e.g., turning on a heating device to heat a tank). The effecting device 3800 may output, onto the links 3999x and back to the monitored device 2300x, a transmission 3933conf1 conveying operational information that confirms that the operational command is being acted upon by doing the commanded action.

In response to receiving the transmission 3933conf1, the monitored device 2300x may relay the operational information confirming that the operational command is being acted on onward in a transmission 2922conf1 to the monitored device 2300a via the internal network 2999. As depicted, there is again a time delay within the monitored device 2300x between the time of receipt of the transmission 3933conf1 and the time of output of the transmission 2922conf1. Via the UI, the operator may be informed of this received confirmation.

Within the external system 3000x, one or more sensing devices 3200 may output a succession of transmissions indicative of the results, over time, of the commanded action being performed. More specifically, as the tank is being heated, each transmission in a series of transmissions 3933sen1 through 3933senx may convey operational information concerning the increasing temperature of the tank to the monitored device 2300x via the communication link(s) 3999x. The transmission 3933senx may convey operational information indicating that the tank has reached a particular temperature that is associated with a transition to the process state 3006p2.

The amount of time that it takes to heat the tank to the particular temperature may be subject to external inputs that make such an amount of time relatively difficult to predict. More specifically, if the tank is part of an apparatus that is exposed to the elements, then the amount of time required to heat the tank to the particular temperature may be affected by the weather. Thus, the quantity of transmissions within the series of transmissions 3933sen1 to 3933senx may be difficult, if not impossible, to predict, and this may make the timing of when the transmission 3933senx is output onto the link(s) 3999x similarly difficult to predict.

In response to receiving the transmission 3933senx, the monitored device 2300x may output a transmission 3933cmd2 conveying an operational command to the same effecting device 3800 to stop acting on the earlier operational command in the earlier transmission 3933cmd1. Thus, the effecting device 3800 may be commanded to stop heating the tank. Again, there is a time delay within the monitored device 2300x between the time of receipt of the transmission 3933senx and the time of output of the transmission 3933cmd2.

In response to receiving the transmission 3933cmd2, the effecting device 3800 may act on the operational command therein to cease doing the commanded action (e.g., cease heating the tank). The effecting device 3800 may output, onto the link(s) 3999x and back to the monitored device 2300x, a transmission 3933conf2 conveying operational information that confirms that the earlier operational command to heat the tank is now no longer being acted upon.

In response to receiving the transmission 3933conf2, the monitored device 2300x may relay the operational information confirming that the original operational command to heat the tank has ceased to be acted upon onward in a transmission 2922conf2 to the monitored device 2300a via the internal network 2999. Again, there is a time delay within the monitored device 2300x between the time of receipt of the transmission 3933conf2 and the time of output of the transmission 2922conf2. Via the UI, the operator may be informed of this received confirmation.

Turning to FIG. 3E, during a performance of the process 3005x, a condition may develop that necessitates stopping the process 3005x as a safety measure. By way of example, it may be that a temperature of a device within the external system 3000x exceeds a threshold, as detected by sensing device 3200, and the logic 2345a and 2345x employed by the monitored devices 2300a and 2300x, respectively, may respond by automatically stopping the process 3005x and providing an alert to an operator.

In a manner similar to the timing of manual input in the above example of FIG. 3D, the timing of when such a condition as overheating may occur may be at least extremely difficult, if not impossible, to predict. This, in turn, may make the timing of when a transmission responsive to such an event is output similarly difficult to predict. However, it should again be noted that the timings of at least some of the transmissions relative to each other may be far more easily predicted, as will be explained in greater detail.

During a process state 3033p of the process 3005x, one or more sensing devices 3200 of the external system 3000x may output a series of transmissions 3933sen1 through 3933senx onto the communication link(s) 3999 and to the monitored device 2300x. Each of these transmissions in this series may convey operational information concerning the status of one or more aspects of the process 3005x, which may include a temperature of a device of the external system 3005x.

As depicted, the process 3005x may go awry such that a transition is made from the depicted process state 3033p in which the process 3005x may be proceeding normally, and to an improper state 3006i in which the process 3005x is no longer proceeding normally. For purposes of this example, it may be that the temperature of that same device of the external system 3005x has risen beyond a particular threshold.

In response to receiving the transmission 3933senx, the logic 2345x implemented within the monitored device 2300x for controlling the process 3005x may output two transmissions. One of the two transmissions may be a transmission 2922alert output onto the internal network 2999 to convey operational information to the monitored device 2300a that includes an alert that a condition such as an excessive temperature level of a device has arisen. Logic 2345a within the monitored device 2300a for controlling the process 3005x may present the alert to an operator via a UI (not specifically shown). The other of the two transmission may be a transmission 3933cmd that is output onto the link(s) 3999x to convey an operational command to an effecting device 3800 within the external system 3000x to perform an action that stops the process 3005x.

As depicted, the output of each of the transmissions 2922alert and 3933cmd occurs with some amount of delay following receipt of the transmission 3933senx. As also depicted, the delay in the output of the transmission 3933cmd may be somewhat longer as a result of a need for the logic 2345x implemented within the monitored device 2300x to determine whether the process 3005x is to be stopped, and if so, what measure(s) to take to cause the process 3005x to be stopped.

In response to receiving the transmission 3933cmd, an effecting device 3800 of the external system 3000x may act on the operational command therein to cause the process 3005x to be stopped. The effecting device 3800 may output, onto the link(s) 3999x and back to the monitored device 2300x, a transmission 3933conf conveying operational information that confirms that the operational command to stop the process 3005x is now being acted upon.

In response to receiving the transmission 3933conf, the monitored device 2300x may relay the operational information confirming that the process 3005x is being stopped onward in a transmission 2922conf to the monitored device 2300a via the internal network 2999. Again, there is a time delay within the monitored device 2300x between the time of receipt of the transmission 3933conf and the time of output of the transmission 2922conf. Via the UI, the operator may be informed of this received confirmation.

### Correlations Among Transmissions and Process States—Update Download Control

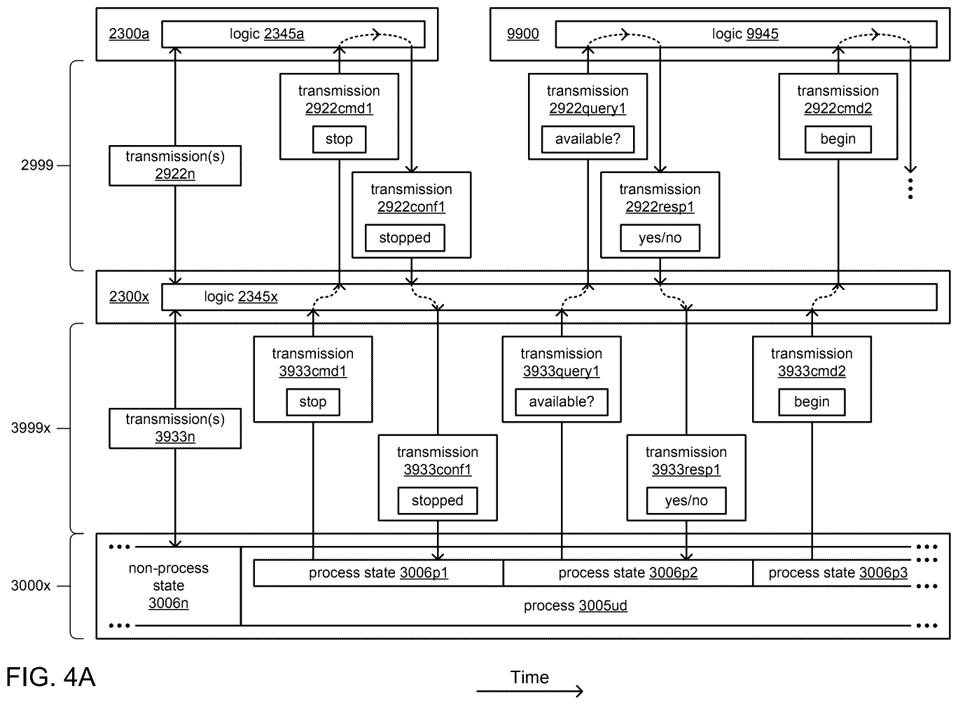

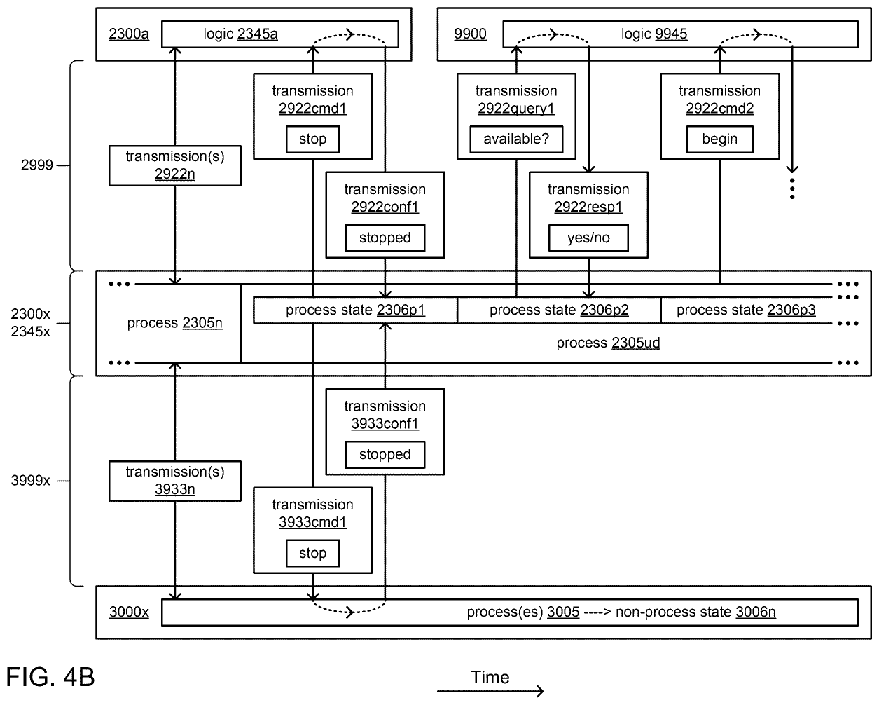

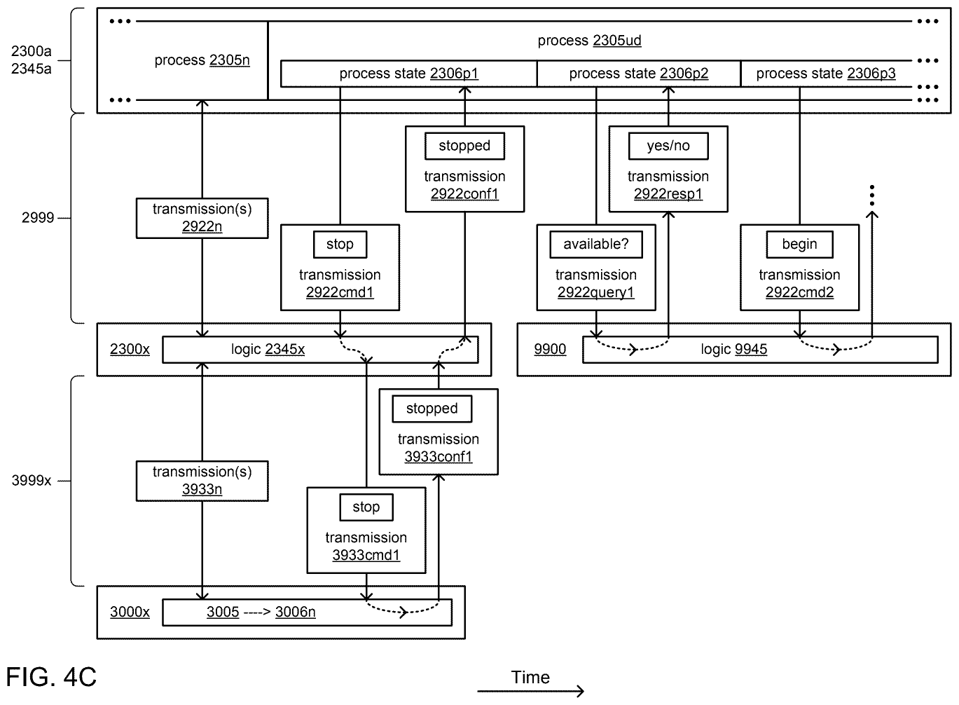

Each of FIGS. 4A, 4B and 4C present aspects of a separate example of the manner in which transmissions 2922 and 3933, an update download state machine, and/or logic employed within different monitored devices or external system correlate and interact to control a performance of an update download process.

Referring to all three of FIGS. 4A-C, as previously discussed, just as the earlier example process 3005x performed within the external system 3000x may progress through a set of process states (e.g., a tree process states of a state machine), the same may also be true of an update download process 3005ud that may also be performed within the example external system 3000x, and/or may also be true of an update download process 2305ud that may be performed within the example monitored device(s) 2300a and/or 2300x.

In a manner also similar to the earlier example process 3005x, one or more transmissions 2922 through the internal network 2999, and/or one or more corresponding transmissions 3933 through the link(s) 3999x, may be associated with the beginning of a performance of the process 3005x. More specifically, in various embodiments, there may be one or more transmissions 2922 and/or 3933 that trigger the commencement of the update download process 2305ud and/or 3005ud. By way of example, there may be various transmission(s) 2922 that convey operational command(s) among the monitored devices 2300a and/or 2300x, and/or that convey operation command(s) between those monitored devices and the external system 3000x that are meant to trigger start of an update download process 2305ud or 3005ud, and/or that are meant to cause a cessation of one or more other processes in preparation for such an update download process.

As those familiar with the updating of low level firmware, operating system routines, libraries that support the execution of application routines, and/or the application routines, will readily recognize, it is often necessary to cause the performances of one or more other processes to cease before engaging in such an update to avoid any of a variety of unpredictable behaviors that may be caused by an updating process. By way of example, it may be that an update process causes one or more hardware components and/or software routines to become inaccessible such that other process(es) may become uncontrollable, unpredictably change to an improper state, remain stuck in a particular process state for longer than is proper, etc. Hardware components that may become inaccessible may include storage devices, interrupt controllers, network interfaces, etc. Alternatively or additionally, software links between differing software routines may become broken such that necessary cooperation between those routines may be entirely lost. Thus, in situations where there is a seemingly well-founded belief that a particular update download process is able to be performed within a particular and/or system without a need to cease the performance(s) of other process(es), it may be regarded as a best practice to do so in any case.

As an alternative to one or more transmissions 2922 and/or 3933 triggering the commencement of an update download process 2305 or 3005, and also in a manner similar to the earlier example process 3005x, it may be that the commencement of an update download process is responsive to external inputs such that the beginning of a performance of the process 3005x may be triggered in a manner that is not based on the occurrence of such transmissions. Thus, from the perspective of the internal network 2999 and the link(s) 3999x, it may be that the first transmission 2922 or 3933 associated with a performance of an update download process 2305ud or 3005ud is a transmission indicating that such a process has already begun. By way of example, there may first be transmission(s) 2922 and/or 3933 that convey operational information that preparations for beginning an update download process have been completed, and/or that such a process has begun such that the transition to a first process state associated with such a process has already occurred.

As previously discussed in reference to the earlier example process 3005x, it may be that a monitoring device 2300 and/or an external system 3000 provides a user interface (UI) by which an operator thereof may manually trigger a download of an updated routine from an external server 9900. Alternatively or additionally, there may be a recurring moment or interval of time (e.g., a particular hour each night, a particular day of each week, a particular date of each month, etc.) at which at least a check for the availability of such downloads is made (which may be immediately followed by the occurrence of such downloads). Thus, the trigger for downloading an updated routine may, at least in part, be a timing component within a monitoring device 2300 and/or an external system 3000.

Thus, in a manner that is further similar to the earlier example process 3005x, in monitoring network activity on the internal network 2999, it may be one or more particular transmissions 2922 associated with a non-process state, one or more particular transmissions 2922 associated with a first process state of an update download process 2305ud or 3005ud, or a combination thereof, that serves as the indicator used by the monitoring device(s) 1500 that an update download process 2305ud or 3005ud has begun. Alternatively or additionally, it may be a combination of one or more transmissions 2922 associated with the cessation of one or more other unrelated processes, and one or more transmissions 2922 associated with the commencement of an update download process that serves as the indicator of that commencement of that update download process. Also alternatively or additionally, it may be that a combination of one or more particular transmissions 2922, and particular timing (e.g., a recurring interval of time, a time of each day, a day of each week, a date in each month, etc.) that serves as the indicator that commencement of that update download process.

Additionally similar to the earlier example process 3005x, it may be particular transmissions 2922 that serve as indicators of transitions between process states of such an update download process. Again, each of such transmissions 2922 associated with such a transition may be a transmission 2922 that is connected to activity occurring at the end of a previous process state, that is connected to activity occurring at the beginning of a next process state, or that is connected to explicitly triggering and/or explicitly indicating a transition therebetween.

However, despite such similarities that may exist in correlations between process states and observable transmissions 2922 and/or 3933, the update download processes 2305ud and/or 3005ud may differ from the earlier example process 3005x in that the control of the update download processes 2305ud and/or 3005ud may not involve so much cooperation through the internal network 2999. More specifically, and as previously discussed, control of the example process 3005x performed within the external system 3000x involved cooperation among at least the two monitored devices 2300a and 2300x through the internal network 2999. In contrast, the complexity of the control required to simply download an updated routine may be far less, and indeed, may be made up largely of repeated transmissions of a very limited variety of operational commands that serve as little more than an ongoing handshake. Thus, the logic and/or state machine that may be implemented within one of the monitored devices 2300a or 2300x, or that may be implemented within the external system 3000x, to receive an updated routine may be relatively simple in comparison with the multiple logic(s) and/or state machine(s) implemented to control the earlier example process 3005x using the combination of monitored devices 2300a and 2300x.

Each of FIGS. 4A-C present a differing example of actions and responses to actions implemented within the monitored devices 2300a and 2300x, and the external system 3000x associated with downloading an updated routine from an external server 9900. Also, as each of these figures makes clear, there are time delays inherent in implementing logic and/or a state machine that are to be taken into account in providing emulations thereof.

FIG. 4A presents an example of an update download process 3005ud implemented as a state machine that is performed within the external system 3000x to download an updated routine from an external server 9900.

As depicted, there may be various transmissions 2922n and/or 3933n that occur at a time before the update download process 3005ud begins within the external system 3000x with the entry into the first process state 3006p1 of the update download process 3005ud. More specifically, and as depicted, it may be that no process was being performed within the external system 3000x during a non-process state 3006n in the time leading up to the commencement of the update download process 3005ud.

As depicted, the update download process 3005ud may commence (starting with the first process state 3006p1) without a trigger from a transmission 2922 or 3933 of any type. Instead, it may be that the first process state 3006p1 is triggered to begin by another external input, such as the previously discussed commanded beginning by an operator through a UI of the external system 3000x, or the previously discussed timed trigger to begin. Regardless of the exact manner in which the first process state 3006p1 of the update download process 3005ud is caused to begin, it may be that a function of the process state 30006p1 is to cause the cessation of performances of one or more other processes within the external system 3000x. Again, this may be done as a best practice to prevent a situation in which there is unpredictable behavior in the performance of a process that might cause damage to property and/or injury to personnel. Thus, during the process state 3006p1, the external system 3000x may be caused to output, onto the link(s) 3999x and to the monitored device 2300x, a transmission 3933cmd1 conveying an operational command to cause a cessation in performance of one or more other processes that may be performed within the external system 3000x under the control of the monitored devices 2300a and 2300x.

As previously discussed in connection with the example process 3005x, there may be cooperation among at least the monitored devices 2300a and 2300x that provides the control over the example process 3005x and/or other processes that may be performed within the external system 3000x. Thus, such a transmission 3933cmd1 through the link(s) 3999x, and directed to the device(s) that exercise control over processes performed within the external system 3000x may be necessary to cause performance(s) of such processes to stop.

In response to receiving the transmission 3933cmd1 at the monitored device 2300x, the logic 2345x implemented therein may cause the monitored device 2300x to relay the operational command onward to the monitored device 2300a in a transmission 2922cmd1 thereto via the internal network 2999. The logic 2345x may also respond by at least ceasing to cause the monitored device 2300x to output, onto the link(s) 3999x and to the external system 3000x, transmissions 3933 that would cause one or more processes (other than the update download process 3005ud) to continue to be performed within the external system 3000x.

The logic 2345x may further respond to the receipt of the transmission 3933cmd1 by causing the monitored device 2300x to output, onto the link(s) 3999x and to the external system 3000x, one or more further transmissions 3933 (not specifically shown) to actively take one or more steps to cause the cessation of performance(s) of one or more processes that might currently be underway within the external system 3000x. Alternatively or additionally, the logic 2345x may further respond by causing the monitored device 2300x to output, onto the link(s) 3999x and to the external system 3000x, one or more further transmissions 3933 (not specifically shown) to cause various components of the external system 3000x to be placed into a known stable state. As previously discussed, this may entail a variety of actions, including and not limited to, powering down various components, stopping the movement of various components, moving various components to a known stable condition, setting conditions of various components to enable data and/or various substances to be maintained at known stable conditions, etc. The various known stable states into which various components may be placed may be specifically selected to enable one or more other processes 3005 to be relatively easily resumed after the update download process 3005ud is completed.

In response to receiving the transmission 2922cmd1 at the monitored device 2300a, the logic 2345a implemented therein may at least cease to cause the monitored device 2300a to output, onto the internal network 2999 and to the monitored device 2300x, further transmissions 2922 that would cause the monitored device 2300x to output further transmissions 3933 to the external system 3000x that would cause one or more processes (other than the update download process 3005ud) to continue to be performed within the external system 3000x. Upon causing at least such a cessation of such transmissions, the logic 2345a may also respond by causing the monitored device 2300a to output, onto the internal network 2999 and back to the monitored device 2300x, a transmission 2922conf1 conveying operational information indicating that the command to cause the cessation of performance of one or more other processes within the external system 3000x has been received and acted upon at the monitored device 2300a.

In response to receiving the transmission 2922conf1 at the monitored device 2300x, and upon causing at least the cessation of transmissions to the external system 3000x that would cause one or more processes (other than the update download processes 3005ud) to continue to be performed therein, the logic 2345x may cause the monitored device 2300x to output, onto the link(s) 3999x and back to the external system 3000x, a transmission 3933conf1 conveying operational information indicating that the command to cause the cessation of performance of one or more other processes within the external system 3000x has been received and acted upon at both of the monitored devices 2300a and 2300x.

As depicted, and as previously discussed in connection with FIGS. 3B-C, delays may be incurred, not just in action being taken in response to a received operational command, but also in simply relaying an operational command. More specifically, and by way of example, the simple act of relaying the operational command received via the transmission 3933cmd1, through the logic 2345x, and onward in the transmission 2922cm1 may take an appreciable amount of time that may be of significance in distinguishing between proper and improper network activity.

The receipt of the transmission 3933conf1 at the external system 3000x may serve as the trigger for transitioning from the process state 3006p1, and to the process state 3006p2. Regardless of the exact manner in which the process state 3006p2 of the update download process 3005ud is caused to begin, it may be that a function of the process state 30006p2 is to check whether an updated routine of a sought after type is currently available from the external server 9900. To perform such a check, the external system 3000x may be caused to output, onto the link(s) 3999x and to the monitored device 2300x, a transmission 33933query1 conveying an operational command for the external server 9900 to provide an indication of whether such an updated routine is currently available.

In response to receiving the transmission 3933query1 at the monitored device 2300x, the logic 2345x implemented therein may cause the monitored device 2300x to relay the operational command onward to the external server 9900 in a transmission 2922query1 thereto via at least the internal network 2999. As previously discussed, such external servers 9900 may be accessible through a connection between the internal network 2999 and an external network 9992 (see FIG. 1A), such as the Internet. In various embodiments, the external system 3000x may have been previously provided with an IP address or other identifier that may be used in the transmission 3933query1 to specify the particular external server 9900 as the intended destination of the transmission 3933query1. In relaying the operational command received in the transmission 3933query1, the logic 2345x may also relay that same IP address or other identifier onward in the transmission 2922query1.

In response to receiving the transmission 2922query1 at the external server 9900, logic 9954 that may be implemented therein may cause the external server 9900 to respond with a transmission 2922resp1 that conveys operational information that answers to the check of whether such an updated routine is currently available. As depicted, such an answer may be a simple binary yes or no. The received transmission 2922query1 may have included an indication of an identifier (e.g., an IP address or other identifier) of a device to which the responding transmission 2922resp1 may be directed so as to cause the responding transmission 2922resp1 to ultimately be received at the monitored device 2300x.

In response to receiving the transmission 2922resp1 at the monitored device 2300x, the logic 2345x implemented therein may cause the monitored device 2300x to relay its operational information onward to the external system 3000x in a transmission 3933resp1 thereto via the link(s) 3999x. Again, as depicted, various delays may be incurred at various steps in the round trip of transmissions 3933query1, 2922query1, 2922resp1 and 3933resp1.

The receipt of the transmission 3933resp1 at the external system 3000x may serve as the trigger for transitioning from the process state 3006p2, and to the process state 3006p3. Regardless of the exact manner in which the process state 3006p3 of the update download process 3005ud is caused to begin, it may be that a function of the process state 30006p3 is to trigger the beginning of the actual download of an updated routine from the external server 9900, if the transmission 3933resp1 conveys an indication that there is such an updated routine currently available. Presuming that there is such an updated routine currently available, the external system 3000x may be caused to output, onto the link(s) 3999x and to the monitored device 2300x, a transmission 3933cmd2 conveying an operational command to the external server 9900 for the download to begin.

As depicted, that operational command may be relayed onward to the external server 9900 by the monitored device 2300x as a transmission 2922cmd2 output onto the internal network 2999, and onward to external server 9900. As further depicted, in response to receiving the transmission 2922cmd2, the logic 9954 of the external server 9900 may commence outputting further transmissions (not specifically shown) that convey portions of an updated routine as portions of operational data.

FIG. 4B presents an example of an update download process 2305ud implemented as a state machine that is performed within the monitored device 2300x to download an updated routine from an external server 9900. Thus, a substantial difference between what is depicted in the previous example of FIG. 4A versus what is depicted in this example of FIG. 4B, is a trading of roles between the monitored device 2300x and the external system 3000x. More specifically, in FIG. 4B, it is the monitored device 2300x that is receiving the download of an updated routine, and not the external system 3000x, as was the case in FIG. 4A. However, despite this substantial difference, the progression of process states 2306p1, 2306p2, 2306p3, etc., and the corresponding progression of transmissions 2922 and 3933 depicted in FIG. 4B is similar in many ways to what was depicted in FIG. 4A.

Again, it may be deemed to be a best practice to cease the performances of one or more processes 3005 within the external system 3000x to prevent unpredictable activity therein. However, in this example, the concern over occurrences of unpredictable activity arises in this example of FIG. 4B from the fact that the monitored device 2300x is the one of the monitored devices 2300 that is in direct communication with the external system 3000x, and from the fact that the monitored device 2300x is involved in controlling processes 3005 that are performed within the external system 3000x. Thus, the risk that updating a routine executed within the monitored device 2300x may cause the monitored device 2300x to, itself, behave unpredictably may be deemed a sufficient cause for placing components of the external system 3000x in a known stable state before such updating occurs.

Thus, as depicted, the update download process 2305ud may be begin with a first process state 2306p1 in which transmissions 2922cmd1 and 3933cmd1 are output that convey operational commands to cause such a cessation in performance of one or more processes 3005 within the external system 3000x. More specifically, the transmission 3933cmd1 may convey operational command(s) to the external system 3000x to place various components in known stable states, while the transmission 2922cmd1 may convey operational command(s) to the monitored device 2300a to cease the output of transmission that would cause one or more processes to continue to be performed therein. As further depicted, as the monitored device 2300a and the external system 3000x complete taking action on those operational commands, they may output transmissions 2922conf1 and 3933conf1 conveying indications back to the monitored device 2300x that the operational commands conveyed in the transmissions 2922cmd1 and 3933cmd1, respectively, have been received and acted upon.

The receipt of the transmissions 2922conf1 and 3933conf1 at the monitored device 2300x may serve as the trigger for transitioning from the process state 2306p1, and to the process state 2306p2. Similar to the process state 3006p2 of update download process 3005ud, and regardless of the exact manner in which the process state 2306p2 of the update download process 2305ud is caused to begin, it may be that a function of the process state 23006p2 is to check whether an updated routine of the one or more types that may be sought is currently available from the external server 9900.

However, and as depicted, communications between the monitored device 2300x and the external server 9000 may be more direct than the communications between the external system 3000x and the external server 9000 in the example of FIG. 4A. During the process state 2306p2, transmissions 2922query1 and 2922resp1 may be output and received as part of checking whether an updated routine of a sought after type is currently available from the external server 9900. Presuming that such an updated routine is currently available, then the actual download thereof may be triggered to begin by the output and receipt of the transmission 2922cmd2 conveying an operational command to the external server 9900 to begin that download.

FIG. 4C presents another example of an update download process 2305ud implemented as a state machine, but which is performed within the monitored device 2300a, instead of the monitored device 2300x, to download an updated routine from an external server 9900. Thus, a substantial difference between what is depicted in the previous example of FIG. 4B versus what is depicted in this example of FIG. 4C, is a trading of roles between the monitored devices 2300a and 2300x. More specifically, in FIG. 4C, it is the monitored device 2300a that is receiving the download of an updated routine, and not the monitored device 2300x, as was the case in FIG. 4B. However, despite this substantial difference, the progression of process states 2306p1, 2306p2, 2306p3, etc., and the corresponding progression of transmissions 2922 and 3933 depicted in FIG. 4C is similar in many ways to what was depicted in FIG. 4B.

Again, it may be deemed to be a best practice to cease the performances of one or more processes 3005 within the external system 3000x to prevent unpredictable activity therein. In a manner somewhat similar to the example of FIG. 4B, the concern over occurrences of unpredictable activity in this example of FIG. 4C arises from the fact that the monitored device 2300a is involved in controlling processes 3005 that are performed within the external system 3000x. Thus, the risk that updating a routine executed within the monitored device 2300a may cause the monitored device 2300a to, itself, behave unpredictably may be deemed a sufficient cause for placing components of the external system 3000x in a known stable state before such updating occurs.

Thus, as depicted, the update download process 2305ud may be begin with a first process state 2306p1 in which transmissions 2922cmd1 and 3933cmd1 output that convey and relay an operational command to cause such a cessation in performance of one or more processes 3005 within the external system 3000x. More specifically, and in a manner that is more similar to the example of FIG. 4A, the transmission 2922cmd1 may convey the operational command from the monitored device 2300a, and to the operational device 2300x, while the transmission 3933cmd1 may relay that operational command onward from the monitored device 2300x, and to the external system 3000x. As further depicted, upon completing the operational command, the external system 3000x may output a transmission 3933conf1 conveying an indication to the monitored device 2300x that the operational command relayed in the transmission 3933cmd1 was received and acted upon. As also further depicted, upon receiving the transmission 3933conf1 and upon completing the operational command, the monitored device 2300x may output a transmission 2922conf1 conveying an indication to the monitored device 2300a that the operation command conveyed in the transmission 2922cmd1 has been received and acted upon by both the monitored device 2300x and the external system 3000x.

The receipt of the transmission 2922conf1 at the monitored device 2300a may serve as the trigger for transitioning from the process state 2306p1, and to the process state 2306p2. Again, regardless of the exact manner in which the process state 2306p2 of the update download process 2305ud is caused to begin, it may be that a function of the process state 23006p2 is to check whether an updated routine of the one or more types that may be sought is currently available from the external server 9900.

In a manner that is more similar to the example of FIG. 4B, communications between the monitored device 2300a and the external server 9000 may be more direct than the communications between the external system 3000x and the external server 9000 in the example update download process 3005ud of FIG. 4A. Again, during the process state 2306p2, transmissions 2922query1 and 2922resp1 may be output and received as part of checking whether an updated routine of a sought after type is currently available from the external server 9900. Presuming that such an updated routine is currently available, then the actual download thereof may be triggered to begin by the output and receipt of the transmission 2922cmd2 conveying an operational command to the external server 9900 to begin that download.

### Gathering Data to Use in Generating Emulations—Gathering Phase

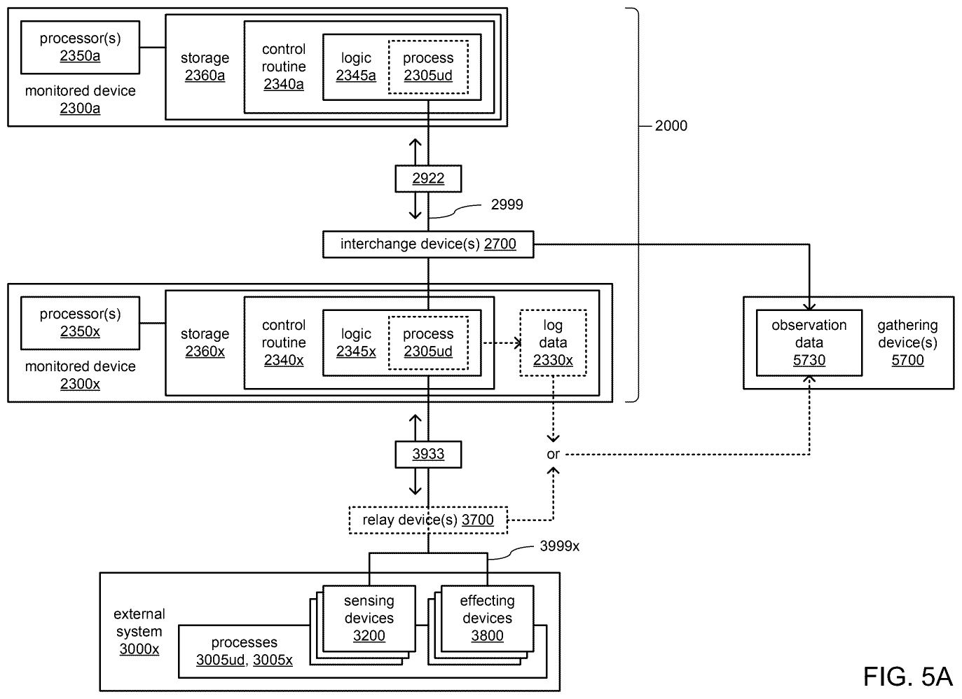

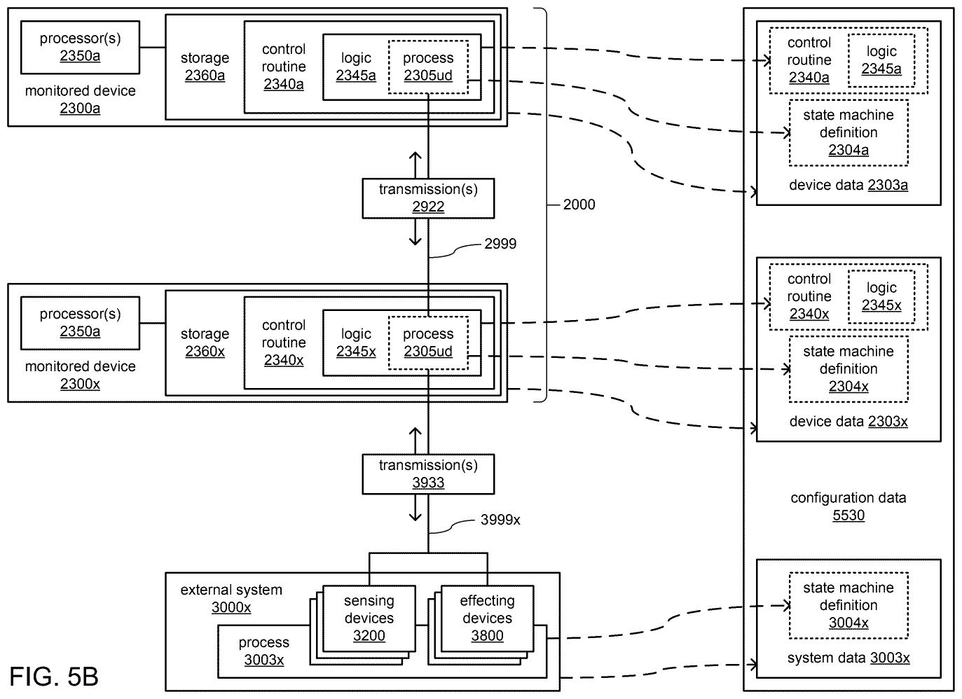

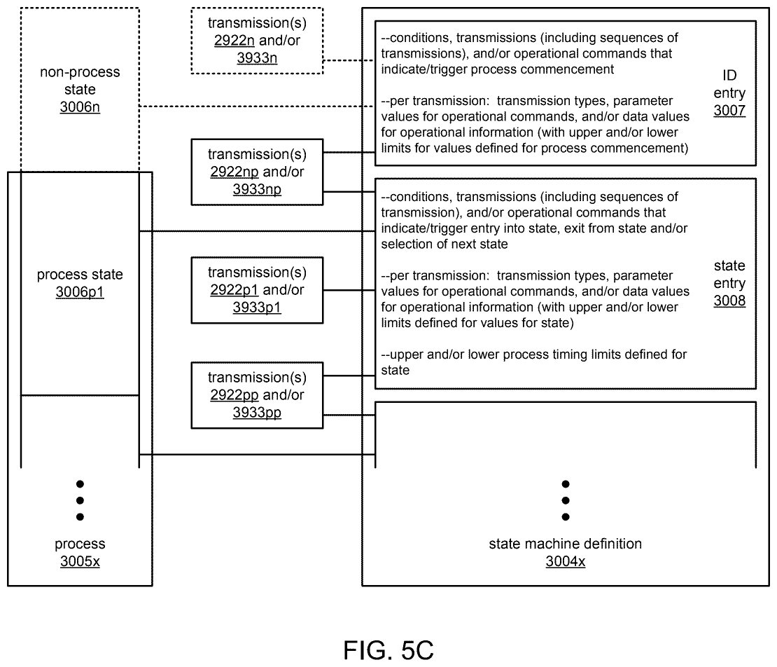

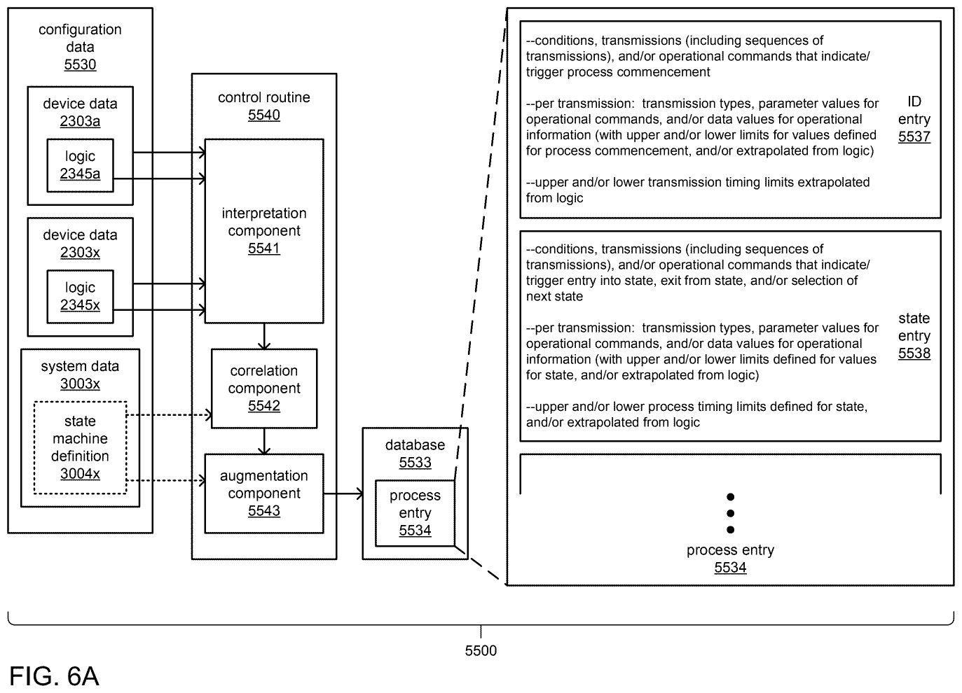

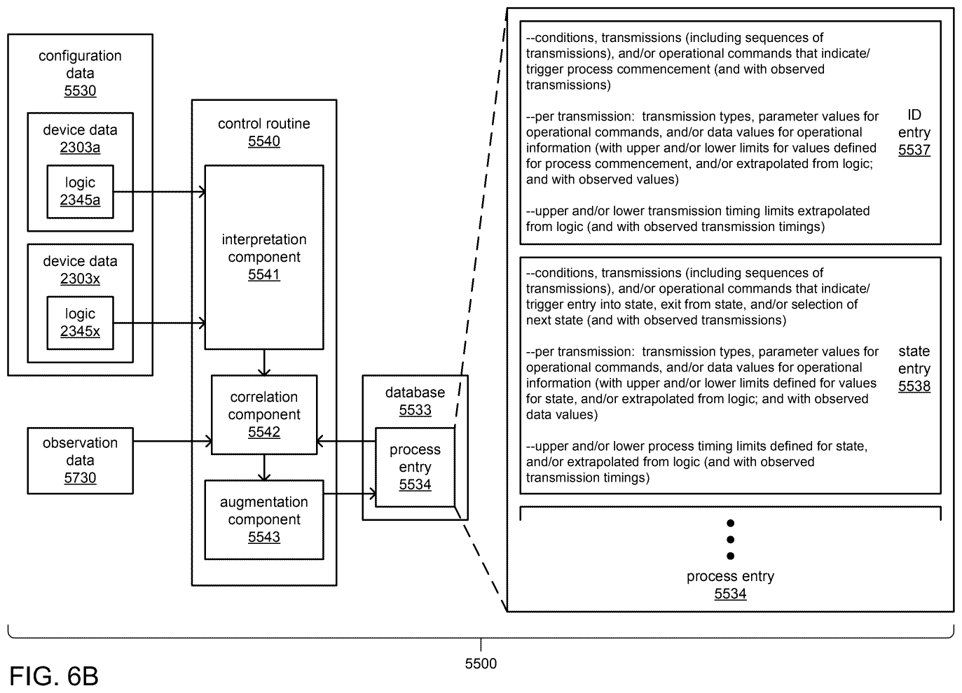

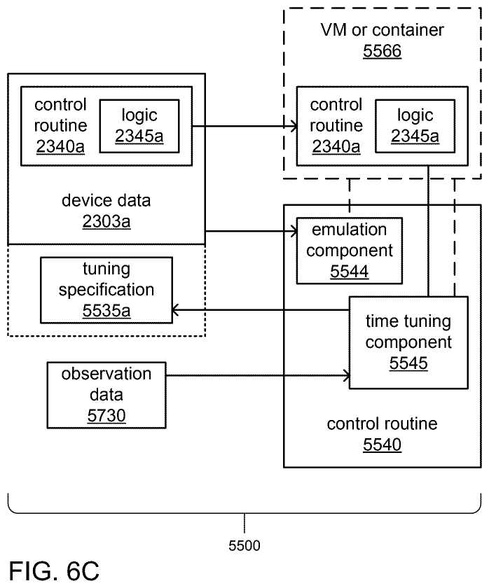

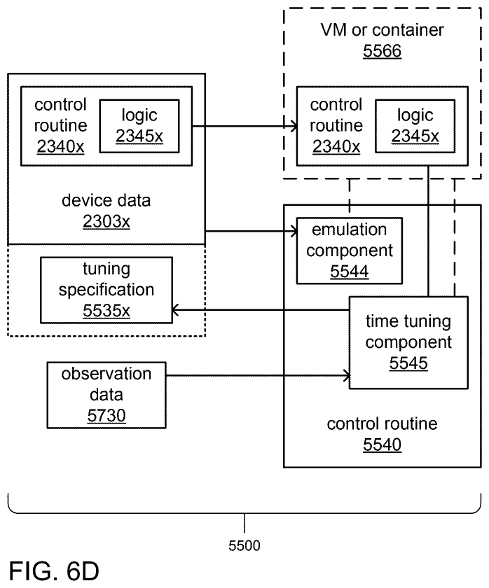

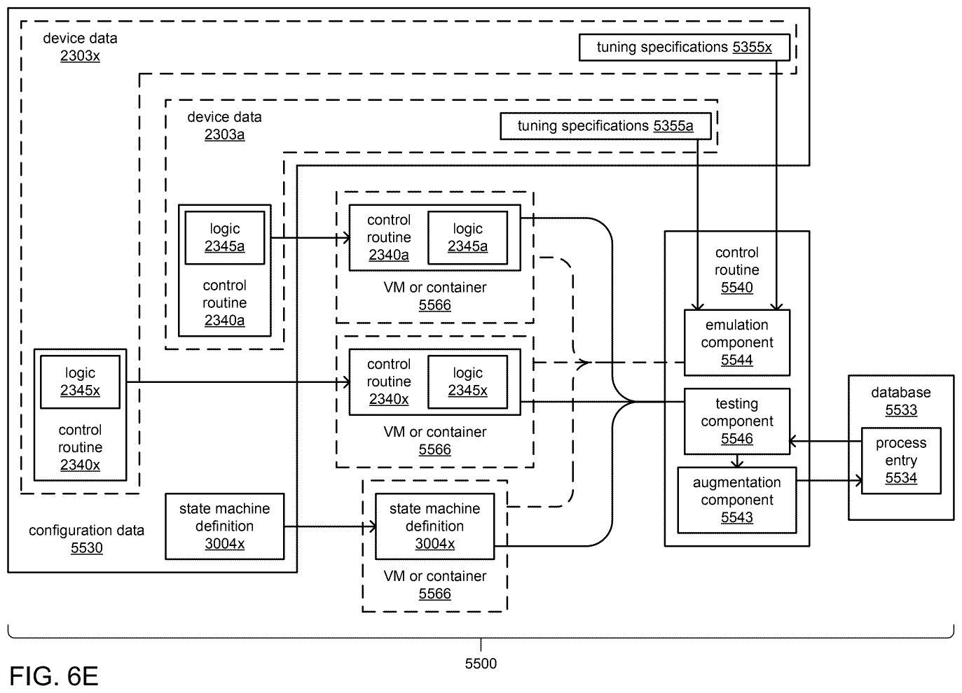

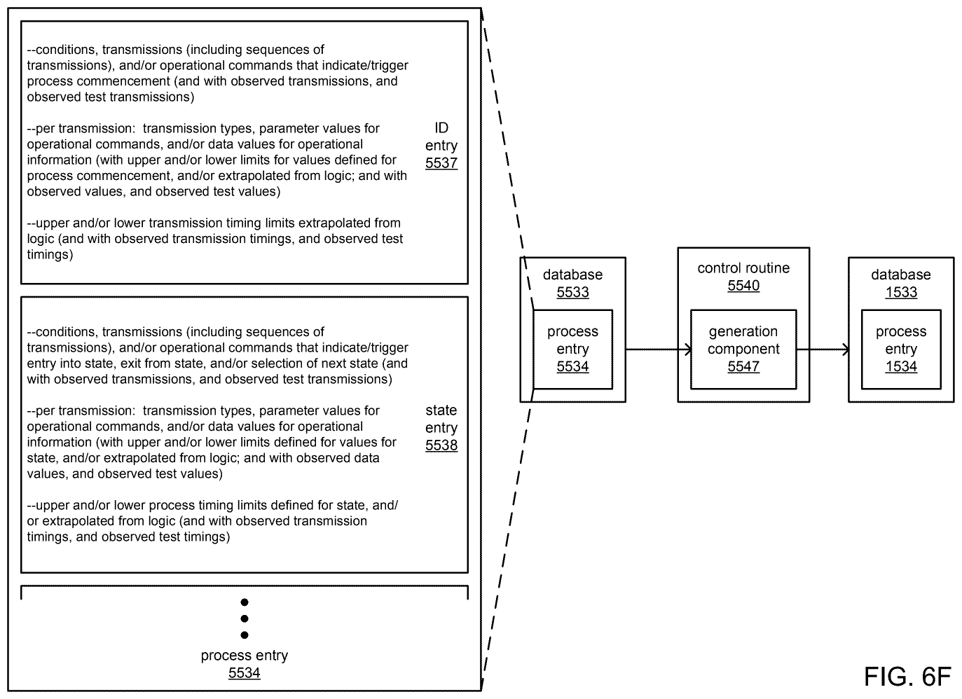

FIGS. 5A, 5B and 5C, taken together, present various aspects of the gathering phase of preparing one or more monitoring devices 1500 for use in monitoring and/or correcting improper network traffic through the internal network 2999. Again, at a time prior to the pre-training phase (to be discussed in reference to FIGS. 6A-F), one or more gathering devices 5700 may be temporarily coupled to one or more interchange devices 2700, and/or one or more relay devices 3700x of the link(s) 3999x, to generate the observation data 5730 for being provided to one or more emulation devices 5500. Also, the emulation device(s) 5500 may also be provided with the configuration data 5530 descriptive of aspects of at least monitored device 2300 (e.g., the monitored devices 2300a and 2300x), external systems 3000 (e.g., the external system 3000x), and/or processes performed within monitored devices 2300 (e.g., the process 2305ud) and/or performed within external systems 3000 (e.g., the processes 3005ud and/or 3005x).

Turning to FIG. 5A, as previously discussed, to generate such emulations of portions of the monitored system 2000 (e.g., the monitored devices 2300a and/or 2300x), the process(es) 2305 performed within one or more of the monitored devices 2300 (e.g., the process 2305ud), the one or more of the external systems 3000 (e.g., the external system 3000x), and/or the process(es) 3005 performed within one or more of the external systems 3000 (e.g., the processes 3005ud and/or 3005x), among the data required is the observation data 5730 that documents at least transmissions 2922 through the internal network 2999 among the monitored devices 2300 within which process(es) 2305 are performed and/or among the monitored devices that control the process(es) 3005 performed within the external system(s) 3000. It may be deemed preferable that such documented transmissions 2922 include whole sets of transmissions 2922 associated with multiple complete performances those processes 2305 and/or 3005. In this way, variations in transmission timing, parameters in transmissions of operational commands, and/or data values in transmissions of operational information that may be normal variations may be taken into account in such emulations. In turn, this may enable the monitoring device(s) 1500 to be prepared to distinguish such normal variations from anomalous variations that are at least more likely to be associated with a malfunction or a cyber attack.

As also previously discussed, it may also be deemed desirable to, if possible, cause the observation data 5730 to similarly document whole sets of corresponding transmissions 3933 that are also associated with the same multiple complete performances of those same processes 2305 and/or 3005. The inclusion of information concerning the content and timing of the transmissions 3933 may enable the emulation of the progression of a process 2305 (e.g., the process 2305ud) or a process 3005 (e.g., the processes 3005ud and/or 3005x) through its process states to be more accurate.

Again, considerable importance is usually placed on not taking action that may impair the functionality of the one or more links 3999 that couple an external system 3000 to one of the monitored devices 2300. This arises from the fact that the link(s) 3999 often directly couple the sensing devices 3200 and effecting devices 3800 that most directly effect changes in process state, including changes to a pre-selected non-process state in response to an unexpected condition that may damage equipment and/or create a hazard. Thus, attaching devices to the link(s) 3999 of an external system 3000 as part of capturing and documenting the transmissions 3933 that pass therethrough may be deemed to present an unacceptable risk. As a result, at least where such components as the relay device(s) 3700x are not available and/or not able to be coupled to, it may be deemed more desirable to obtain such information concerning such transmissions 3933 from log data that may be generated and maintained by the monitored device(s) 2300 that are directly involved in such communications (e.g., the depicted log data 2330x generated within the monitored device 2300x for transmissions 3933 associated with the external system 3000x).

Turning to FIG. 5B, as previously discussed, each of the control routines 2340a and 2340x of the monitored devices 2300a and 2300x may implement logic 2345a and 2345x, respectively, that are each part of the logic employed to perform process(es) 2305 thereat (e.g., the process 2305ud) and/or employed to control performances of process(es) 3005 performed within the external system 3000x (e.g., the processes 3005ud and/or 3005x). Thus, the configuration data 5530 may be generated to include device data 2303a concerning the monitored device 2300a, device data 2303x concerning the monitored device 2300x, and/or system data 3003x concerning the external system 3000x.

In some embodiments, each of the device data 2303a and 2303x may include indications of various characteristics of the hardware and/or software of its corresponding one of the monitored devices 2300a and 2300x. Such characteristics may include, and are not limited to, the type and/or revision level of the processor(s); the type and quantity of volatile and/or non-volatile storage; the type and revision of operating system and/or driver software executed; the type and revision of other software executed; the type and/or revision of network interface(s); etc. The system data 3003x may include indications of similar characteristics of the external system 3000x. Alternatively or additionally, the system data 3003x may include indications of characteristics of the sensing devices 3200 and/or the effecting devices 3800. The provision of such information for the monitored devices 2300a and/or 2300x, and/or for the external system 3000x may enable a more accurate emulation of each by enabling more accurate emulations of components thereof.

In some embodiments, each of the device data 2303a and 2303x may include a state machine definition 2304a and 2304x, respectively, that is descriptive of various aspects of the process states 2306 of process(es) 2305 (e.g., the process 2305ud) that may be performed within its corresponding one of the monitored device 2300a and 2300x.

Alternatively or additionally, the each of the device data 2303a and 2303x may include an alternate description of the logic 2345a and 2345x, respectively, which as previously discussed, may implement the state machines. In some of such embodiments, such an alternate description may take the form of a copies of at least portions of the control routines 2340a and 2340x that include the logic 2345a and 2345x, respectively. The system data 3003x may similarly include a state machine definition 3004x that is descriptive of various aspects of the process states 3006 of process(es) 3005 (e.g., the processes 3005ud and/or 3005x) that may be performed within the external system 3000x.

It should noted that embodiments are possible in which at least some of such content of the configuration data 5530 is not available. This situation may arise as a result of security and/or trade secret concerns, where information concerning details of one or more processes 2305 and/or 3005 is deemed to be too sensitive to make available. Alternatively or additionally, it may be that a description of one or more of the process 2305 and/or 3005 as a state machine has never been generated such that it simply does not exist. Thus, in such embodiments, the state machine definition(s) 2304 and/or 3004 may be derived from other information contained within the configuration data 5530 and/or from within the observation data 5730 as part of the pre-training phase of preparing the monitoring device(s) 1500 for use.

Turning to FIG. 5C, in embodiments in which one or more state machine definitions 2304 and/or 3004 are provided, each such provided state machine definition 2304 or 3004 may include a separate entry for each process state, and/or may include an entry descriptive of various aspects of the manner in which a performance of the corresponding process 2305 or 3005 is caused to begin. FIG. 5C presents an example of such a provided state machine definition 3004x for the earlier-described example process 3005x.

Turning to the depicted example ID entry 3007 of the example state machine definition 3004x, various conditions and/or events that cause and/or indicate the commencement of the process 3005x may be specified. By way of example, such a specification may specify one or more particular transmissions 2922 through the internal network 2999 and/or one or more particular transmissions 3933 through the link(s) 3999x that may trigger and/or indicate commencement of the process 3005x. Further, for each transmission, the transmission type (e.g., conveying an operational command or conveying operational information), parameter values for operational commands, data values for operational information may also be specified. Still further, where multiple values are possible for a parameter value or for a data value, a group of discrete values and/or a range of values may be specified in any of a variety of ways (e.g., a maximum value or upper limit, a minimum value or lower limit, a median value, a mean value, an average value, a list of discrete values, a model/formula for deriving values, a probability distribution, etc.).

In some embodiments in which upper and/or lower limits on a value are specified, such upper and/or lower limits may be selected to include values that are associated with various error conditions that have been planned for such that the state machine of the process 3005x and/or the logic 2345a and/or 2345x involved in controlling the processor 3005x have been designed to include measures to address those conditions. Indeed, in some embodiments, there may be ranges of values and/or sets of discrete values specified for parameter values and/or data values that are associated with a performance of the process 3005x without error conditions, and other ranges of values and/or sets of discrete values specified for parameter values and/or data values that are associated with a performance of the process 3005x in which one or more anticipated error conditions occur.

Turning to the depicted example state entry 3008 of the example state machine definition 3004x, for each state entry 3008, various conditions and/or events that cause and/or indicate entry into the corresponding state, that cause and/or indicate exit from the corresponding state, and/or that cause and/or indicate the selection of the next state may be specified. By way of example, such a specification may specify one or more particular transmissions 2922 through the internal network 2999 and/or one or more particular transmissions 3933 through the link(s) 3999x that may trigger and/or indicate such entry into and/or exit from the corresponding state, and/or that may cause and/or indicate the selection of the next state. Further, for each transmission, the transmission type, parameter values for operational commands, data values for operational information may also be specified. Again, where multiple values are possible for a parameter value or for a data value, a group of discrete values and/or a range of values may be specified in any of a variety of ways (e.g., a maximum value or upper limit, a minimum value or lower limit, a median value, a mean value, an average value, a list of discrete values, a model/formula for deriving values, a probability distribution, etc.). Further, each state entry 3008 may also specify upper and/or lower timing limits for the performance of different actions during the corresponding state.

### Using Gathered Data to Define Aspects of Emulations—Pre-Training Phase

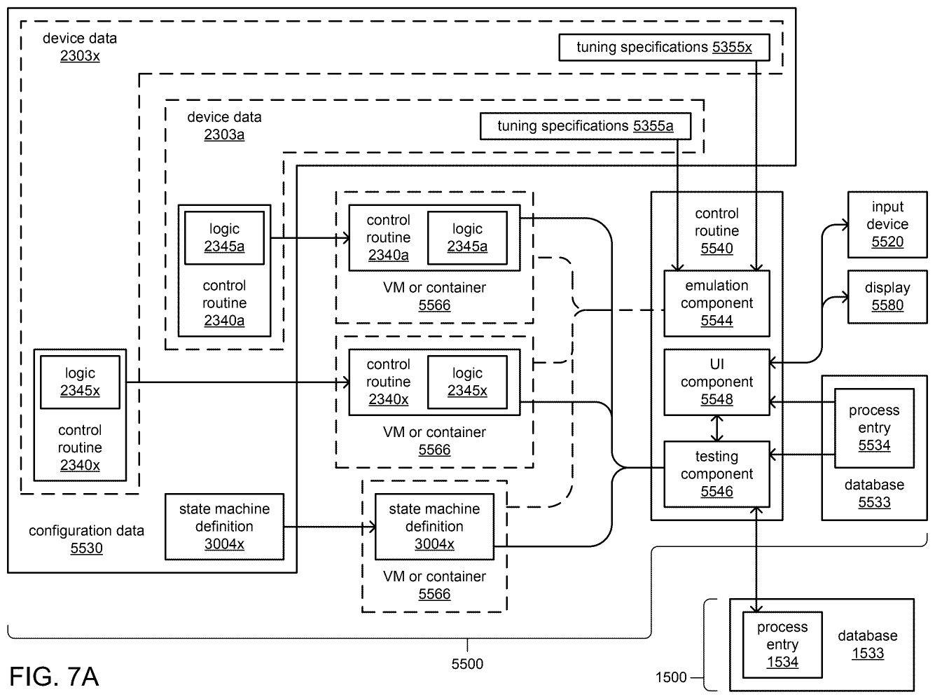

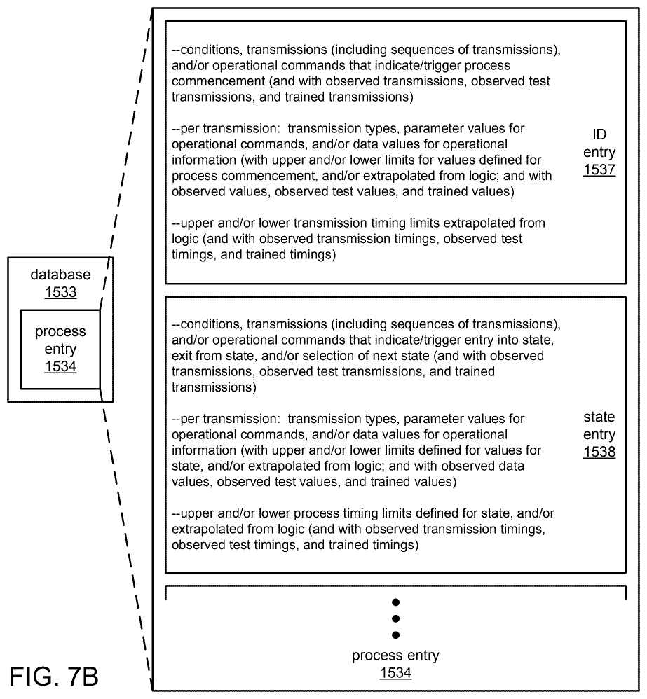

FIGS. 6A, 6B, 6C, 6D, 6E and 6F, taken together, present various aspects of the pre-training phase of preparing one or more monitoring devices 1500 for use in monitoring and/or correcting improper network traffic through the internal network 2999. Again, at a time following the gathering phase (just discussed in reference to FIGS. 5A-C), and prior to the emulation training phase (to be discussed in reference to FIGS. 7A-B), one or more emulation devices 5500 may use the observation data 5730 together with the configuration data 5530 to prepare for generating emulations of portions of the monitored system 2000 (e.g., the monitored devices 2300a and 2300x), one or more of the external systems 3000 (e.g., the external system 3000x), one or more processes 2305 and/or 3005 (e.g., the process 3005x performed within the external system 3000x). In so doing, preparations are made for using a set of such emulations together to prepare the one or more monitoring devices 1500.

It should be noted that, for purposes of illustration by example, an example is used of preparing one or more monitoring devices 1500 to monitor and/or correct improper network traffic in connection with performing the process 3005x within the external system 3000x under the control of the monitored devices 2300a and 2300x. Thus, FIGS. 6A-F present aspects of preparing and/or generating emulations to be used in training such monitoring device(s) 1500 (as will then be described in greater detail in FIGS. 7A-B).

Turning to FIG. 6A, the control routine 5540 executed by processor(s) 5550 of at least one of the emulation devices 5500 may include an interpretation component 5541 to parse and/or analyze logic employed by monitored devices 2300, a correlation component 5542 to correlate portions of such logic and/or of state machine definitions, and an augmentation component 5543 to begin the generation of the database 5533.

As previously discussed, each of the monitored devices 2300 (including the monitored devices 2300a and 2300x) may be a computing device. Thus, it is envisioned that each monitored device 2300 may incorporate any of a variety of types of processor, storage components, peripheral components, etc. As a result, any of a variety of processor instruction sets, peripheral and/or storage addressing architectures, etc. may be used. Each of the device data 2303a and 2303x within the configuration data 5530 may specify such aspects of its corresponding one of the monitored devices 2300a and 2300x thereby enabling the selection of a version of the interpretation component 5541 that may incorporate a matching instruction de-compiler, analyzer and/or interpreter to enable parsing of each of the logic 2345a and 2345x, respectively, as the interpretation component 5541 is executed by the processor(s) 5550 of at least one of the emulation devices 5500.

As also previously discussed, in some embodiments, the configuration data 5530 may include a separate instance of system data 3003 for each external system 3000 (e.g., the depicted instance of system data 3003x for the external system 3000x). Further, each such instance of system data 3003 may include, for each process 3005 that is performed within its corresponding external system 3000, a separate state machine definition 3004 that describes the process states 3006 of its corresponding process 3005 (e.g., the depicted state machine definition 3004x for the process 3005x that is performed within the external system 3000x). However, as also previously discussed, there may be other embodiments in which it may be that a state machine definition 3004 is not provided for one or more processes 3005.

In embodiments in which the state machine definition 3004x for the process 3005x is provided in the system data 3000x, execution of the correlation component 5542 may cause the processor(s) 5550 to identify the process states 3006 of the process 3005x that correspond to each of various portions of the logic 2345a and 2345x. With such correlations identified, execution of the augmentation component 5543 may cause the processor(s) 5550 to generate a process entry 5534 for the process 3005x within the database 5533 to include the contents of that provided state machine definition 3004x, with augmentations from the correlated portions of logic.

However, in embodiments in which the state machine definition 3004x for the process 3005x is not provided in the system data 3003x, then execution of the correlation component 5542 may cause the processor(s) to correlate portions of the logic 2345a to portions of the logic 2345x. The processor(s) 5550 may then be caused to derive the set of process states 3006 of the process 3005x from the now correlated combination of the logic 2345a and 2345x. With such correlations identified, and with the set of process states 3006 derived, execution of the augmentation component 5543 may cause the processor(s) 5550 to generate the process entry 5534 for the process 3005x within the database 5533.

Thus, each process entry 5534 of the database 5533 may be generated to have an internal structure somewhat similar to that of a state machine definition 3004 (e.g., the state machine definition 3004x depicted in FIG. 5C). More specifically, the process entry 5534 generated for the process 3005x may have an ID entry 5537 and multiple state entries 5538 that would correspond in organization an content to the ID entry 3007 and the multiple state entries 3008, respectively, within the state machine definition 3004x that may or may not be provided for the process 3005x.

However, in comparison to the ID entry 3007 of the state machine definition 3004x for the process 3005x, the ID entry 5537 of the corresponding process entry 5534 may include additional information extrapolated from correlated portions of the logic 2345a and 2345x associated with causing the commencement of a performance of the process 3005x. Such additional information may include, and not be limited to, upper and/or lower limits of parameter values and/or data values, and/or upper and/or lower limits for the timings of when each transmission is to occur. Such information may be descriptive of both transmissions 2922 that pass through the internal network 2999 and transmissions 3933 that pass through the link(s) 3999x.

Also, in comparison to the state entries 3008 of the state machine definition 3004x for the process 3005x, each state entry 5538 of the corresponding process entry 5534 may include additional information extrapolated from correlated portions of the logic 2345a and 2345x associated with the corresponding process state 3006 of the process 3005x. Again, such additional information may include, and not be limited to, upper and/or lower limits of parameter values and/or data values, and/or upper and/or lower limits for the timings of when each transmission is to occur. Also again, such information may be descriptive of both transmissions 2922 that pass through the internal network 2999 and transmissions 3933 that pass through the link(s) 3999x.

Where such extrapolations from the logic 2345a and 2345x are concerned, it should be noted that, while the state machine definition 3004x may have specified various constraints for timings, parameter values and/or data values based on various requirements for each state of the process 3005x, the logic 2345a and/or 2345x may impose additional constraints that are also required to be satisfied. As a result, the specifications of timings, parameter values and/or data values within the ID entry 5537 and the state entries 5538 within the process entry 5534 for the process 3005x may be more constrained than corresponding specifications provided in the state machine definition 3004x.

Turning to FIG. 6B, the correlation component 5542 may again be executed to cause the processor(s) 5550 to correlate each of the observed transmissions 2922 or 3933 indicated in the observation data 5730 to one of the process states 3006 described in the process entry 5534 of the database 5533 for the process 3005x. The augmentation component 5543 may also again be executed to cause further augmentation of the ID entry 5537 and/or the state entries 5538 of that process entry 5534 with indications of timings, operational commands, parameter values and/or data values that were actually observed for each of the observed transmissions 2922 or 3933.

As a result, the entries 5537 and/or 5538 within the process entry 5534 for the process 3005x are caused to include indications of real world observations for such information for each transmission 2922 or 3933 that is associated with each process state 3006, in addition to the ranges and/or sets of possible timings, commands and/or values that are specified by the state machine definition 3004x, and/or that are extrapolated from the logic 2345a and 2345x.

In some embodiments, a statistical analysis may be performed based on the observed timings of the observed transmissions 2922 and/or 3933 that takes into account whatever variation in timings may be observed across multiple performances of the process 3005x. From such an analysis for each such transmission, a range of timing and/or a probability distribution of timing for when the transmission is expected to occur may be specified in the process entry 5534 for the process 3005x.

Turning to FIG. 6C, the control routine 5540 may also include an emulation component 5544 and a time tuning component 5545. Execution of the emulation component 5544 may cause the processor(s) 5550 of one of the emulation devices 5500 to instantiate an execution environment in which one or more routines of a monitored device may be executed, such as the depicted control routine 2340a of the monitored device 2300a. As depicted, such an execution environment may be a virtual machine (VM) or a container 5566. Regardless of the exact nature and/or characteristics of the execution environment that is provided, further execution of the emulation component 5544 may cause the processor(s) 5550 to retrieve indications of characteristics of a monitored device 2300 from a corresponding instance of device data 2300 (e.g., the depicted device data 2303a corresponding to the monitored device 2300a) to guide aspects of the execution environment (e.g., the VM or container 5566) that is provided, thereby providing an execution environment for the execution of the control routine 2340a that relatively closely mimics various aspects of the execution environment normally provided to the control routine 2340a within the monitored device 2300a.

More specifically, and as previously discussed in reference to FIG. 5B, each instance of device data 2303 may include indications of various characteristics of the hardware and/or software of its corresponding monitored device 2300. Such characteristics may include, and are not limited to, the type and/or revision level of the processor(s); the type and quantity of volatile and/or non-volatile storage; the type and revision of operating system and/or driver software executed; the type and revision of other software executed; the type and/or revision of network interface(s); etc.

With such an execution environment provided, execution of the time tuning component 5545 by the processor(s) 5550 may cause the retrieval of indications from the observation data 5730 of amounts of time between transmissions 2922 and/or 3933 that are causally linked by portions of the logic 2345 of a control routine 2340 (e.g., the logic 2345a of the control routine 2340a of the monitored device 2300a). Referring briefly back to FIGS. 3B-C, as was discussed in reference to the logic 2345x, there may be portions of that logic that are triggered to output a transmission 2922/3933 in response to the receipt of a transmission 2922/3933, and such a response may take place with an amount of time delay. As was also discussed (but not specifically depicted), similar responses with time delays may also be exhibited by the logic 2345a. As has been discussed, the observation data 5730 includes timing information for each observed transmission 2922 and 3933 that documents the amount of time that elapsed for each such delay.

Returning to FIG. 6C, in executing the time tuning component 5545, the clock speed, number of processing cycles per second allocated to the VM or container 5566, and/or another parameter that exerts influence over the speed of execution of the control routine 2340a therein may be manipulated to cause the time delays exhibited by the logic 2345a therein to at least relatively closely match those documented in the observation data 5730. In this way, a time tuning setting may be identified to cause the timing behavior of the logic 2345a within the VM or container 5566 to match the timing behavior of the logic 2345a within the monitored device 2300a. An indication of the time tuning setting that begets such timing behavior may then be stored within the device data 2303a (or elsewhere within the storage 5560 of one or more of the emulation devices 5500) as the depicted tuning specification 5535a.

Turning to FIG. 6D, a similar use of information in the device data 2303x, emulation, and time tuning may be performed to similarly identify a time tuning setting for the logic 2345x of the monitored device 2300x, and an indication thereof may be stored within the device data 2303x (or elsewhere within the storage 5560 of one or more of the emulation devices 5500) as the depicted tuning specification 5535x.

With such time tuning settings having been identified for use in emulating the monitored devices 2300a and 2300x, the monitored devices 2300a and 2300x may now be emulated with relatively accurate timings.

Turning to FIGS. 6E-F, the control routine 5540 may additionally include a testing component 5546 to perform various tests of combinations of emulations of monitored devices 2300, processes performed within monitored devices 2300, external systems 3000, and/or processes performed within external systems 3000. As depicted, and as is about to be explained in greater detail, the testing component 5546 may be employed to perform various tests of a combination of emulations of the monitored devices 2300a and/or and 2300x interacting with an emulation of the process 3005x performed within the external system 3000x based on the state machine definition 3004x.

In executing the emulation component 5544, the processor(s) 5550 of at least one of the emulation devices 5500 may be caused to instantiate VMs or containers 5566 in which the execution environments of the monitored devices 2300a and 2300x may be emulated to enable the control routines 2340a and 2340x, respectively, to be executed therein. Additionally, another VM or container 5566 may be instantiated in which the state machine of the process 3005x may be implemented. In further executing the emulation component 5544, communications among these VMs or containers 5566 may be enabled to allow transmissions 2922 and 3933 thereamong in a manner that mimics the communications that would normally take place on the internal network 2999 and the link(s) 3999x.

In executing the testing component 5546, the processor(s) 5550 may be caused to parse the process entry 5534 within the database 5533 for the process 3005x to retrieve lower and/or upper limits for timings for events that trigger the output of transmissions 2922 and/or 3933. Such events may include simulated operator inputs via a UI to the logic 2345a, and/or simulated measurements taken by simulated sensing devices 3200 for the process 3005x. Experiments may then be performed in which each of such simulated inputs are performed, each timed to meet its corresponding lower and upper limits for timing of occurrence. In this way, edge and/or corner cases based on corresponding upper and/or lower limits of transmissions 2922 and/or 3933 that are triggered by these inputs may be tested.

Further execution of the testing component 5546 may then cause the resulting test timings of those transmissions 2922 and/or 3933 to be documented, and execution of the augmentation component 5543 may then cause the indications of timings for transmissions already present in the database 5533 to be augmented with these observed test timings. In this way, the upper and/or lower limits for timings with which transmissions 2922 and/or 3933 might actually occur in edge and/or corner cases may be added to the database 5533, alongside the timings actually observed during normal operation of the monitored system 2000 together with the process 3005x.

In some embodiments, the resulting combination of transmission timings that are extrapolated from the combination of the logic 2345a and 2345x; that are observed to have actually taken place during normal operation; and that are derived from such experimentation with edge and/or corner cases as just described may be combined to generate a fuller set indications of transmission timings in the process entry 5534 for the process 3000x in the database 5533. As a result, for each transmission 2922 or 3933, that process entry 5534 in the database 5533 may include indications of what timings are possible in theory, versus what timings are possible in unlikely extreme timing conditions, versus what timings have actually been observed to occur. In some of such embodiments, each such indication of timings for a transmission 2922 or 3933 may take the form of a probability distribution indicative of relative likelihoods of theoretically possible timings, vs. unlikely timings under extreme conditions, vs. timings that have actually been observed to occur.

Regardless of the exact way in which such indications of transmission timings are represented in that process entry 5534 within the database 5533, such extensive timing information for at least transmissions 2922 through the internal network 2999 may enable greater accuracy in distinguishing between proper and improper transmissions 2922 through the internal network 2999, as well as more certain identification of when a span of time has elapsed without an expected transmission 2922 having occurred. Alternatively or additionally, such extensive timing information for transmissions 2922 and/or 3933 may enable the provision of emulations guided by such timing information for diagnostics, testing and/or training purposes.

As depicted in FIG. 6F, with the database 5533, including a process entry 5534 for the process 3005x, having been generated as described above, execution of a generation component 5547 of the control routine 5540 may cause processor(s) 5550 of an emulation device 5500 to generate the database 1533 with a corresponding process entry 1534 therefrom. It may be that each of the process entries 1534 of the database 1533 is somewhat reduced in content from their counterpart process entries 5534 of the database 5533. By way of example, information concerning transmissions 3933 through links 3999 (e.g., the link(s) 3999x) may not be included in process entries 1534 of the database 1533 as the communications traffic through link 3999 may not normally be monitored by the monitoring device(s) 1500.

In essence, as each process entry 5534 of the database 5533 is generated and then augmented (perhaps repeatedly augmented), each process entry 5534 is caused to become a definition of a model for the process 2305 or 3005 that corresponds to it. And as is about to be described, the defined within each process entry 5534 may be further refined before being stored as a process entry 1534 in the database 1533 that is ultimately provided to each monitoring device 1500 to be used in analyzing transmissions 2922 to identify corresponding processes 2305 and/or 3005, and to be used in taking corrective action in connection with those transmissions 2922, as will be further discussed in still greater detail.

### Using the Emulations for Training—Emulation Training Phase

FIGS. 7A and 7B, taken together, present various aspects of the training phase of preparing one or more monitoring devices 1500 for use in monitoring, stopping and/or correcting improper network traffic through the internal network 2999. Again, at a time following the pre-training phase (just discussed in reference to FIGS. 6A-F), and prior to such actual use of the monitoring device(s) 1500 in monitoring, stopping and/or correcting improper network traffic through the internal network 2999, the monitoring device(s) 1500 may be temporarily coupled to the emulation device(s) 5500 to be trained and/or tested using the emulated network traffic among at least the emulations of various monitored devices 2300 (e.g., emulations of the monitored devices 2300a and 2300x).

Turning to FIG. 7A, as depicted, the information within a process entry 5534 within the database 5533 for a process 2305 or 3005 (e.g., the process 3005x) may be used as an input to a UI component 5548 of the control routine 5540 to guide the presentation of options for manual testing to an operator through a user interface (UI) that employs an input device 5520 and/or a display 5580 of an emulation device 5500. More precisely, a process entry 5534 of the database 5533 may be used to provide an operator with options for defining one or more experiments that are based on the indications within that process entry 5534 of what parameter values, data values, timings, etc. have been determined to be possible as a result of the aforedescribed interpretation, extrapolation and experimentation operations.

Turning to FIG. 7B, as part of such testing, the monitoring device(s) 1500 may be placed in a training mode to enable the learning of new possible transmissions 2922 that may occur as part of proper network traffic on the internal network 2999 associated with a particular process 2305 or 3005, to enable the learning of new possible parameter values and/or data values for the contents of those transmissions 2922 that may occur through the internal network 2999, and/or to enable the learning of new timings for those transmissions 2922. As a result, such new information concerning those transmissions 2922 that may occur through the internal network 2999 in connection with the particular process 2305 or 3005 may be added to the specifications of transmissions, transmission contents and/or transmission timings already stored within a process entry 1534 that defines a model for that particular process 2305 or 3005 within the database 1533.

### Alternate/Supplemental Training Approach

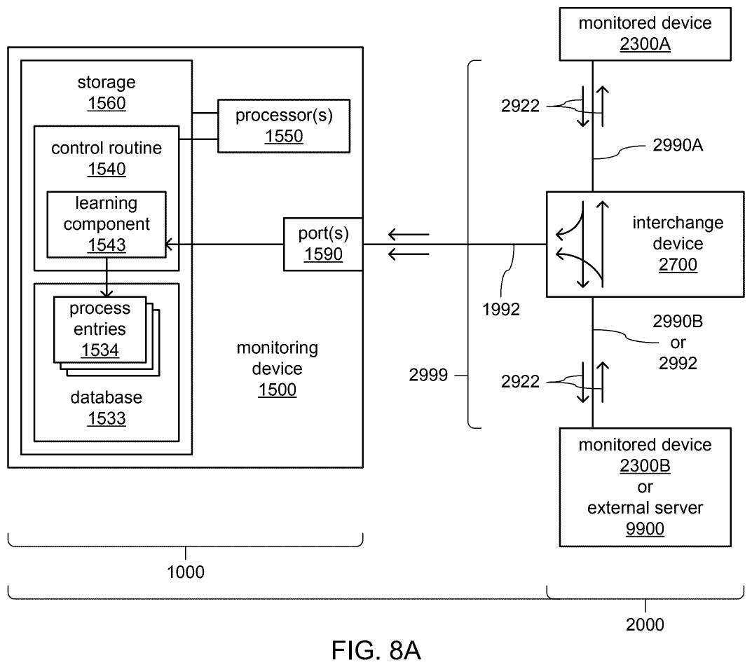

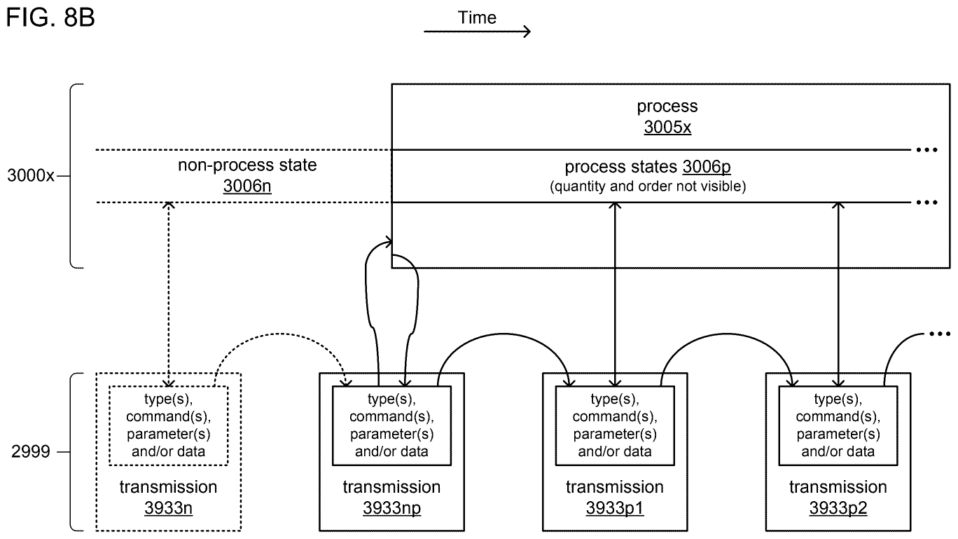

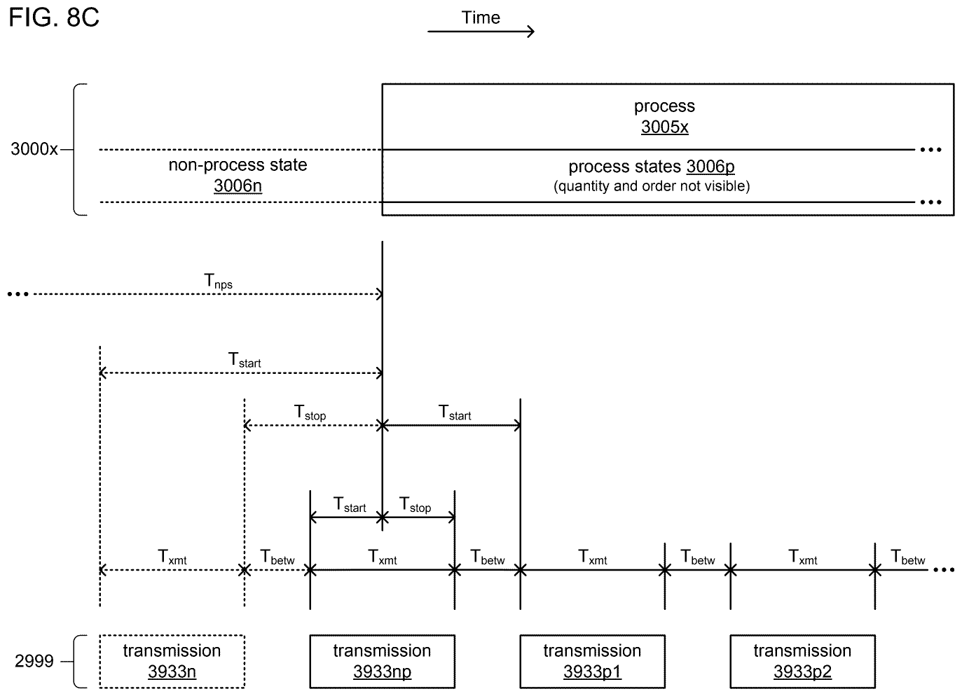

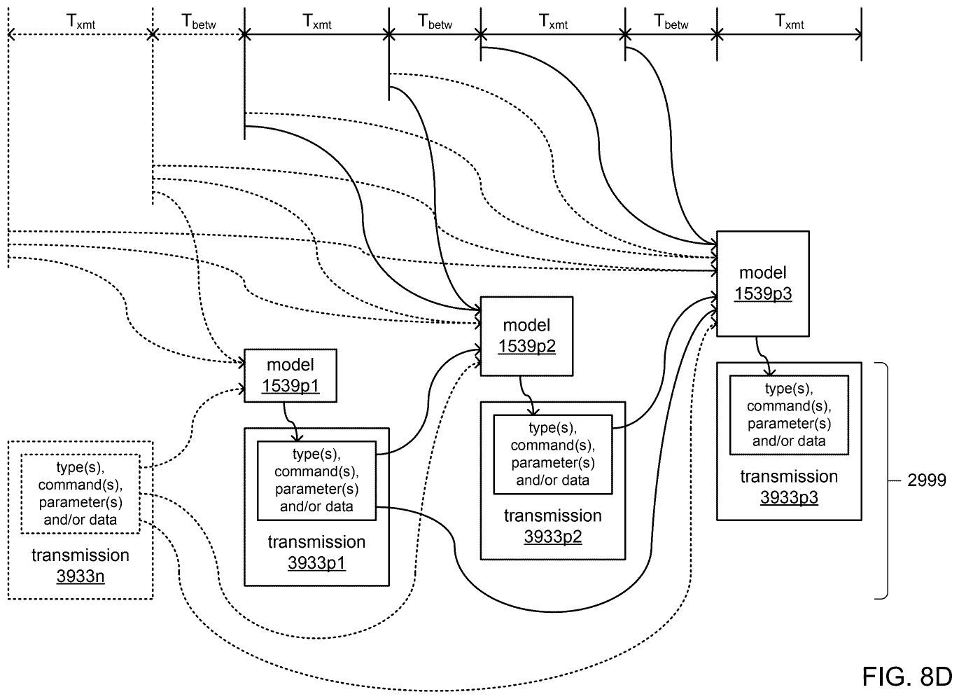

FIGS. 8A, 8B, 8C and 8D, taken together, present various aspects of an example embodiment of an alternate approach to training a monitoring device 1500 to detect and/or respond to learned patterns of transmission through the internal network 2999. Again, such patterns of transmission may be associated with controlling an industrial process (e.g., the process 3005x) and/or associated with downloading software updates (e.g., the processes 2305ud and/or 3005ud).

Turning to FIG. 8A, in some embodiments, this alternate approach to training a monitoring device 1500 may be employed to provide supplemental training at a time after the emulation-based approach described in detail above has been employed to provide the initial training. As is about to be described, this alternate approach does not employ emulations, and allows the monitoring device 1500 to remain in place and connected to interchange device(s) 2700. However, in other embodiments, it may be that this alternate approach to training a monitoring device 1500 may be employed for both initial and subsequent training.

As depicted, a monitoring device 1500 may be coupled to an interchange device 2700 by one or more of its ports 1590 and through the depicted link 1992. In executing the depicted learning component 1543 of the control routine 1540, the processor(s) 1550 may be caused to place the monitoring device 1500 in a training mode in which the monitoring device 1500 is prepared for use (or further prepared for use). In such preparations, observations are made of transmissions 2922 of operational commands and/or operational information through the internal network 2999 that are associated with a particular process 2305 or 3005, and those observations may serve as a basis for machine learning from actual examples from when the particular process 2305 or 3005 is performed normally. As depicted, where such transmissions 2922 are associated with controlling an industrial process (e.g., the process 3005x performed within the external system 3000x), then such transmissions 2922 may be between two monitored devices 2300 (e.g., the depicted monitored devices 2300a and 2300b), and may be conveyed through corresponding links 2990a and 2990b, respectively, of the internal network 2999. However, where such transmissions are associated with downloading an updated routine, then such transmissions 2922 may be between a monitored device 2300 (e.g., the depicted monitored device 2300a) and an external server 9900, such transmissions may be conveyed through corresponding links 2990a and 2992, respectively, of the internal network 2999.

More specifically, copies and/or indications of these transmissions 2922 of operational commands and/or operational information that are associated with a particular process 2305 or 3005 are relayed by the interchange device 2700 to the monitoring device 1500 via the link 1992. Within the monitoring device 1500, the received copies and/or indications of such transmissions may be used to generate and/or augment information stored within a process entry 1534 of the database 1533 that corresponds to the particular process 2305 or 3005.

Still more specifically regarding the control of an industrial process, and in embodiments where the monitoring device 1500 was earlier provided with descriptions of portions of the logic used for the process by monitored device(s) 2300 and/or by components of an external system 3000 to control the industrial process, the entry set 1531 may have already been generated at an earlier time based on such descriptions of such logic. Again, such descriptions of such logic may include descriptions of aspects of the process states 2306 or 300g, along with descriptions of aspects of transmissions 2922 associated with individual process states, and/or descriptions of aspects of transmissions 2922 associated with transitions between process states. As previously discussed, in such embodiments, the timings and/or data values of at least some of the transmissions, for which copies and/or indications are relayed to the monitoring device 1500, are correlated to indications of expected transmissions 2922 within a process entry 1534 for a particular process 2305 or 3005. The observed timings and/or data values may be used to derive models that are descriptive of variations observed in those timings and/or data values, as well as being descriptive of relative probabilities of such variations. Alternatively or additionally, the observed timings and/or data values may be used to derive and/or train models based on neural networks and/or other forms of machine learning.

Alternatively, regarding either the control of an industrial process or the process of downloading of a software update, and in other embodiments where the monitoring device 1500 was not earlier provided with descriptions of portions of the logic used for the process (e.g., not provided with a state machine definition 2304 or 3004), the process entry 1534 for a process 2305 or 3005 may be generated from the observations made of transmissions 2922 among the particular monitored devices 2300 that are associated with that process 2305 or 3005. More specifically, the copies and/or indications of such transmissions 2922 that are relayed to the monitoring device 1500 may be analyzed for their timings, for the types of the transmissions 2922, for what commands and/or parameters were included in transmissions 2922 of the type used to convey operational commands, and/or for what data values were included in transmissions 2922 of the type used to convey operational information. As previously discussed, with there being no access to data concerning the process states of the process with which such transmissions are associated (e.g., no access to a state machine definition 2304 or 3004), the analysis of at least observed variations in what types of transmissions occur and/or in what commands are transmitted may be used as a basis for deriving a set of process states of the process. Again, models based on statistical analyses and/or models based on any of a variety of machine learning technologies may be derived based on observed variations in commands and/or parameters transmitted, variations in data values transmitted, and/or variations in timings of the transmissions.

Regardless of the exact manner in which the various process entries 1534 within the database 1533 are generated and/or augmented, the processor(s) 1550 may be caused, by further execution of the learning component 1543, to transition the monitoring device 1500 out of such a training mode upon reaching a predefined threshold, such as a threshold quantity of performances of the particular process from which observations of transmissions of operational commands or operational information are made, and/or a threshold amount of time spent in the training mode.

It should be noted that, in some embodiments, use of such a training mode may be entirely obviated by pre-loading the monitoring device 1500 with a database 1533 that has already been previously generated, either within the very same monitored system 2000, or within another monitored system that is similar enough that any variations in timings of transmissions therein are relatively small such that proper operation of the monitoring device 1500 with the monitored system 2000 is not impaired. In some of such embodiments, it may be that the database 1533 was previously generated through earlier training using another monitoring device 1500 that was trained based on observing the same monitored system 2000, or another sufficiently similar monitored system.

FIGS. 8B, 8C and 8D present aspects of using this alternate approach in a situation in which descriptions of the logic used to control the process 3005x are not provided. Thus, in this alternate approach in such a situation entails preparing a monitoring device 1500 based on machine learning from observations of network traffic that occurs through the network 2999 during multiple performances of the process 3005x, but without the benefit of information correlating those observations to stages of the process 3005x. As a result, such preparation must be based on the timings, types, particular operation commands (including parameters) and/or particular operational information associated with the transmissions 3933 that are observed.

FIG. 8B, when compared to FIG. 3B, illustrates causality information that is not provided to the monitoring device 1500 as a result of not being provided with a description of the logic for controlling the process 3005x. In some embodiments, indications that are manually entered by an operator of what transmission(s) 3933, or sequence of transmissions 3933, are associated with the beginning of the process 3005x may be relied upon by the monitoring device 1500 to serve as an indicator for when a performance of the process 3005x has begun and/or is being triggered to begin. Thus, as depicted, it may still be possible for the monitoring device 1500 to correlate specific transmission(s) 3400 (e.g., one or more of the depicted transmissions 3933n, 3933np and/or 3933p1) with the beginning of a performance of the process 3005x.

However, even with the benefit of an operator of the monitored system 2000 providing manual identification of each transmission 3933 that is associated with the process 3005x versus other transmissions 3933 that are not associated with the process 3005x, there remains no information provided to the monitoring device 1500 that correlates individual process states 3006p to individual transmissions 3933p (e.g., the specifically labeled transmissions 3933p1, 3933p2, and so on). As a result, identifying instances of causality between particular process states 3006p and the occurrence and/or content of particular transmissions 3933p, and/or identifying instances of causality between particular transitions between process states 3006p and the occurrence and/or content of particular transmissions 3933p, may not be possible.

FIG. 8C, when compared to FIG. 3C, illustrates timing information that is not provided to the monitoring device 1500 as a result of not being provided with a description of the logic for controlling the process 3005x. Again, indications that are manually entered by an operator of what transmission(s) 3933, or sequence of transmissions 3933, are associated with the beginning of the process 3005x may be relied upon by the monitoring device 1500 to serve as an indicator for when a performance of the process 3005x has begun and/or is being triggered to begin. Thus, as depicted, it may still be possible for the monitoring device 1500 to correlate the timings of specific transmission(s) 3933 (e.g., one or more of the depicted transmissions 3933n, 3933np and/or 3933p1) with the beginning of a performance of the process 3005x.

However, even with the benefit of an operator of the monitored system 2000 providing manual identification of each transmission 3933 that is associated with the process 3005x versus other transmissions 3933 that are not associated with the process 3005x, there remains no information provided to the monitoring device 1500 that correlates the timings of the start and/or ending of individual process states 3006p to individual transmissions 3933p (e.g., the specifically labeled transmissions 3933p1, 3933p2, and so on). As a result, identifying specific times at which particular transmissions 3933p are expected to occur based on the when particular process states 3006p start and/or end may not be possible.

Thus, and turning to FIG. 8D, with such a lack of access to a description of the logic for controlling the process 3003x, the monitoring device 1500 may rely on the aforedescribed observations of transmission type, content, parameters and/or timing as inputs to deriving models 1539p for each transmission 3933p that is to occur during a performance of the process 3005x. By way of example, and as depicted, individual models 1539p1, 1539p2 and 1539p3 may be derived for each of the depicted transmissions 3933p1, 3933p2 and 3933p3, respectively.

Regarding timings, with no access to information concerning the logic for determining when any particular transmission 3933p (e.g., the depicted transmissions 3933p1-p3) is to be expected to occur, each of the corresponding models 1539p (e.g., the depicted corresponding models 1539p1-p3) may include a model for the time at which to begin its corresponding transmission 3933p that is based on the time period from when the last transmission 3933p ended (i.e., Tbetw). Such a model of timing may also be derived to include some degree of variation (including relative probabilities) for when to begin transmitting based on observations of such variations across multiple performances of the process 3005x.

Regarding what commands and/or associated parameters are to be transmitted in transmissions of operational commands, each one of such models 1539p (e.g., the models 1539p1-p3) that is associated with a transmission 3933p (e.g., the transmissions 3400p1-p3, respectively) that is of a type for transmitting an operational command may include a model for the selection of the particular command to be transmitted and/or a model for the selection of the parameter(s) to be included therewith. Such a model may take into account timings relative to one or more preceding transmissions 3933p, along with the content of one or more preceding transmissions 3933p.

Regarding what data values are to be transmitted in transmissions of operational information, each one of the models 1539p (e.g., the models 1539p1-p3) that is associated with a transmission 3933p (e.g., the transmissions 3933p1-p3, respectively) that is of a type for transmitting operational information may include a model for the derivation of data values to be transmitted therein. Again, such a model may take into account timings relative to one or more preceding transmissions 3933p, along with the content of one or more preceding transmissions 3933p.

As such models 1539p for each transmission 3933p are developed and/or refined based on observations from multiple performances of the process 3005x, a process entry 1534 for the process 3005x may be generated and stored in the database 1533. Such a process entry set 1534 may have an organizational structure similar to what was previously described in connection with FIG. 7E.

Again, with the lack of provision of information concerning the logic for controlling the process 3005x, there may be no information available concerning any aspect of the set of process states 3006p of the process 3005x. In some embodiments, the set of process states 3006p may be inferred from the observed transmissions 3933p. More specifically, from observations of the transmissions 3933p that occur on the network 2999 during multiple performances of the process 3005x, the beginnings and endings of different process states 3006p may be inferred to be associated with each instance in which there appears to be a point in the multiple performances at which a selection is made from among multiple observed possibilities of what transmission 3933p is to occur.

By way of example, where there is observed to be some variation between the transmission of one command or another among the multiple performances, or where there is observed to some variation between the transmission of an operational command and the transmission of operational information, the processor(s) 1550 may be caused by execution of the learning component 1543, to infer that one process state 3006p ends at that point, and that there is a selection of what process state 3006p is to begin at that point.

### Detection and Correction of Missing Transmission

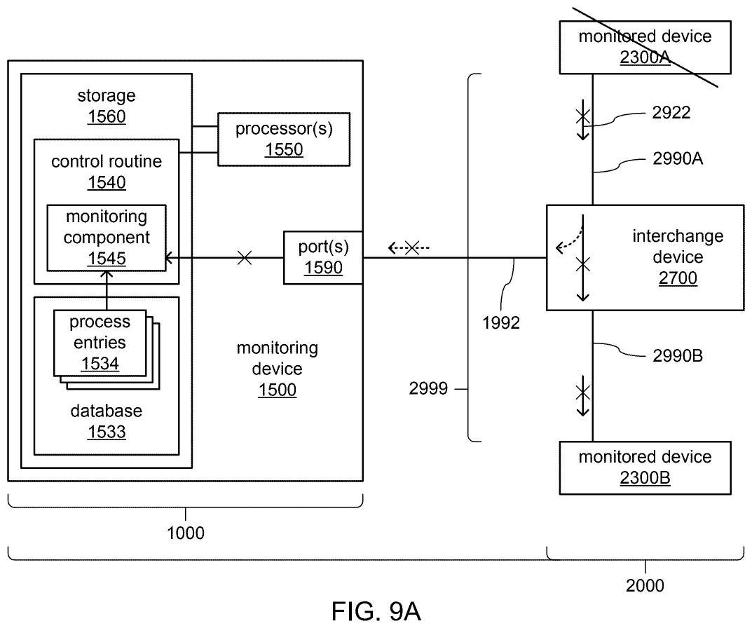

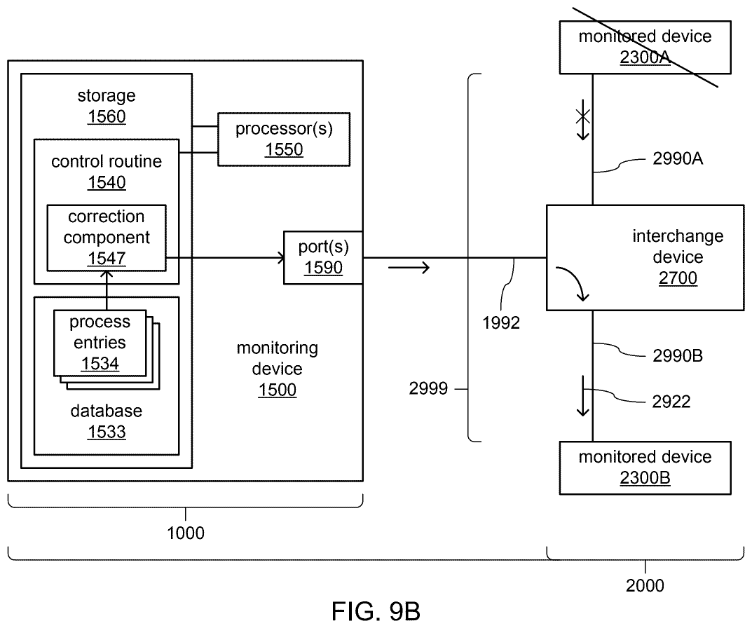

FIGS. 9A and 9B, taken together, present various aspects of an example embodiment of using a monitoring device 1500 to identify an instance in which a transmission 2922 of a particular operational command or operational information does not occur when it is expected to occur, and to respond to such an instance by generating and outputting a replacement transmission 2922 of the particular operational command or operational information.

Turning to FIG. 9A, the control routine 1540 may incorporate a monitoring component 1545 that, when executed by the processor(s) 1550, may cause the monitoring device 1500 to enter into an operating mode in which the monitoring device 1500 is used to detect and address instances of network activity on the internal network 2999 that does not conform to what is expected.

More specifically, FIG. 9A depicts an example instance in which a transmission 2922 of an operational command or operational information associated with controlling a particular process 3005 performed within an external system 3000 does not occur when expected. More specifically, the depicted monitored device 2300A fails to transmit a particular operational command to the depicted monitored device 2300B (through the depicted interchange device 2700, and links 2990A and 2990B of the internal network 2999) during a span of time in which that transmission 2922 of that operational command or operational information was expected to take place, according to the information about the expected transmission 2922 that is stored within a process entry 1534 of the database 1533 that corresponds to the particular process 3005. In continuing to execute the monitoring component 1545, the processor(s) 1550 may be caused to detect this lack of such a transmission 2922 of the particular operational command or operational information. More precisely, the processor(s) 1550 may be caused to detect the lack of receiving an indication from the interchange device 2700 that such a transmission 2922 has occurred on the internal network 2999.

As previously discussed, and as will be familiar to those skilled in the art, the failure of the monitored device 2300A to transmit a particular operational command or operational information when expected (or at all) may be caused by any of a variety of conditions. Again, the cause may be any of a variety of hardware and/or software malfunctions that may typically befall a computing device. As still another possibility, the monitored device 2300A may be in the process of being serviced, replaced and/or upgraded under circumstances in which the need for the monitored device 2300A to transmit the particular operational command or operational information during an expected span of time has somehow not been accommodated. Alternatively, the cause may be some form of cyber attack that has compromised the monitored device 2300A, itself, or at least has compromised the ability of the monitored device 2300A to access the link 2990A and/or to use the link 2990A to transmit the particular operational command or operational information through the internal network 2999.

Turning to FIG. 9B, the control routine 1540 may incorporate a correction component 1547 that, when executed by the processor(s) 1550, may cause the processor(s) 1550 to take action to address the lack of occurrence of this expected transmission 2922 on the internal network 2999. More specifically, in response to this lack of transmission of the particular operational command or operational information, the processor(s) 1550 may be caused to use information stored within the corresponding process entry 1534 concerning this particular transmission to, itself, generate and transmit the operational command or operational information to the monitored device 2300B (through the depicted interchange device 2700 and the depicted links 1992 and 2990B). In effect, the monitoring device 1500 is caused to take the place of the monitored device 2300A for purposes of transmitting the particular operational command or operational information to the monitored device 2300B.

As part of generating and/or transmitting the particular operational command or operational information to the monitored device 2300B, the processor 1550 (s) may be caused to refer to indications stored in that corresponding process entry 1534 of the database 1533 concerning what the particular operational command or operational information to be transmitted is, and/or various protocol details to be adhered to in transmitting the particular operational command or operational information. Among such protocol details may be the need to include one or more identifiers with the operational command or operational information that may specify the destination for the transmission, that identify the iteration of the particular process 3005 that the particular operational command or operational information is directed to, etc. Also among such protocol details may be an indication of a need to generate a command sequence number that identifies the relative position of the particular operational command or operational information among other operational commands or operational information that are transmitted as part of controlling the process 3005 (this command sequence number should not be confused with the sequence numbers used in TCP/IP). By way of example, such a command sequence number may need to be generated by incrementing the command sequence number of the last operational command or operational information associated with the particular process 3005 that was observed to have been transmitted.

It should be noted that, although an example of a breakdown in electronic communications involving a failure to output an expected transmission 2922 by a single monitored device 2300A is presented and discussed in connection with FIGS. 9A-B, it is envisioned that there could be a breakdown in electronic communications involving a failure by multiple monitored devices 2300 and involving multiple expected transmissions 2922. In such an eventuality, it may be that the monitoring device 1500 is caused to detect such multiple failures by such multiple monitored devices 2300 (e.g., such failures occurring in both of the monitored devices 2300A and 2300B), and may be further caused to act to correct each of the resulting instances of the lack of output of an expected transmissions 2922.

### Detection and Correction of Improper Transmission—With Buffer

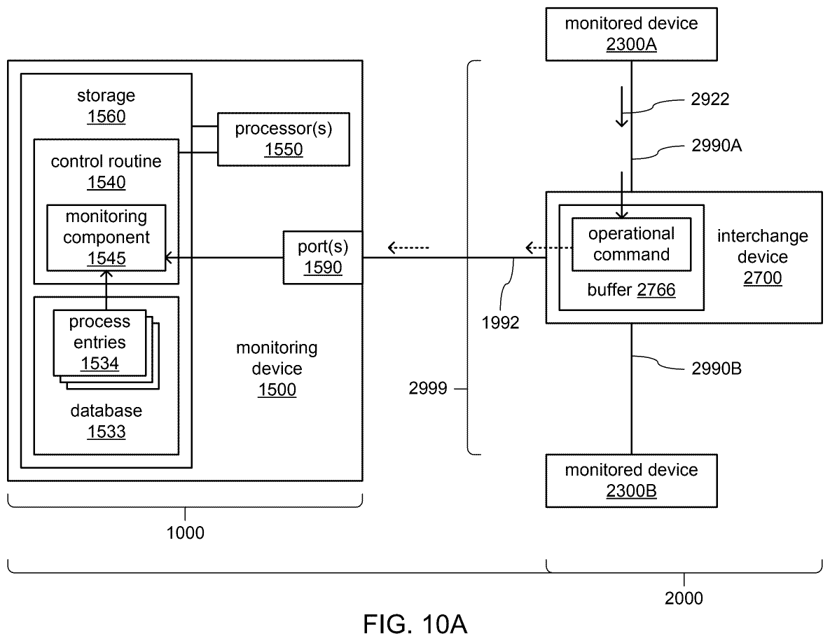

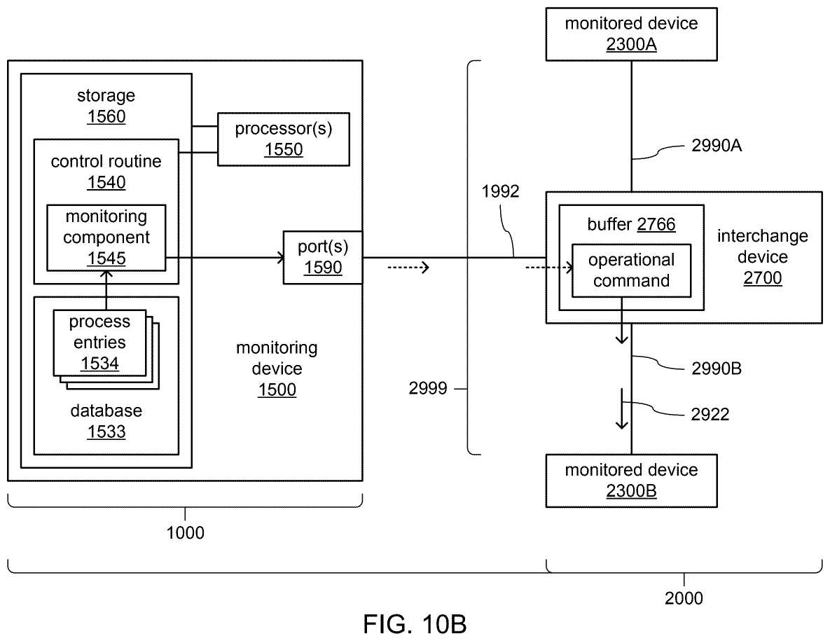

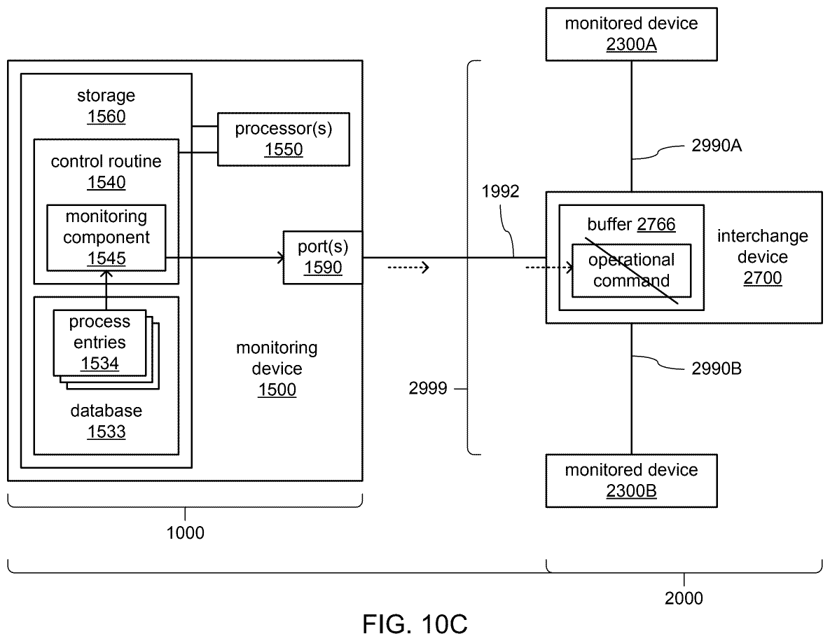

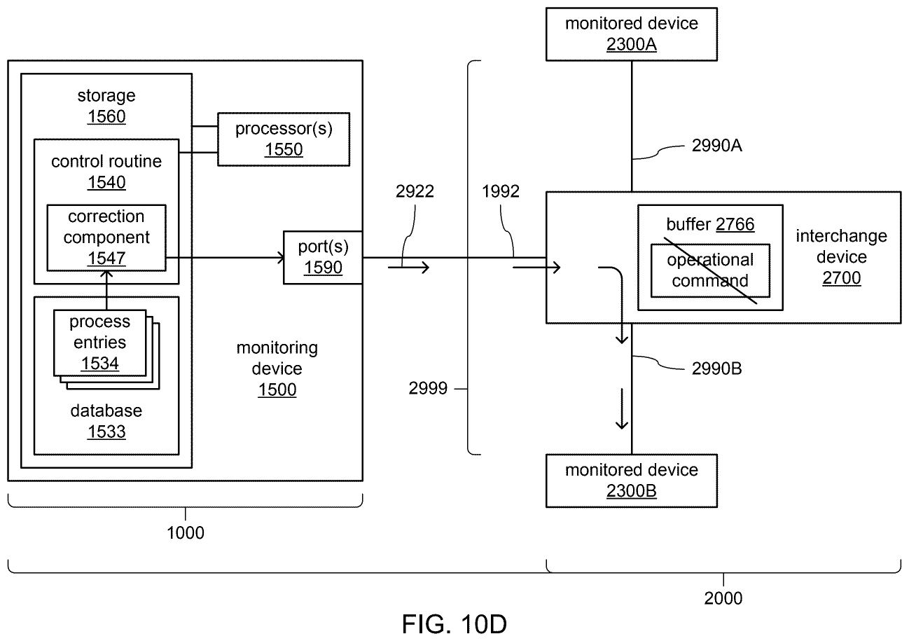

FIGS. 10A, 10B, 10C and 10D, taken together, present various aspects of an example embodiment of using a monitoring device 1500 to identify an instance in which an improper or invalid operational command is transmitted, and to respond to such an instance by blocking that transmission 2922 and/or generating and outputting a transmission 2922 that conveys a corrected and/or countermanding operational command.

Turning to FIG. 10A, the control routine 1540 may incorporate a monitoring component 1545 that, when executed by the processor(s) 1550, may cause the monitoring device 1500 to enter into an operating mode in which the monitoring device 1500 is used to detect and address instances of improper network activity on the internal network 2999 in which a transmission 2922 conveys an operational command that does not conform to what is expected.

By way of example, the depicted monitored device 2300A outputs, onto its link 2990A with the depicted interchange device 2700, a transmission 2922 of an operational command associated with a particular process 3005 performed within an external system 3000. At the interchange device 2700, the operational command may be intercepted (such that the transmission 2922 of the operational command is not allowed to reach its destination, at least not initially) by being stored within the buffer 2766 therein. A copy or indication of the operational command is then relayed by the interchange device, on the depicted link 1992, to the depicted monitoring device 1500 for analysis. Within the monitoring device 1500, further execution of the monitoring component 1545 by the processor(s) 1550 may cause the processor(s) 1550 to refer to a process entry 1534 of the database 1533 that corresponds to the particular process 3005. Referring to such a process entry 1534 may be done as part of analyzing the operational command to determine whether its type, its content (including any parameter values therein), the timing of its transmission, its order of transmission relative to other transmitted operational commands and/or to transmitted operational information, and/or still other aspects thereof, conform to what is expected for the particular process 3005.

Turning to FIG. 10B, if the processor(s) 1550 determine that the transmission 2922 received from the monitored device 2300A (and being held at the interchange device 2700) conveys an operational command of proper type, content, transmission timing, transmission order relative to other commands, etc., then the monitoring device 1500 may transmit an instruction along the link 1992 to the interchange device 2700 to proceed with relaying the transmission 2922, with its operational command, onward to its intended destination device (i.e., the depicted monitored device 2300B), thereby allowing the operational command to be received at its intended destination device.

However, and turning to FIG. 10C, if the processor(s) 1550 determine that the transmission 2922 received from the monitored device 2300A (and being held within the buffer 2766 of the interchange device 2700) conveys an operational command that is improper in type, content, transmission timing, transmission order relative to other commands, etc., then the processor(s) 1550 may be caused to generate alert(s) of various types and/or to operate the port 1590 to transmit instruction(s) along the link 1992 to instruct the interchange device 2700 to refrain from relaying that transmission 2922 onward to its intended destination device (i.e., the depicted monitored device 2300B), thereby preventing the reception of that operational command at its intended destination device.

Turning to FIG. 10D, as previously discussed, in some embodiments, and under various pre-selected circumstances, it may be that, in addition to instructing the interchange device 2700 to refrain from relaying the transmission 2922 conveying the improper operational command onward to its intended destination device, the processor(s) 1550 of the monitoring device 1500 may be further caused to generate and output a substitute transmission 2922 that conveys a substitute proper operational command. More precisely, and as depicted, the control routine 1540 may incorporate a correction component 1547. In being executed by the processor(s) 1550, and in response to circumstances in which the improper operational command was transmitted at a time at which it was expected that a proper operational command was to be transmitted, the processor(s) 1550 may be caused to generate a substitute proper operational command that is of the expected type and that includes expected parameter(s). Stated differently, the processor(s) 1550 may be caused to use information stored within the process entry 1534 of the database 1533 that corresponds to the process 3005 to, itself, generate the proper operational command that should have been transmitted. The processor 1550 may then operate the port 1590 to output a transmission 2922 onto the link 1992 that conveys the generated proper operational command to the interchange device 2700, along with instructions to relay it to the expected destination device (i.e., the monitored device 2300B). In effect, the monitoring device 1500 is caused to take the place of the monitored device 2300A for purposes of transmitting the proper operational command to the monitored device 2300B.

As part of generating and/or transmitting such a substitute proper operational command to the monitored device 2300B, the processor 1550 (s) may be caused to refer to indications stored in the corresponding process entry 1534 of the database 1533 concerning various protocol details to be adhered to in transmitting it. Among such protocol details may be the need to include one or more identifiers with the command that may specify the destination device for the transmission, that identify the iteration of the process 3003 that the particular command is directed to, etc. Also among such protocol details may be an indication of a need to generate a command sequence number that identifies the relative position of the proper operational command among other operational commands that are transmitted as part of controlling the industrial process (this command sequence number should not be confused with the sequence numbers used in TCP/IP). By way of example, such a command sequence number may need to be generated by incrementing the command sequence number of the last operational command associated with the process 3005 that was observed to have been transmitted.

### Detection and Correction of Improper Transmission—Without Buffer

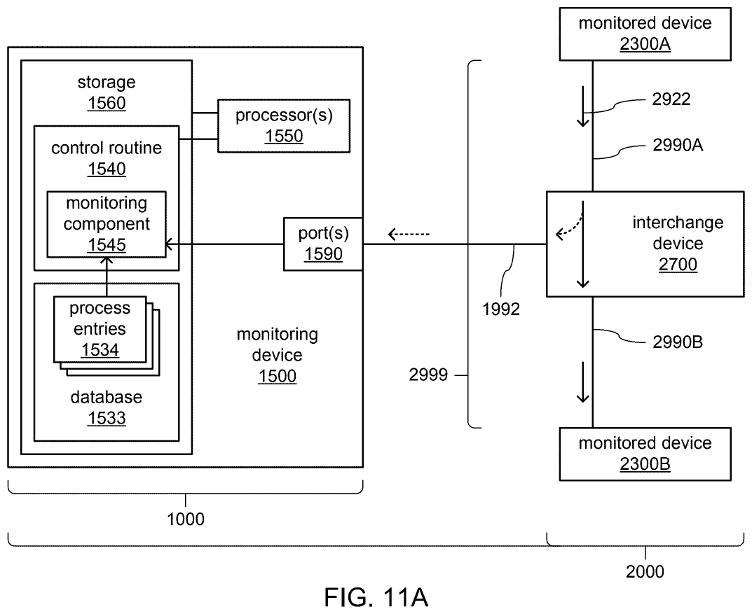

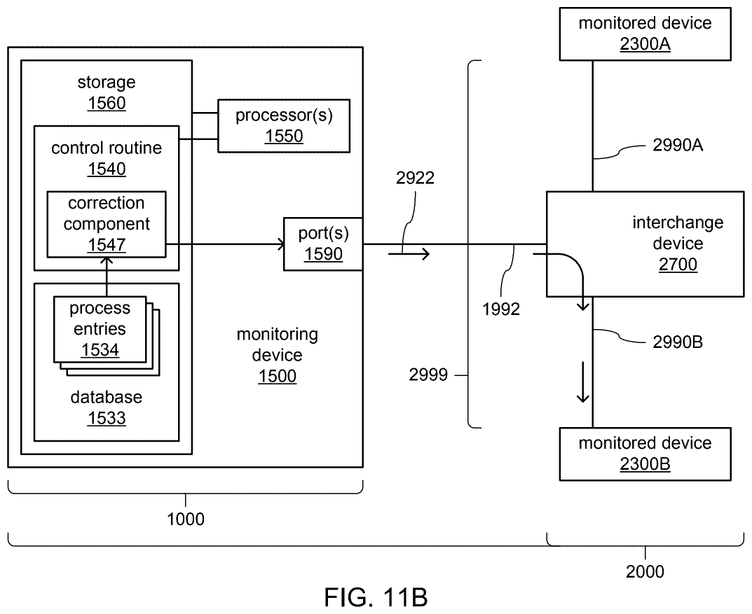

FIGS. 11A and 11B, taken together, present various aspects of an example embodiment of using a monitoring device 1500 to identify an instance in which an improper operational command is transmitted, and to respond to such an instance by generating and outputting a transmission 2922 that conveys a corrected and/or countermanding operational command.

Turning to FIG. 11A, in a manner similar to what was discussed above in reference to FIG. 10A, the processor(s) 1550 of the depicted monitoring device 1500 may be caused, by execution of the monitoring component 1545 of the control routine 1540, to place the monitoring device 1500 into an operating mode in which the monitoring device 1500 is used to detect and address instances of improper network activity on the internal network 2999 in which a transmission 2922 conveys an operational command that does not conform to what is expected.

By way of example, and similar to what was discussed above in reference to FIG. 10A, the depicted monitored device 2300A outputs, onto its link 2990A with the depicted interchange device 2700, a transmission 2922 of an operational command associated with a particular process 3005 performed within an external system 3000. However, unlike the interchange device 2700 of FIGS. 10A-D, the interchange device 2700 of FIGS. 11A-B may not incorporate the ability to intercept and temporarily store the transmission 2922 as part enabling the operational command that it conveys to be conditionally allowed to be relayed onward to its intended destination device. Instead, the interchange device 2700 of FIGS. 11A-B may simply proceed with relaying the transmission 2922 onward to its intended destination device (i.e., the monitored device 2300B).

However, as the interchange device 2700 so relays the transmission 2922 onward to the monitored device 2300B via its corresponding link 2990B, a copy and/or indication of the transmission 2922, including the operational command therein, is relayed along the depicted link 1992 to the monitoring device 1500 for analysis. As has been discussed, within the monitoring device 1500, the processor(s) 1550 may be caused by caused by execution of the monitoring component 1545 to refer to the process entry 1534 of the database 1533 that corresponds to the particular process 3005 as part of analyzing the transmission 2922, including the operational command therein, to determine whether the type of the transmission 2922, its content (including any parameter values of the operational command), the timing of the transmission 2922, its order of being transmitted relative to other transmissions 2922, and/or still other aspects, conform to what is expected for the particular process 3005. If the processor(s) 1550 determine that the transmission 2922 is proper (e.g., conveys an operational command of proper type and parameters, with proper transmission timings, in proper order relative to other transmissions, etc.), then the processor(s) 1550 may be caused to take no further action regarding the transmission 2922, since it has already been relayed to the monitored device 2300B.

However, and turning to FIG. 11B, if the processor(s) 1550 determine that the transmission 2922 conveys an operational command that is improper in type, content, transmission timing, transmission sequence order relative to other commands, etc., then the processor(s) 1550 may be caused to generate and transmit one or more operational commands to countermand the improper operational command and/or to provide an expected proper operational command.

More specifically, the processor(s) 1550 of the monitoring device 1500 may be further caused by execution of the correction component 1547 to generate at least one countermanding operational command that serves to stop and/or reverse whatever action or non-action was ordered to be taken by the improper operational command was conveyed in the transmission 2922. In so doing, the processor 1550 may be caused to use both the contents of the improper operational command and information about expected transmissions of expected operational commands for the particular process 3005 stored within the corresponding process entry 1534 of the database 1533 to generate such countermanding operational command(s). The processor 1550 may then be caused to operate the port 1590 to output at least one transmission 2922 of the at least one countermanding operational command onto the link 1992 to the interchange device 2700 along with instructions to relay the at least one transmission 2922 to the same destination device as the improper operational command (i.e., to the monitored device 2300B).

Also more specifically, and either in addition to or in lieu of the generation and transmission of at least one countermanding operational command, where the improper operational command was transmitted at a time at which it was expected that a proper operational command was to be transmitted, the processor 1550 may generate a substitute proper operational command that is of the expected type and that includes expected parameter(s). Again, in so doing, the processor(s) 1550 may be caused to use information stored within the corresponding process entry 1534 of the database 1533 about expected transmissions of operational commands for the particular process 3005 to generate such a proper operational command. Again, the processor(s) 1550 may then be caused to operate the port 1590 to output a transmission 2922 conveying the generated proper operational command onto the link 1992 to the interchange device 2700 along with instructions to relay it to the same destination device as the improper operational command (i.e., to the monitored device 2300B). In effect, and in a manner similar to what was discussed in reference to FIG. 10D, the monitoring device 1500 is caused to take the place of the monitored device 2300A for purposes of transmitting the proper operational command to the monitored device 2300B.

It should be noted that, in various situations, it may be that the generation and transmission of the proper command also serves the purposes of countermanding the improper command operational command, such that the generation and transmission of separate and distinct countermanding operational command(s) is unnecessary. Again, as part of generating and transmitting either or both of distinct countermanding operational command(s) and a proper operational command, the processor 1550 may be caused to refer to indications of various protocol details stored in the corresponding process entry set 1534 of the database 1533 that corresponds to the particular process 3005.

### Identification and Simpler Responses to Update Download Process

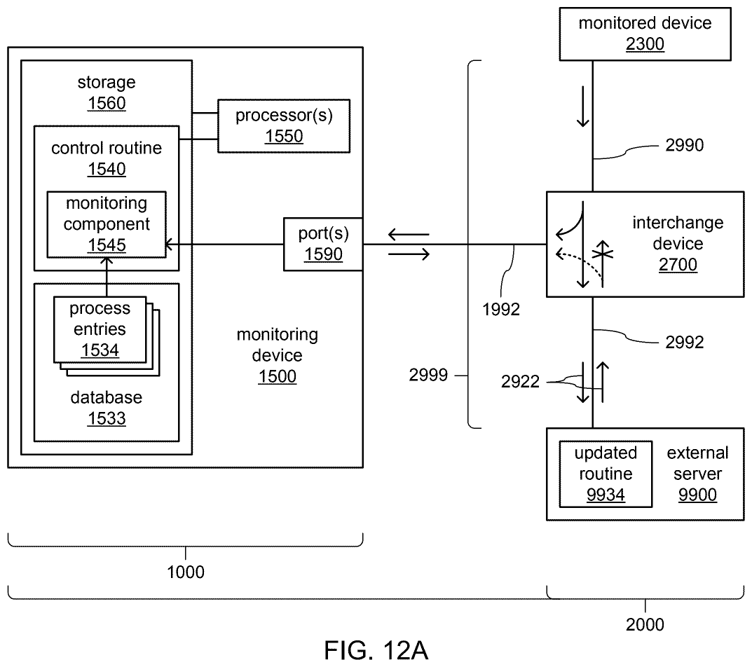

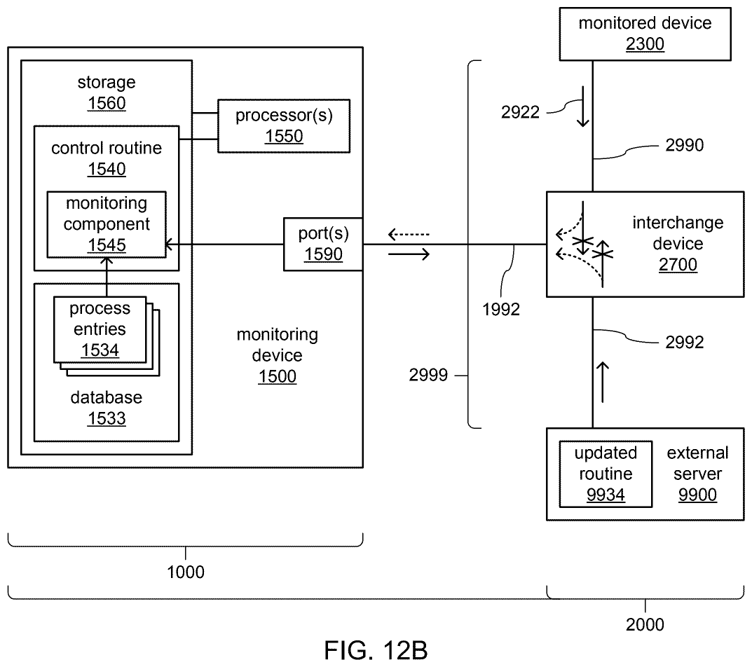

FIGS. 12A and 12B, taken together, present various aspects of an example embodiment of detecting and responding to the commencement of a process of downloading a software update for a monitored device 2300 (e.g., an update download routine 2305ud) based on a pattern of transmissions 2922 occurring on the internal network 2999. FIG. 12A depicts aspects of the detection and an example initial response, and FIG. 12B depicts aspects of an example response of preventing such a download from at least being completed.

Turning to FIG. 12A, in executing a monitoring component 1545 of the control routine 1540, processor(s) 1550 of a monitoring device 1500 may cooperate with an interchange device 2700 through a link 1992 to monitor activity occurring on the internal network 2999 for a pattern of transmissions 2922 that is able to be matched to one of the processes described within one of the process entries 1534 of the database 1533. As depicted, a process for the downloading of an updated routine 9934 by a monitored device 2300 may be so identified as having begun with a particular first transmission 2922 that is associated with that process from a monitored device 2300 that is directed toward an external server 9900.

It is envisioned as possible that the very first transmission 2922 associated with a particular process may have characteristics, such as a type of operational command, a parameter, a particular identifier of a destination device, etc. that may be sufficiently unique that just the very first transmission 2922 is needed to provide an indication that the particular process has commenced. Thus, where such a unique first transmission 2922 is observed by the monitoring device 1500, it may not be necessary to wait to observe even a second transmission 2922 (which may be in reply to the first transmission) before the particular process is able to be identified, and a response to its commencement is able to be determined and implemented. Indeed, FIG. 12A depicts the implementation of a particular response in which the relaying of the very first transmission 2922 is allowed to proceed through the interchange device 2700, but a second transmission 2922 in response thereto is then blocked from being relayed through the interchange device 2700.

However, it is also envisioned as possible that a relatively small quantity of multiple transmissions 2922 occurring in a particular sequence and/or with a particular combination of content may need to be observed to provide a sufficiently reliable indication that a particular process has commenced. Thus, in such a situation, there may be multiple transmissions 2922 that are allowed to proceed in both directions between the monitored device 2300 and the external server 9900 before the commencement of the particular process for downloading an updated routine 9934 for execution within the monitored device 2300 is recognized (e.g., an update download process 2305ud).

Regarding the possible responses to the commencement of the process of downloading the depicted updated routine 9934, in some embodiments, the process may be allowed to proceed without interruption as long as comparisons of the transmissions 2922 of operational commands and/or operational information that occur conform to what has been learned to be expected by the monitoring device 1500. More specifically, the transmissions 2922 identified as associated with this update download process may be compared to indications in the corresponding process entry 1534 of what transmissions 2922 are expected to occur, what the content of each transmission 2922 is expected to be, what the order of those transmissions 2922 is expected to be, and/or what the timing of each of those transmissions 2922 is expected to be. In such an embodiment, it may be that the detection of even a single transmission that does not exhibit expected characteristics may serve as a basis for blocking further transmissions 2922 that are identified as associated with the update download process. Such a blockage of such subsequent transmissions 2922 may be intended to force the process to be halted, and thereby force the process to be commenced again from the beginning if it is to be carried out successfully. Such a forced restart from the beginning may be deemed an effective way to deal with the possibility of corruption of the updated routine 9934 during the downloading of it.

As an alternative to simply blocking further transmissions 2922 in this update download process in response to such a non-conforming transmission 2922, the processor(s) 1550 may, instead, be caused to use the information within the corresponding process entry 1534 for this process to correct the non-conforming transmission 2922. More specifically, in a manner similar to what was earlier described in connection with FIGS. 10A-D, a transmission 2922 that is non-conforming in its content may be blocked from being relayed through the interchange device 2700, while a replacement transmission 2922 with conforming content may be generated within the monitoring device 1500, and provided to the interchange device 2700 to relay onward in place of the non-conforming transmission. Alternatively or additionally, in a manner similar to what was earlier described in connection with FIGS. 9A-B, a transmission 2922 that is expected to occur at a particular time, but which does not occur when expected, may be responded to by the monitoring device 1500 generating the missing transmission 2922, itself, and providing it to the interchange device 2700 to be relayed to the destination device to which the missing transmission would have been directed. Such corrective efforts may be made to address particular circumstances in which the affected transmissions 2922 are determinative of whether a download involves a particular external server 9900 that is deemed to be trustworthy, rather than an external server 9900 that is unknown or that is known to be an untrustworthy (e.g., fake) external server. Such corrections may be performed to address situations in which an identifier of an external server 9900 may have been mistyped by an operator of the monitored device 2300. Alternatively, the downloading of software updates may be deemed to be sufficiently sensitive that it is deemed to be undesirable to make corrections in an update download process, regardless of whether such a correction is to an innocent mistake, rather than to a deliberate effort to download a fake software update from a fake external server.

In other embodiments, the process of downloading the depicted updated routine 9934 may be blocked immediately upon being identified as having commenced. Thus, once enough transmissions 2922 have occurred to enable the commencement of the update download process to be identified, the process may be immediately blocked or otherwise negated to prevent its completion, and to require that the update download process be commenced again from the beginning if it is to be carried out successfully. In such embodiments, it may be that a notification is transmitted to particular personnel seeking a response as to whether the process should be allowed to take place. Thus, in such embodiments, it may be that this update download process continues to be blocked each time it is identified as having commenced until such approval is received from such personnel.

FIG. 12B depicts such an ongoing complete blockage of transmissions in either direction that are associated with a download process that is being blocked.

### Buffering and Mimicry Responses to Update Download Process

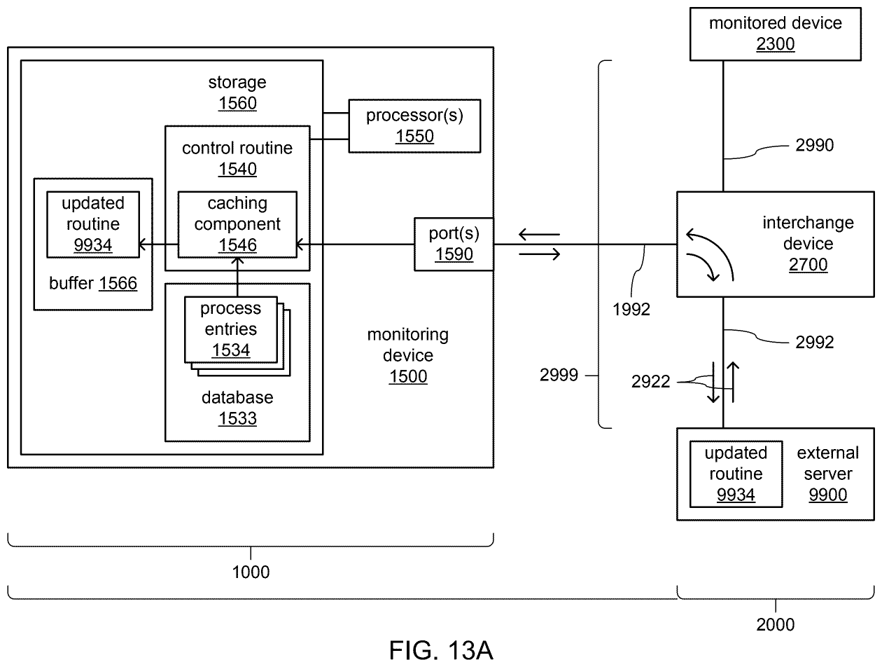

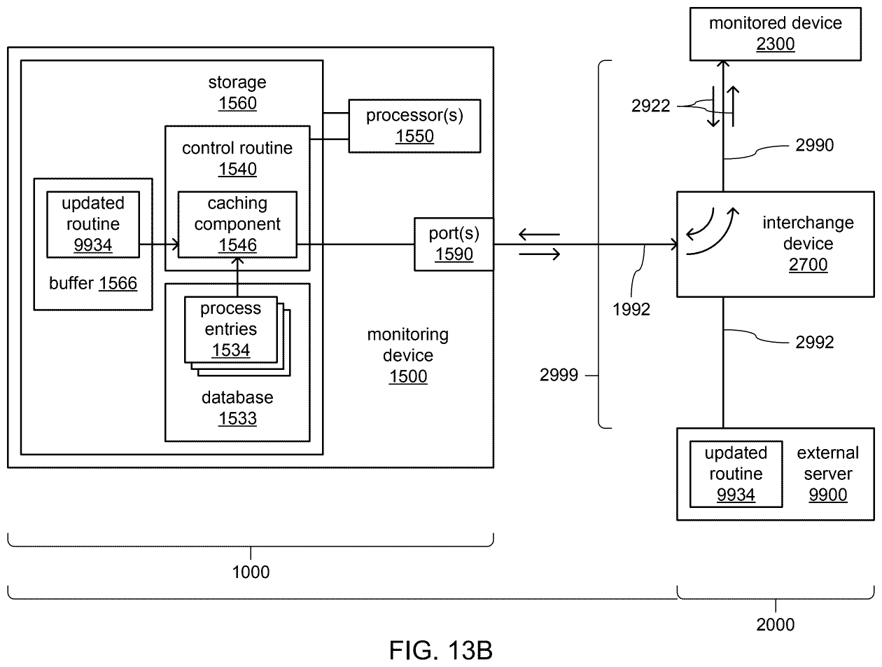

FIGS. 13A and 13B, taken together, present various aspects of another example embodiment of responding to the commencement of a process of downloading a software update for a monitored device 2300 based on a pattern of transmissions 2922 occurring on the internal network 2999. Each of FIGS. 13A and 13B depicts aspects of an example subsequent response to the detection of the commencement of such a download.

Turning to FIG. 13A, in executing a caching component 1546 of the control routine 1540, processor(s) 1550 of the monitoring device 1500 may cooperate with the interchange device 2700 through the link 1992 to independently complete an earlier attempted software update that entails the downloading of an updated routine 9934 from an external server 9900. As discussed above, it may be that one or more earlier attempts by the monitored device 2300 to download the updated routine 9934 were blocked while approval to proceed was awaited from personnel.

Following the receipt of such approval, and at a time when the monitored device 2300 may have ceased attempting to perform the update download process, processor(s) 1550 may be caused to use learned information concerning transmissions 2922 associated with such an update download process to engage in communications with that external server 9900 that mimic the communications that the monitored device 2300 would have engaged in as part of performing the download earlier, if that earlier download had been permitted to proceed. In so doing, the processor(s) 1550 may retrieve indications of learned characteristics of the transmissions 2922 associated with this update download process from its corresponding one of the process entries 1534 within the database 1533. In this way, the monitoring device 1500 may store a copy of the updated routine 9934 in preparation for providing the updated routine 9934 to the monitored device 2300 at a later time.

It should be noted that such operations may be limited to being performed with software updates for which a license or other form of permission has been granted for such storage thereof. In some of such embodiments, the opportunity of the storage of the updated routine 9934 within a buffer 1566 of the monitoring device 1500 may be used to analyze the updated routine 9934 to determine its authenticity and/or to identify any malicious code therein.

Turning to FIG. 13B, at a later time, when the monitored device 2300 may again attempt to download the updated routine 9934, the processor(s) 1550 may cooperate with the interchange device 2700 to similarly mimic the learned behavior of the external server 9934 to cause the monitored device 2300 to download the updated routine 9934 from the monitoring device 1500, and not the directly from the external server 9900. Again, the processor(s) 1550 may retrieve indications of learned characteristics of the transmissions 2922 associated with this update download process from its corresponding one of the process entries 1534 within the database 1533.

Among the uses that may be made of the set of emulations provided by the emulation device(s) 5500, other uses are possible including but not limited to (a) Archive Storage: a facility's support team may wish to store its network traffic captures for historical and future comparison purposes; (b) Equipment Function Validation: checking on and/or verifying the functioning of Operational Technology (OT) network equipment, Industrial Control Systems (ICS) processes, and field equipment; (c) Diagnostic Debug: debugging the functioning of OT (operational technology) network equipment, ICS processes, and field equipment to find and solve otherwise difficult to detect and/or solve problems; (d) Datamining (AI or otherwise): uncovering minute as well as major patterns and trends in production equipment command-and-control and usage that would otherwise not be readily easy to uncover; (e) Cyber Security Malware & Hacker analysis: isolating and analyzing rogue, harmful or malicious OT network traffic sent by or otherwise altered by nefarious attackers and/or their hardware/software equipment; (f) Monitoring & Reporting: there are entire classes of important and sophisticated facility reports that virtually cannot be produced any other way; (g) Cost Performance Analysis & Improvement: conducting live, in-depth technical, production, and/or performance research on an entire ICS facility full of equipment produced by different vendor makes and models of all at the same time; (h) Product Development & Improvement: ICS vendors studying the function and performance of their respective ICS hardware and software products, each for their own respective product improvement purposes and new product development purposes.

There is thus disclosed a system of one or more devices that implements a method for enhancing computer network reliability by countering disruptions in network communications involved with the update of software. The features set forth below may be combined in any of a variety of ways to create any of a variety of embodiments of such a system and/or of a method of decision making augmentation that may incorporate such a system.

A monitoring system includes: a processor configured to perform operations including: place the monitoring system into a training mode to generate a model of a software update process; receive indications of observed transmissions of operational commands or operational information among multiple monitored devices of a monitored system, wherein at least one of the multiple monitored devices is configured to initiate the software update process; and from the received indications of observed transmissions of operational commands or operational information associated with the software update process, generate the model of the software update process, wherein the model includes indications of an expected order of transmissions of operational commands or operational information associated with the software update process.

The monitored system may include at least one interchange device to which each monitored device of the multiple monitored devices is separately coupled; the transmissions of operational commands or operational information among the multiple monitored devices may be conveyed through the one or more interchange devices; and the monitoring system may be coupled to the at least one interchange device to receive the indications of observed transmissions of operational commands or operational information among the multiple monitored devices.

The model may include a finite state model that includes indications of multiple states of the software update process and indications of valid transitions among the multiple states.

A monitoring system includes a processor configured to perform operations including: place the monitoring system into an operating mode to use a model of a software update process to analyze observed transmissions of operational commands or operational information associated with the software update process; receive, from one or more interchange devices, indications of observed transmissions of operational commands or operational information among multiple monitored devices of a monitored system, wherein at least one of the monitored devices is configured to provide an updated routine in the software update process; and compare the received indications of observed transmissions of operational commands or operational information associated with the software update process to indications in the model of expected transmissions of operational commands or operational information associated with the software update process to determine whether a particular transmitted operational command is a proper operational command associated with the software update process or to determine whether particular transmitted operational information is proper operational information associated with the software update process.

The monitored system may include at least one interchange device to which each monitored device of the multiple monitored device is separately coupled; the transmissions of operational commands or operational information among the multiple monitored devices may be conveyed through the one or more interchange devices; and the monitoring system may be coupled to the at least one interchange device to receive the indications of observed transmissions of operational commands or operational information among the multiple monitored devices.

The at least one interchange device may intercept and store the particular transmitted operational command or operational information; and the processor may be further configured to respond to a determination that the particular transmitted operational command is a proper operational command associated with the software update process, or to a determination that the particular transmitted operational information is proper operational information associated with the software update process, by instructing the at least one interchange device to release the particular transmitted operational command or operational information from storage and allow the particular transmitted operational command or operational information to be relayed to its intended destination.

The at least one interchange device may intercept and store the particular transmitted operational command, and the processor may be further configured to respond to a determination that the particular transmitted operational command is an improper operational command associated with the software update process by performing operations including: instruct the at least one interchange device to refrain from relaying the particular transmitted operational command to its intended destination; generate a substitute proper operational command including a type of operational command based on an expected order of operational commands specified in the model, and including an expected parameter value based on the model; and transmit the substitute proper operational command to the at least one interchange device to be relayed to an expected destination specified in the model.

The processor may be further configured to respond to a determination that the particular transmitted operational command is an improper operational command associated with the software update process, or to a determination that the particular transmitted operational information is improper operational information associated with the software update process, by logging or providing an alert to particular personnel, or attempting one or more corrective actions.

The model may include a finite state model that includes indications of multiple states of the software update process and indications of valid transitions among the multiple states.

A method of generating a model of a software update process includes: receiving, by a processor of a monitoring system, and from an interchange device of a monitored system, indications of observed transmissions, through the interchange device, of operational commands or operational information among multiple monitored devices of the monitored system; and from the received indications of observed transmissions of operational commands or operational information associated with the software update process, generating, by the processor, the model of the software update process, wherein the model includes indications of an expected order of transmissions of operational commands or operational information associated with the software update process.

The model may include a finite state model that includes indications of multiple states of the software update process and indications of valid transitions among the multiple states.

A method of using a model of a software update process to analyze observed transmissions of operational commands or operational information associated with the software update process includes: receiving, by a processor of a monitoring system, and from at least one interchange device of a monitored system, indications of observed transmissions of operational commands or operational information among multiple monitored devices of a monitored system; and comparing, by the processor, the received indications of observed transmissions of operational commands or operational information associated with the software update process to indications in the model of expected transmissions of operational commands or operational information associated with the software update process to determine whether a particular transmitted operational command is a proper and expected operational command associated with the software update process, or to determine whether the particular transmitted operational information is proper and expected operational information associated with the software update process.

The at least one interchange device may intercept and store the particular transmitted operational command or operational information; and the method may further include responding, by the processor, to a determination that the particular transmitted operational command is a proper and expected operational command associated with the software update process by instructing the at least one interchange device to allow the particular transmitted operational command to be relayed to its intended destination, or responding, by the processor, to a determination that the particular transmitted operational information is proper and expected operational information associated with the software update process by instructing the at least one interchange device to allow the particular transmitted operational information to be relayed to its intended destination.

The at least one interchange device may intercept and store the particular transmitted operational command, and the method may further include responding, by the processor, to a determination that the particular transmitted operational command is an improper operational command associated with the software update process by performing operations including: instructing the at least one interchange device to refrain from relaying the particular transmitted operational command to its intended destination; generating, by the processor, a substitute proper operational command including a type of operational command based on an expected order of operational commands specified in the model, and including an expected parameter value based on the model; and transmitting the substitute proper operational command to the at least one interchange device to be relayed to an expected destination specified in the model.

The method may further include responding to a determination that the particular transmitted operational command is an improper operational command associated with the software update process, or to a determination that the particular transmitted operational information is improper operational information associated with the software update process, by logging or providing an alert to particular personnel, or attempting one or more corrective actions.

The model may include a finite state model that includes indications of multiple states of the software update process and indications of valid transitions among the multiple states.

Various other components may be included and called upon for providing for aspects of the teachings herein. For example, additional materials, combinations of materials, and/or omission of materials may be used to provide for added embodiments that are within the scope of the teachings herein.

Standards for performance, selection of materials, functionality, and other discretionary aspects are to be determined by a user, designer, manufacturer, or other similarly interested party. Any standards expressed herein are merely illustrative and are not limiting of the teachings herein.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure has been described with reference to illustrative embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the claimed invention not be limited to the particular embodiment disclosed as the best mode contemplated for carrying out this invention, but that the invention will include all embodiments falling within the scope of the appended claims.

We claim:

1. A monitoring system comprising a processor configured to perform operations comprising:
place the monitoring system into a training mode to generate a model of a software update process;
receive indications of observed transmissions of operational commands or operational information among multiple monitored devices of a monitored system, wherein at least one of the multiple monitored devices is configured to initiate the software update process; and
from the received indications of observed transmissions of operational commands or operational information associated with the software update process, generate the model of the software update process, wherein the model comprises indications of an expected order of transmissions of operational commands or operational information associated with the software update process.

2. The monitoring system of claim 1, wherein:
the monitored system comprises at least one interchange device to which each monitored device of the multiple monitored devices is separately coupled;
the transmissions of operational commands or operational information among the multiple monitored devices are conveyed through the one or more interchange devices; and
the monitoring system is coupled to the at least one interchange device to receive the indications of observed transmissions of operational commands or operational information among the multiple monitored devices.

3. The monitoring system of claim 1, wherein the model comprises a finite state model that comprises indications of multiple states of the software update process and indications of valid transitions among the multiple states.

4. A monitoring system comprising a processor configured to perform operations comprising:
place the monitoring system into an operating mode to use a model of a software update process to analyze observed transmissions of operational commands or operational information associated with the software update process;
receive, from one or more interchange devices, indications of observed transmissions of operational commands or operational information among multiple monitored devices of a monitored system, wherein at least one of the monitored devices is configured to provide an updated routine in the software update process; and
compare the received indications of observed transmissions of operational commands or operational information associated with the software update process to indications in the model of expected transmissions of operational commands or operational information associated with the software update process to determine whether a particular transmitted operational command is a proper operational command associated with the software update process or to determine whether particular transmitted operational information is proper operational information associated with the software update process.

5. The monitoring system of claim 4, wherein:
the monitored system comprises at least one interchange device to which each monitored device of the multiple monitored device is separately coupled;
the transmissions of operational commands or operational information among the multiple monitored devices are conveyed through the one or more interchange devices; and
the monitoring system is coupled to the at least one interchange device to receive the indications of observed transmissions of operational commands or operational information among the multiple monitored devices.

6. The monitoring system of claim 4, wherein:
the at least one interchange device intercepts and stores the particular transmitted operational command or operational information; and
the processor is further configured to respond to a determination that the particular transmitted operational command is a proper operational command associated with the software update process, or to a determination that the particular transmitted operational information is proper operational information associated with the software update process, by instructing the at least one interchange device to release the particular transmitted operational command or operational information from storage and allow the particular transmitted operational command or operational information to be relayed to its intended destination.

7. The monitoring system of claim 4, wherein:
the at least one interchange device intercepts and stores the particular transmitted operational command; and
the processor is further configured to respond to a determination that the particular transmitted operational command is an improper operational command associated with the software update process by performing operations comprising:
instruct the at least one interchange device to refrain from relaying the particular transmitted operational command to its intended destination or to otherwise block, stop of countermand the transmitted operational command;
optionally generate a substitute proper operational command comprising a type of operational command based on an expected order of operational commands specified in the model, and comprising an expected parameter value based on the model; and
transmit the substitute proper operational command to the at least one interchange device to be relayed to an expected destination specified in the model.

8. The monitoring system of claim 4, wherein the processor is further configured to respond to a determination that the particular transmitted operational command is an improper operational command associated with the software update process, or to a determination that the particular transmitted operational information is improper operational information associated with the software update process, by logging or providing an alert to particular personnel, or attempting one or more corrective and/or preventative actions.

9. The monitoring system of claim 4, wherein the model comprises a finite state model that comprises indications of multiple states of the software update process and indications of valid transitions among the multiple states.

10. A method of generating a model of a software update process comprising:
receiving, by a processor of a monitoring system, and from an interchange device of a monitored system, indications of observed transmissions, through the interchange device, of operational commands or operational information among multiple monitored devices of the monitored system; and
from the received indications of observed transmissions of operational commands or operational information associated with the software update process, generating, by the processor, the model of the software update process, wherein the model comprises indications of an expected order of transmissions of operational commands or operational information associated with the software update process.

11. The method of claim 10, wherein the model comprises a finite state model that comprises indications of multiple states of the software update process and indications of valid transitions among the multiple states.

12. A method of using a model of a software update process to analyze observed transmissions of operational commands or operational information associated with the software update process, the method comprising:
receiving, by a processor of a monitoring system, and from at least one interchange device of a monitored system, indications of observed transmissions of operational commands or operational information among multiple monitored devices of a monitored system; and
comparing, by the processor, the received indications of observed transmissions of operational commands or operational information associated with the software update process to indications in the model of expected transmissions of operational commands or operational information associated with the software update process to determine whether a particular transmitted operational command is a proper and expected operational command associated with the software update process, or to determine whether the particular transmitted operational information is proper and expected operational information associated with the software update process.

13. The method of claim 12, wherein:
the at least one interchange device intercepts and stores the particular transmitted operational command or operational information; and
the method further comprises responding, by the processor, to a determination that the particular transmitted operational command is a proper and expected operational command associated with the software update process by instructing the at least one interchange device to allow the particular transmitted operational command to be relayed to its intended destination, or responding, by the processor, to a determination that the particular transmitted operational information is proper and expected operational information associated with the software update process by instructing the at least one interchange device to allow the particular transmitted operational information to be relayed to its intended destination.

14. The method of claim 12, wherein:
the at least one interchange device intercepts and stores the particular transmitted operational command; and
the method further comprises responding, by the processor, to a determination that the particular transmitted operational command is an improper operational command associated with the software update process by performing operations comprising:
instructing the at least one interchange device to refrain from relaying the particular transmitted operational command to its intended destination;
optionally generating, by the processor, a substitute proper operational command comprising a type of operational command based on an expected order of operational commands specified in the model, and comprising an expected parameter value based on the model; and
transmitting the substitute proper operational command to the at least one interchange device to be relayed to an expected destination specified in the model.

15. The method of claim 12, further comprising responding to a determination that the particular transmitted operational command is an improper operational command associated with the software update process, or to a determination that the particular transmitted operational information is improper operational information associated with the software update process, by logging or providing an alert to particular personnel, or attempting one or more corrective or preventative actions.

16. The method of claim 12, wherein the model comprises a finite state model that comprises indications of multiple states of the software update process and indications of valid transitions among the multiple states.
